(19) United States
(12) Patent Application Publication
(10) Pub. No.: US 2013/0231980 A1
(43) Pub. Date: Sep. 5, 2013

(54) EDUCATION ORGANIZATION ANALYSIS AND IMPROVEMENT SYSTEM

(71) Applicant: ADVANCED, Alpharetta, GA (US)

(72) Inventors: Mark A. Elgart, Alpharetta, GA (US); Alberto A. Mayo, Alpharetta, GA (US); Paul E. Lawler, Alpharetta, GA (US); Timothy J. Veil, Duluth, GA (US)

(73) Assignee: ADVANCED, Alpharetta, GA (US)

(21) Appl. No.: 13/784,622

(22) Filed: Mar. 4, 2013

Related U.S. Application Data
(63) Continuation-in-part of application No. 13/782,933, filed on Mar. 1, 2013.
(60) Provisional application No. 61/763,388, filed on Feb. 11, 2013.
(60) Provisional application No. 61/702,231, filed on Sep. 17, 2012.
(60) Provisional application No. 61/606,363, filed on Mar. 2, 2012.

(51) Int. Cl. G06Q 10/06

(52) U.S. Cl. CPC G06Q 10/0639
USPC 705/7.38

(57) ABSTRACT

Methods and systems for school analysis and improvement are disclosed. A computerized system is provided that is accessible to remote parties through a computer network and that are controlled by a managing entity. An option is presented to the administrator to administer surveys and diagnostics via the computerized system. The surveys and diagnostics request data regarding performance of the school as well as data responsive to the surveys and diagnostics. The data responsive to the surveys and diagnostics and the performance data are stored into a database managed by the managing entity. An administrator of the school is presented the responsive data and the performance data, and thereafter, data is received from the administrator describing one or more desired objectives for the school.

### CLAIM OF PRIORITY

The present application is a continuation-in-part of U.S. application Ser. No. 13/782,933, filed Mar. 1, 2013, entitled EDUCATION ORGANIZATION ANALYSIS AND IMPROVEMENT SYSTEM, and claims priority to U.S. provisional application Ser. No. 61/763,388, filed Feb. 11, 2013, U.S. provisional application Ser. No. 61/702,231, filed Sep. 17, 2012, and U.S. provisional application Ser. No. 61/606,363, filed Mar. 2, 2012, entitled SCHOOL ANALYSIS AND IMPROVEMENT SYSTEM, the entire disclosure of each of which is hereby incorporated by reference herein.

A portion of the disclosure of this patent document contains material which is subject to copyright protection. The copyright owner has no objection to the facsimile reproduction by any-one of the patent document or the patent disclosure, as it appears in the Patent and Trademark Office patent file or records, but otherwise reserves all copyright whatsoever.

### BACKGROUND

Education organizations, such as schools, school systems, education corporations, and educational service agencies, routinely make efforts to improve performance, whether in response to an internal desire to improve and better serve the interests of the students and/or the community, or in response to governmental or other public or institutional encouragement or regulatory requirements. Education organization performance, however, is a result of the performance of disparate people and systems, and improvement efforts can therefore require information from disparate sources and may require education organization to provide access to such information, or to proactively provide the information, to various entities.

### SUMMARY

To address the above issues, methods, systems and computer program products are disclosed herein to analyze education organization performance and to implement improvement plans for the organization. In one embodiment, an administrator (i.e., education organization representative such as a principal or school improvement specialist) at an education organization has access to software which allows the administrator (via the system) to view various survey data along with self-assessment data. The administrator also can view various reports relating to student performance data. After viewing data relating to a self-assessment diagnostic based on a set of standards (e.g., purpose and direction, governance and leadership, teaching and assessing for learning, resources and support systems, and using results for continuous improvement) and supporting indicators, as well as data from stakeholder perception surveys, the administrator performs a root cause analysis and then develops goals for education organization improvement using the software. The administrator also addresses assurances and reports these assurances to other entities.

In accordance with an embodiment of the present invention, a method of analyzing the performance of an education organization based on a set of categories of organization activities or attributes, the method includes: providing a computerized system that is accessible to remote parties through a computer network and that is controlled by a managing entity; providing, at the computerized system, a first set of queries for a first set of data items that describe education organization performance, that relate to one or more of the categories, and that are applicable to an administrator of the education organization; providing, at the computerized system, a second set of queries for a second set of data items that describe education organization performance, that relate to one or more of the categories, and that are applicable to individuals who interact with the education organization; providing to one or more first representatives of the education organization access, via the computer network and the computerized system, to the first set of data items and receiving first data from one or more first representatives in response to the first set of queries; providing to one or more individuals who interact with the education organization access, via the computer network and the computerized system, to the second set of data items and receiving second data from the one or more individuals in response to the second set of queries; receiving third data that describes performance of students at the education organization; defining, at the computerized system, a set of parameters corresponding to demographic attributes of the students; receiving, at the computerized system from a second representative of the education organization, a selection of said parameters; and presenting to the second representative the first data, the second data, and the third data, wherein the third data is limited by the selected parameters.

In accordance with an embodiment of the present invention, a method of analyzing the performance of a education organization and facilitating an improvement plan, the method includes: providing a computerized system that is accessible to remote parties through a computer network and that is controlled by a managing entity; receiving, at the computerized system through the computer network, authenticating information identifying an administrator of the education organization, wherein the administrator comprises a representative of the education organization; presenting an option to the administrator to administer diagnostic via the computerized system, wherein the diagnostics include a self-assessment diagnostic comprising queries relating to the education organization's performance, and a stakeholder perception survey comprising queries relating to the education organization's performance; providing access to the self-assessment diagnostic to one or more first representatives of the education organization and receiving first response data from the one or more first representatives; providing access to the stakeholder perception survey to one or more individuals who interact with the education organization and receiving second response data from the one or more individuals; receiving third data describing performance of students of the education organization; presenting to a second representative of the education organization the first response data, the second response data, and the third data; following the second presenting step, receiving, from a third representative of the education organization, fourth data describing one or more desired objectives for the education organization.

In accordance with an embodiment of the present invention, a method for education organization analysis and improvement includes providing a computerized system that is accessible to remote parties through a computer network and that are controlled by a managing entity. An option is presented to the administrator to administer stakeholder perception surveys via the computerized system. The surveys request data regarding performance of the education organization as well as data responsive to the surveys. The data responsive to the surveys and the performance data are stored into a database managed by the managing entity. An administrator of the education organization is presented the responsive data and the performance data, and thereafter, data is received from the administrator describing one or more desired objectives for the education organization.

The features, functions, and advantages that have been discussed may be achieved independently in various embodiments of the present invention or may be combined with yet other embodiments, further details of which can be seen with reference to the following description and drawings.

### BRIEF DESCRIPTION OF DRAWINGS

FIG. 1A is a block diagram of education organization analysis and improvement in accordance with some embodiments of the present invention.

FIG. 1B is a system for education organization analysis and improvement in accordance with an embodiment.

FIG. 2 is a flow chart of a method for education organization analysis and improvement in accordance with some embodiments of the present invention.

FIGS. 3-62 illustrate graphical user interfaces for implementing the method of education organization analysis and improvement according to some embodiments.

### DETAILED DESCRIPTION

Embodiments of the present invention will now be described more fully hereinafter with reference to the accompanying drawings, in which some, but not all, embodiments of the invention are shown. Indeed, the invention may be embodied in many different forms and should not be construed as limited to the embodiments set forth herein. Where possible, any terms expressed in the singular form herein are meant to also include the plural form and vice versa, unless explicitly stated otherwise. Also, as used herein, the term “a” and/or “an” shall mean “one or more,” even though the phrase “one or more” is also used herein. Furthermore, when it is said herein that something is “based on” something else, it may be based on one or more other things as well. In other words, unless expressly indicated otherwise, as used herein “based on” means “based at least in part on” or “based at least partially on.” Like numbers refer to like elements throughout.

In accordance with embodiments of the invention, the terms “school,” “school system,” or other similar term or phrase encompasses any organization that has a mission of teaching students and/or managing or administering one or more such learning organizations including, but not limited to, K-12 schools (private or public), or a system that includes several associated learning institutions. In specific embodiments of the invention, use of the term “school” may be limited to an early learning school, elementary school, a middle school, a high school, or a postsecondary school.

In accordance with some embodiments, “education corporation” or other similar term or phrase encompasses a private or commercial organization that oversees two or more schools or learning institutions. In accordance with some embodiments, “educational service agency” is an organization that provides school improvement services to one or more schools or school systems.

The term “education organization” may refer to a school, school system or other jurisdictions, education corporation, or educational service agency.

Additionally, as used herein, the term “administrator” or “school administrator” relates to a representative of a school or other education organization who is authorized to perform an analysis of the organization's performance and/or assist with improvement plans for the organization. In one embodiment, an administrator is a principal, vice principal, school improvement specialist or other individual or entity who or that performs administrative functions at or for the organization, regardless of other roles (e.g., involving teaching) the person or entity performs. In one embodiment, the administrator is an employee of the organization being evaluated. In one embodiment, the administrator is an employee of the local school district. In one embodiment, the administrator is an employee of a state education agency or state department of education. In one embodiment, the administrator is an employee of a private organization or partner agency involved in the accreditation and/or school improvement process.

Additionally, as used herein, the term “survey” relates to an instrument designed to collect stakeholder perception data from stakeholders, wherein a stakeholder is anyone who is involved in the organization's improvement process, such as parents, students, school staff, and community members. According to some embodiments, as used herein, the term “diagnostic” refers to an assessment of an education organization's performance in any of various aspects of its operations and/or its effectiveness in achieving its objectives.

Embodiments of the present invention are directed to methods and/or systems, including computer programs and databases, for analyzing an education organization and providing and/or facilitating the provision of an improvement plan for the education organization. At a general level, the system and methodology provides a repository for information analyses and plans relating to the education organization that is common to the education organization and external entities that assess the education organization, and provides a framework common to the education organization and the external entities by which they may conduct such analyses. In some embodiments, for instance, the framework defines a set of standards, and sets of indicators associated with respective standards, that form the basis of the diagnostics. Having a common basis, the (internal) diagnostics performed by the education organization itself, and the (external) diagnostics performed by the external entity(ies) can be compared and can be used together in forming improvement plans.

On the education organization side, the process begins when an education organization administrator enters data, and/or the system acquires existing data from a jurisdictional data source, if available. The education organization performs diagnostics based upon the data, performs a root cause analysis based upon the diagnostics, and generates an improvement plan to address problem causes identified by the root cause analysis. An external entity performs its own diagnostic, using the same formulas as the education organization, defines objectives for the organization, and generates reports.

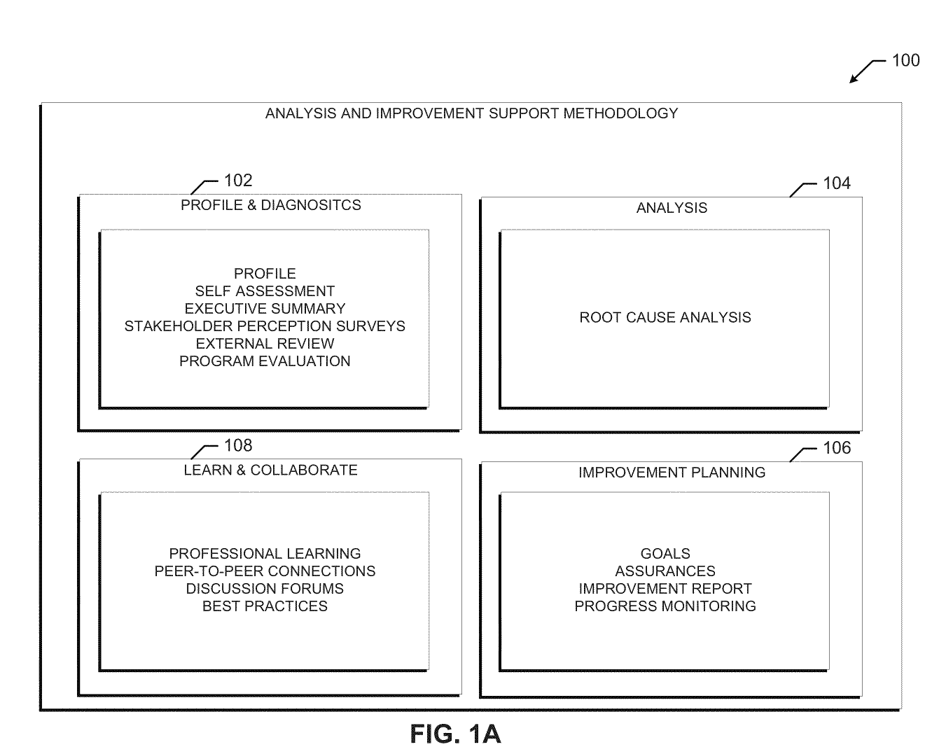

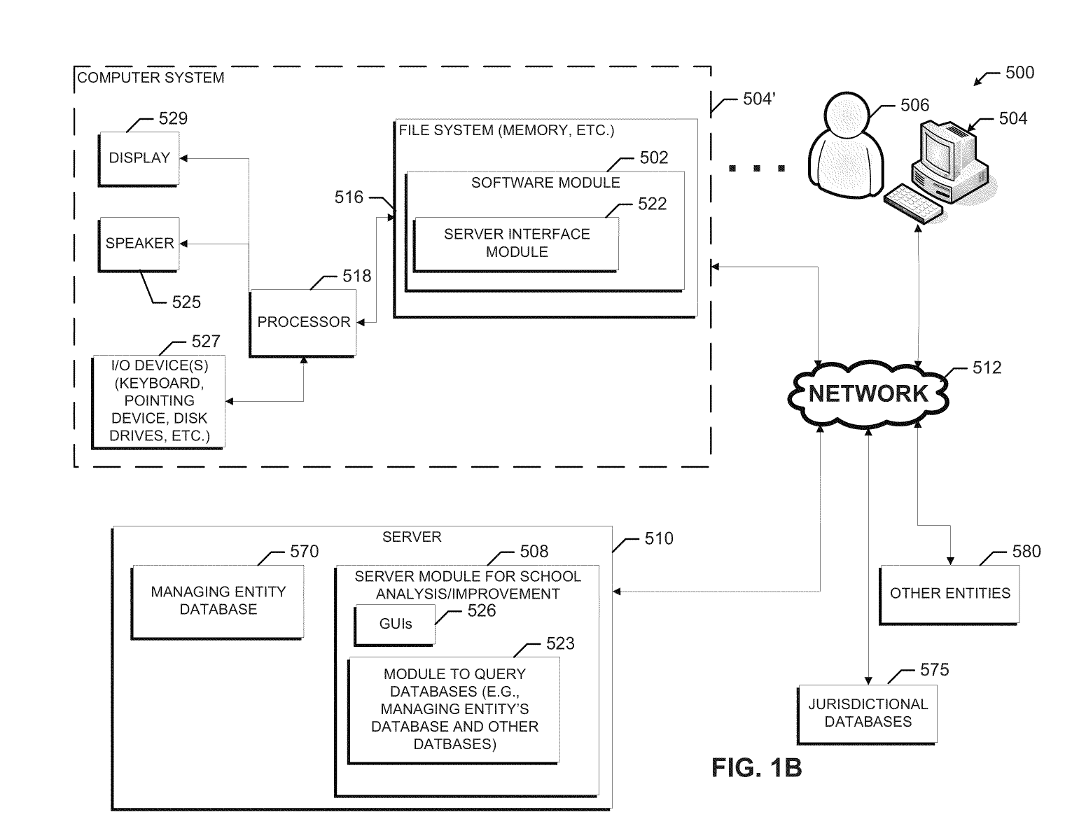

FIG. 1A illustrates a block diagram 100 of a school analysis and improvement methodology in accordance with some embodiments, or in some embodiments of arrangements. The discussion below presents one or more examples of how such steps may be effected, but it should be understood that this is for example purposes and that steps illustrated herein as being manual may be automated, and vice-versa. The blocks identified within methodology 100 are general representations of steps effected in the method, which may be executed by one or more individuals outside a computer system, or in conjunction with a computer system, or automatically by the computer system alone.

At a profile and diagnostics process 102, an administrator enters profile information into the system describing the education organization. As described below, the administrator may do this after the education organization and the managing entity reach an agreement by which the organization will utilize the system and the managing entity will provide an assessment of the organization and/or facilitate an improvement process. Alternatively, the system may access a jurisdictional database to download some or all of such information. The administrator may then complete a self-assessment diagnostic and an executive summary diagnostic, initiate stakeholder perception surveys, and receive external review/student performance data. Each of these items is discussed below.

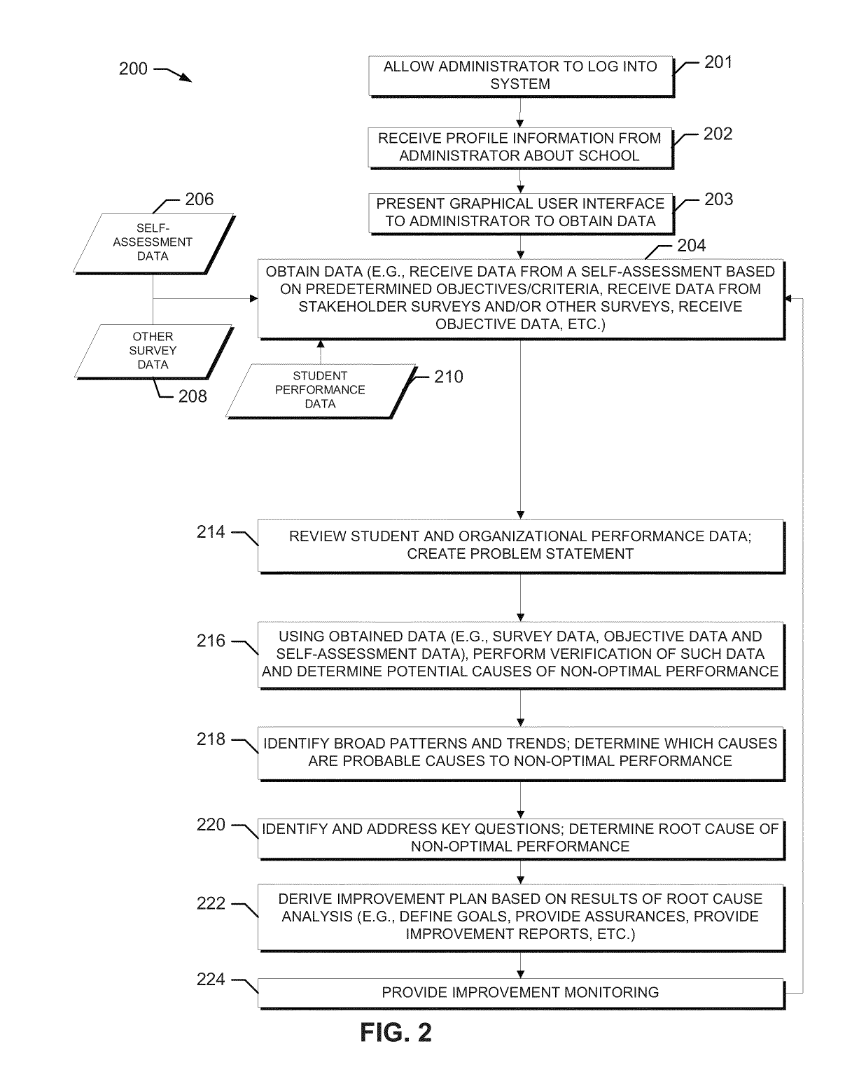

At an analysis process 104, an administrator analyzes the data received and developed at process 102. In one example, the administrator identifies a problem, scans the data to determine potential causes of the problem, analyzes patterns and trends to determine probable causes of the problem, and correlates the probable causes to determine actual causes. In certain embodiments, software is used to analyze the data to determine a root cause. The root cause analysis is discussed below with regard to FIG. 2.

In process 106, the administrator provides various information to an automated system for an improvement planning process. The administrator develops improvement goals the organization is to achieve and attests to a set of assurances designed (e.g. by the managing entity) to address federal, state and accreditation requirements. The administrator utilizes the system to generate an improvement report that may include the information gathered through the system, such as via the diagnostics, the improvement plan, and the assurances. Improvement plans can be configured to address specific needs of jurisdictional entities responsible for managing school improvement and accreditation processes.

An accreditation entity may monitor the education organization's improvement process as part of its evaluation whether the education organization meets accreditation standards defined (typically) by the accreditation entity or an external authority having jurisdiction over the education organization. As should be understood in this art, an accreditation entity is typically approved by the jurisdictional authority to perform accreditation services for education organizations in the jurisdictions, and multiple accreditation entities may be approved in a given jurisdiction. In the presently-described embodiments, the accreditation entity (which may also be the managing entity) may define multiple sets of standards and indicators (described below) for application to the respective types of organizational entities it may review, e.g. early education organizations, secondary schools, online learning organizations, corporate schools, and/or parochial schools.

In block 108, the system presents various learning and collaborative tools to the administrator to facilitate the education organization's development beyond the analytical framework defined by the first three blocks. These tools may include professional learning information (which may include learning materials developed by the managing entity or by third parties, such as departments of education) for use as training materials, peer-to-peer connections, discussion forums, and best practices defined by the managing entity through its research efforts. In certain embodiments, these tools are available to an education organization's faculty, employees and/or administrators, and, where applicable, members of parent organizations and other organizations to leverage a network of information and individuals to achieve the organization's improvement goals and objectives.

FIG. 1B is a block schematic diagram of an education organization analysis and improvement system 500 in accordance with one or more embodiments of the present invention. System 500 may include a software module 502 operable on a computer system 504, or similar device of an administrator 506. System 504 may be a personal computer or mobile device that operates entirely under the control of administrator 506, but may also be a client computer networked to a server on which some or all of the functionality described herein is performed. Thus, it should be understood that system 504 can encompass various computing systems and arrangements. System 500 also includes a school (for ease of explanation, the term “school” is used herein, often interchangeably with the term “education organization,” but it should be understood this is for purposes of discussion only and not for purposes of limitation) analysis/improvement module 508 operable on a server 510 (hereinafter “server school analysis/improvement module”) at and/or controlled by a managing entity. The managing entity, for instance an accreditation entity, controls and manages the school analysis/improvement tool and provides this tool to education organizations. The managing entity collects data into database 570 and/or facilitates collection of data by the education organization. Through system 510, the managing entity facilitates the operation of an education organization diagnostic process, as discussed below with respect to FIG. 2 and following figures. As such, the managing entity may work with education organizations and their administrators to accredit the organizations and to assist in analysis of the organizations and related improvement plans. The managing entity is not, however, otherwise affiliated with the organizations or their administrators.

Server 510, including database 570 (and also optionally computer system 504), may be considered to correspond to the term “system” as used herein. Server 510 is accessible by administrator computer system 504 via a network 512 such as the Internet. Where computer system 504 is a mobile device, the computer system 504 may connect to network 512 via a cellular network, as should be well understood, and in such embodiments network 512 should be understood to include a cellular network. One or more of the methods discussed herein may be embodied in or performed by software module 502 and/or server school analysis/improvement module 508, alone or in conjunction with an administrator at the education organization. That is, some of the features or functions of the presently described methods may be performed by software module 502 on computer system 504, and other features or functions of the presently described methods may be performed by server school analysis/improvement module 508 on server 510. In another embodiment, all of the features or functions of the presently described methods may be performed by server 510 or computer system 504.

Managing entity database 570 may be operable on server 510 or may be operable separate from server 510 and may be communicable by administrators 506 using their respective computer systems 504. Managing entity database 570 includes various data relating to education organizations that are enrolled with the managing entity that controls server 510 and that implements the school analysis/improvement methodology 100 in conjunction with the administrator as described herein. Each education organization is allotted a series of data records in the database that are associated with the organization so that those individuals who access the system and who have permissions that associate them to the organization can access the organization's data in the database. Each organization's database records include data specific to the respective organization, including profile data, school performance data, diagnostic data (including stakeholder perception survey data, self-assessment diagnostic data, and external review diagnostic data), student performance data, student demographic information, school goal data, assurance data, stored reports, and the like.

Each computer system 504′ may be similar to the exemplary computer system 504 and associated components illustrated in FIG. 1B.

Each software module 502 and/or server school analysis/improvement module 508 may be a self contained system with embedded logic, decision making, state based operations and other functions that may operate in conjunction with collaborative applications, such as web browser applications, email, telephone applications and any other application that can be used to communicate with an intended recipient. Education organizations may utilize the self contained systems as part of a process of analyzing school performance and developing an improvement plan.

Software module 502 may be stored on a file system 516 or memory of the computer system 504. Software module 502 may be accessed from file system 516 and run on a processor 518 associated with computer system 504. Software module 502 may include various modules that perform steps as discussed herein.

Software module 502 may also include a module 522 to interface with the server (hereinafter “server interface module”). The server interface module allows for interfacing with modules on server 510 and communicates with server 510 to upload and/or download requested data and other information. As such, computer 504 may act as both a requesting device and an uploading device. Additionally, the server interface module allows for transmission of data and requests between computer 504 and server 510. For example, server interface module 522 allows for a query message to be transmitted to the server and also allows for receipt of the results. The server interface module distributes data received to the appropriate server module for further processing.

Any query may take the form of a command message that presents a command to the server, which in turn compiles the command and executes the requested function, such as retrieving information from database 570.

Software module 502 may also present screens of one or more predetermined graphical user interfaces (“GUIs”) through which the administrator may input data into the system, select data from the system, direct computer 504 to perform certain functions, define preferences associated with a query, or input any other information and/or settings. School analysis/improvement module 508 may generate the screens, which may be provided to module 502 and, in turn, presented to the administrator on a display 529 of computer system 504. The screens are the physical instantiations of the GUIs, which can be custom-defined (e.g. respective GUI's may be defined for device types having different displays and/or other differing platform characteristics, e.g. desktop or mobile) and execute in conjunction with other modules and devices on the user's computer 504, such as I/O devices 527, server interface module 522, or any other module. The system as described herein may be considered to have a single or multiple GUIs. The predetermined screens may be presented in response to the administrator's attempts to perform operations (such as those described below with respect to FIG. 2), query the database, or enter information and/or settings. The GUIs and their screens present user notifications and may allow the administrator to custom define a query as discussed herein. An example of the GUI is discussed herein with regard to the remaining Figures.

Administrator computer system 504 may also include a display 529 and a speaker 525 or speaker system. Display 529 may present applications for electronic communications and/or data extraction, uploading, downloading, etc. and may display survey data, performance data, notifications, etc. as described herein. Any GUI associated with school analysis/improvement module 508 and application may also be presented on display 529. Speaker 525 may present any voice or other auditory signals or information to administrator 506 in addition to or in lieu of presenting such information on display 529.

Administrator computer system 504 may also include one or more input devices, output devices or combination input and output devices, collectively I/O devices 527. I/O devices 527 may include a keyboard, computer pointing device, or similar means to control operation of applications and interaction features described herein. I/O devices 527 may also include disk drives or devices for reading computer media, including computer-readable or computer-operable instructions.

As noted above, server school analysis/improvement module 508 may reside on server 510. It should be understood that server school analysis/improvement module 508 may also, or alternatively, reside on another computer or on a cloud-computing device. One or more of the sub-modules of the server school analysis/improvement module 508 may all run on one computer or run on separate computers.

Server school analysis/improvement module 508 includes one or more graphical user interfaces (“GUIs”) 526, as described above. The GUI screens are generated by server 510 and allow the administrator to access the GUI using a web browser to enter data on the GUI through a software as a service (“SaaS”) or other application programming interface (“API”). Thus, when the administrator enters data on the GUI, server school analysis/improvement module 508 stores the data in managing entity database 570.

Server school analysis/improvement module 508 also includes a module 523 to query databases (hereinafter “query module”). Query module 523 allows a user to query data on server 510 and, thereby, from managing entity database 570. In certain embodiments, the module may be used to execute queries against external databases, such as database 575. The query may take the form of a command message that presents a command to server 510, which in turn compiles the command and executes the requested function, such as retrieving information from database 570 or database 575. Query module 523 communicates with server 510 to upload a query and download requested items via server interface module 522. After transmission of a query message and retrieval of the query results, query module 523 may store the retrieved data in the memory for future retrieval.

Jurisdictional database(s) 575 are connected to network 512 so that server 510 can retrieve information therefrom. Jurisdictional database(s) 575 are managed by private or governmental entities, e.g. private or governmental school jurisdictions or testing or regulatory entities, who may give permission to the managing entity of server 510 to access information on jurisdictional database(s) 575 for data corresponding to education organizations enrolled with the managing entity. The jurisdictional entity may govern and collect data from multiple education organizations. Some states, for example, collect and maintain data about the education organizations within the state, such that school profile information discussed below may be obtained from the jurisdictional database, provided the format of such data is known. This obviates the need for a given education organization to enter or upload its own information. Jurisdictional database(s) 575 are remote from the managing entity in the sense that the managing entity does not control the jurisdictional entity's computer systems, and vice-versa. Jurisdictional database(s) 575 may contain student performance data and other information (e.g. raw grading data, raw test performance data, and student demographic data) that schools regularly report to the jurisdictional entity in the normal course of business. The managing entity, with the jurisdictional entity's permission, periodically or intermittently downloads data from jurisdictional database 575 related to the education organizations within the jurisdiction that have reached agreement with the managing entity to use the system and its framework in performing assessments of the organization and defining action plans.

For example, managing entity system 510 may download, from a state department of education database 575, school performance data (indicated at 210, in FIG. 2) maintained in that database for education organizations of that state that have entered into agreements with the managing entity to allow the managing entity to perform assessments of the organization and to allow the organization to use the managing entity's system for school improvement analysis. The content and format of this data varies from jurisdiction to jurisdiction, and system 510 may therefore include a translator for respective jurisdictions. Based on the jurisdiction's database format, the translator selects the desired data from the database 575 and translates the data into a common format used by database 570. The managing entity creates the translator, and executes the downloads, in conjunction with the jurisdictional entity that controls and manages database 575. In some instances, however, broad jurisdictional databases are not available, and in that case the education organization may provide performance, demographic, and attendance data for the organization's students directly to the managing entity.

Other entities 580 are also connected to network 512. These other entities may be accreditation entities (this may be in addition to the managing entity, in those instances where the managing entity is an accreditation entity), governmental entities, or the like with which education organizations may need to communicate. These entities enroll with the managing entity, are provided login credentials, and are assigned access rights to view data and reports relating to education organizations over which they may have jurisdiction or with which they reach suitable agreement. For example, a school may need to submit a report that includes assurances to an accreditation entity and, thus, could do so by creating the report through the system, thereby allowing the accreditation entity to access the report over network 512.

The flowcharts and block diagrams in the Figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems which perform the specified functions or acts, or combinations of special purpose hardware and computer instructions.

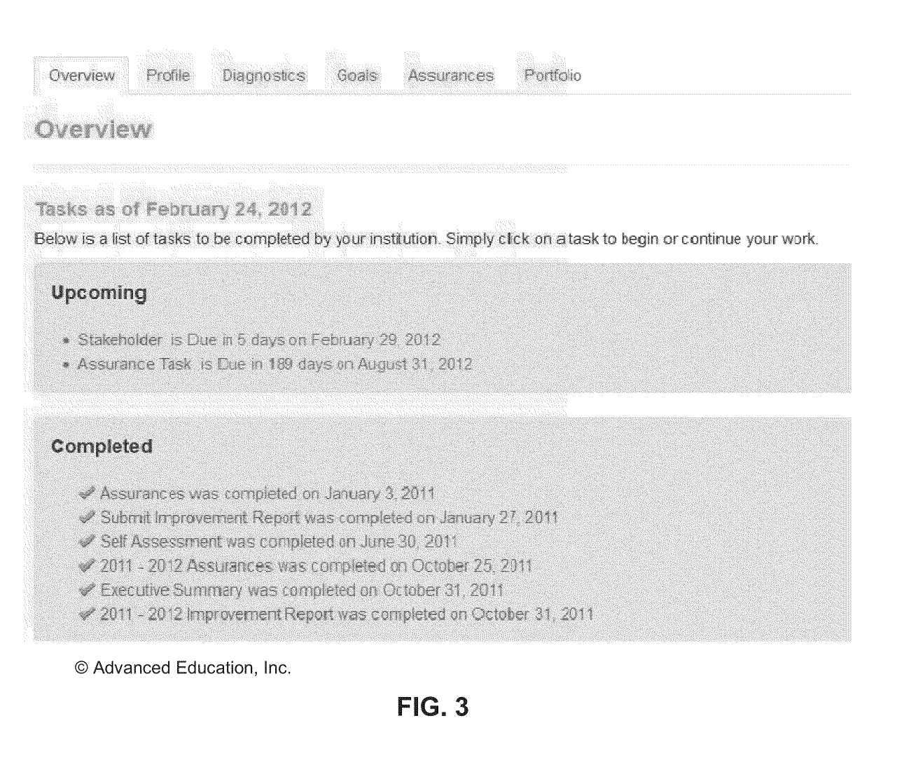

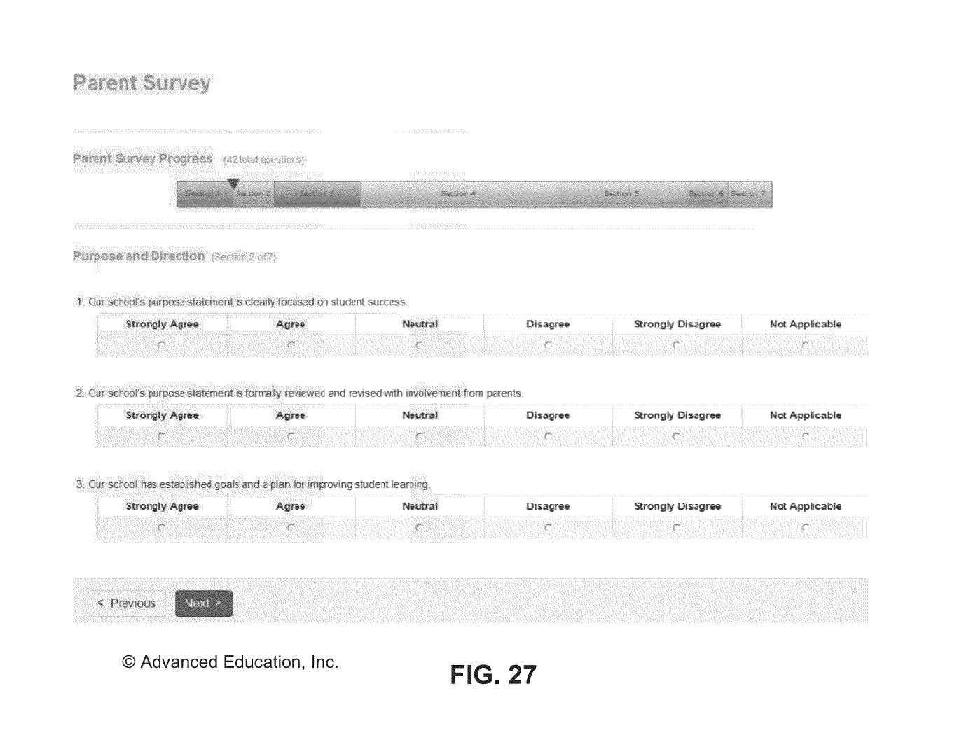

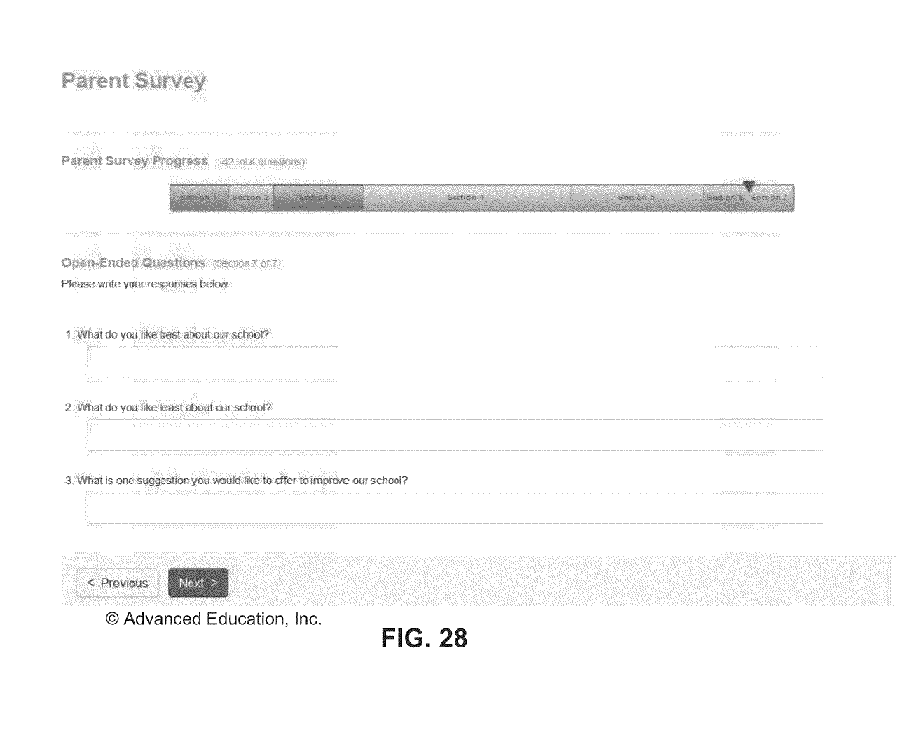

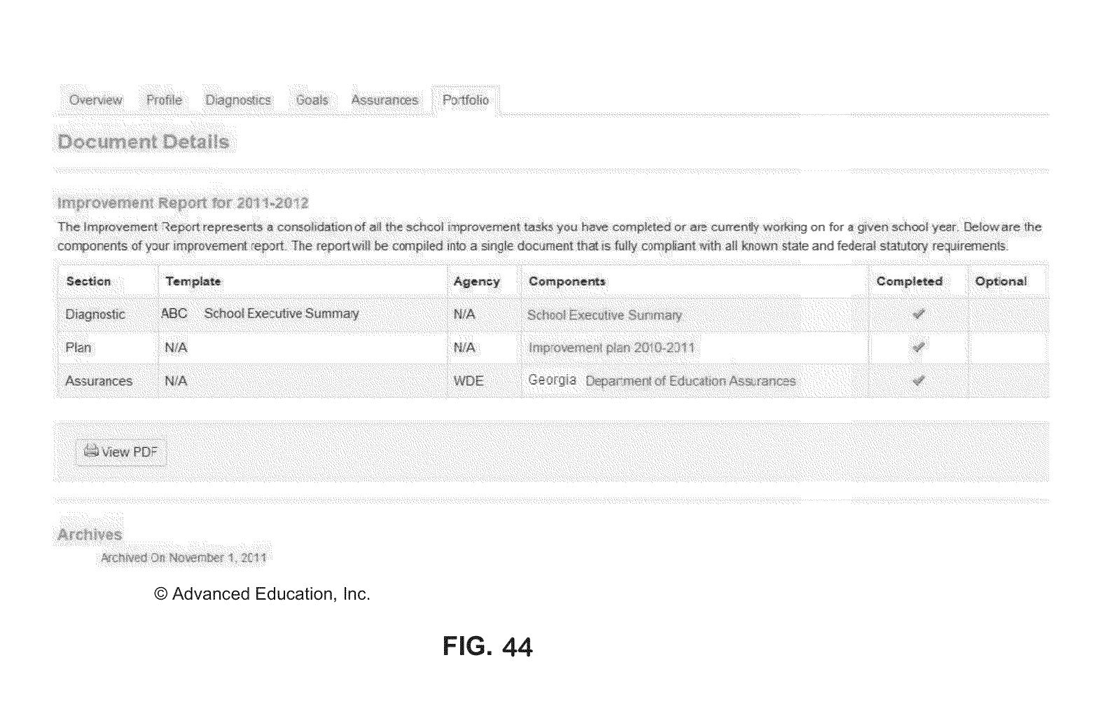

FIG. 2 illustrates an exemplary method 200 for diagnosing, implementing and monitoring an education organization's performance. Also with reference to FIG. 1B, the method is preferably implemented in whole or in part via a computer (510 and/or 504) that executes computer instructions (502, 508) that may perform each or part of the steps described at method 200. As noted above, the system presents graphical user interfaces to an administrator 506 of the education organization at 529, in execution of the method described herein. Accordingly, these GUI screens are presented in the Figures according to various embodiments, and method 200 is described below with regard to FIGS. 3-45, in conjunction with FIG. 2.

As previously discussed, the administrator may be a designated employee or other person associated with the education organization at issue, who is preferably familiar with the organization's operations and performance. The administrator, who may be considered to operate the system on behalf of the organization, is responsible for collecting self-assessment data and stakeholder perception data, inputting the data into the system, and entering other information impacting organizational improvement, for example defining goals, improvement plans, and assurances (as is discussed below). The administrator performs a root cause analysis using the system and data in the system.

As indicated at block 201 of FIG. 2, the administrator logs into the system at computer system 504 using a login GUI screen presented by the system that requests the administrator to enter a username/password combination. Database 570, maintained by the managing entity, contains a list of unique username and password combinations for each administrator authorized to utilize the system and to have access to one or more given education organizations' data. Once the administrator enters a username and password, the GUI sends the entered combination to managing entity server 510, which compares the submitted password with a password stored in database 570 and associated with the submitted username. Should the stored password match the inputted password for the administrator's entered username, the system authenticates the administrator to the system. The GUI then presents a screen at which the administrator may select any one of the one or more education organizations to which the administrator's username is associated in the database. The administrator selects an organization, causing the GUI to send the selection to module 523, and thereby selecting that organization's data for use in the present session. Subsequent actions by system 510 with this administrator are performed with the data stored at database 570 in association with the selected education organization.

The database associates the administrator with an education organization, and hence with the organization's data, by associating the administrator's username with a customer number for that organization. Previously, when initially enrolled with the managing entity, the managing entity will have set up a new account for the organization in database 570. This creates a new database entry for the organization and associates the organization with a customer number assigned by the managing entity, e.g. automatically by system 510. The managing entity's system stores all data for the school in database 570 and associates (via the organization's customer number) all such data with the organization.

### Overview

FIG. 3 illustrates an overview GUI screen that the system presents when the administrator logs into the system. The overview screen includes selectable tabs or sections pertaining to “Overview,” “Profile,” “Diagnostics,” “Goals,” “Assurances,” and “Portfolio.” The “Overview” tab in FIG. 3 is the default view and is thus presented at start up, when the administrator logs in to server module 508 via computer module 502. The screen presents a high-level overview of the status of the various assessment and improvement plan tasks that the database records for the administrator's school. These tasks, in turn, relate to a protocol applicable to the education organization. The managing entity defines a protocol for each education organization, either by defining a given protocol for a specific organization or for a jurisdiction so that the protocol is applied to all education organizations within the jurisdiction. In general, a protocol is a predetermined organization of data and functions relating to improvement analyses and processes. The protocol defines a hierarchy or organization of the performance data, tailored to the data that is available for a given school or jurisdiction. For example, as discussed below the hierarchy assumes that all education organizations will have data describing the content the organization provides to its students. But that content may vary, for instance from school to school or jurisdiction to jurisdiction. One school may categorize certain coursework content as “English,” whereas another might teach the same content, but categorized differently, such as by “literature,” “composition,” and “grammar.” Other schools might have different content altogether, e.g. welding and automotive mechanics. Similarly, the presently-described embodiments assume all education organizations organize their students into groups that correspond to levels at which the content is taught, but those organizations can vary. Some schools, for instance, may organize students into the traditional K through 12 grade arrangement, whereas others may organize students by proficiency level, or by age. But in such primary groupings, the groupings correspond to how the content is allocated to the students. Education organizations may also identify students by further subdivisions, which may be independent of the content, e.g. race, ethnicity, or gender, but such subgrouping may vary as desired and appropriate, e.g., for a given education organization and jurisdiction. That is, the present embodiments assume that all education organizations provide content to their students, and categorize their students into groups corresponding to content and to subgroups that are independent of content, and all protocols in these embodiments organize the performance data under these three broad groups. Within each group, however, the data may be organized as the education organization, and in particular a jurisdiction, desires. Thus, the managing entity defines the data hierarchy within a given protocol to correspond to the content, grades, and subgroups within which the education organizations or jurisdiction organize their data and defines a translator to automatically pull the organization's or jurisdiction's performance data and populate database records corresponding to the respective education organizations with the retrieved data.

Similarly, the present embodiments assume that the improvement processes for all education organizations will involve profile data, diagnostics, improvement plans, reports, and assurances, as described in more detail herein, but each of these can vary from one protocol to another. Profile data, for example, describes the identity and characteristics of an education organization. The protocol defines the data items that comprise the profile data. For instance, all protocols may include information such as the school's name, customer number, and grades taught, but a given protocol may also call for information specific to an education organization or jurisdiction. For instance, a protocol may be defined for all schools within a given state, where the state classifies the schools by county for certain purposes. Thus, a school's county would be important in such an example, and the profile data for this particular protocol would include identification of the county. Further, and as described below, the presently described embodiments all encompass at least four types of diagnostics—self-assessment, executive summary, stakeholder surveys, and external reviews—but the format of these diagnostics, and the information each seeks to obtain, varies by protocol. In particular, and also as described below, the diagnostics can be built based on standards and indicators that, if present, indicate that the school is operating at a proficient level. Because the functions and missions of education organizations may vary, the managing entity varies the diagnostics, and particularly the standards and indicators, from protocol to protocol, to account for these differences. That is, even though all protocols in these embodiments will have self-assessment, executive summary, survey, and external review diagnostics, and even though each such diagnostic may be built upon a set of standards and indicators, the standards and indicators may vary from protocol to protocol, thus causing variation in the diagnostics from protocol to protocol. Because the standards and diagnostics, and the underlying data may vary, so too may the improvement plans and reports vary. Assurances may also vary as a result of standards variations, but they may also vary simply because a given protocol is applicable to a given jurisdiction that issues a given set of assurances.

The protocol may also require that for any education organization set up in the database under that protocol, the education organization should complete the assurances associated with the protocol and should complete one or more particular diagnostics, one or more surveys, and possibly one or more predetermined improvement plans, so as to facilitate an external review. FIG. 3 lists all such required tasks associated with the protocol for which this particular education organization is associated, and indicates the status of each task with respect to this particular education organization. As the particular actions, such as internal and external assessments, assurances, surveys, and reports, that are effected through the system in association with the school (and, thus, recorded by system 510 in database 570), are associated in the database with a time stamp corresponding to the date the action occurred, the system knows whether an action has been completed. The discussion below provides explanations of the various actions themselves, but for purposes of the Overview screen, the GUI presents a “Completed” screen that lists each completed event associated with the school. As is also described below, the database records actions that are to be completed by a future date, and the GUI lists those in an “Upcoming” screen. For example, the items shown in FIG. 3 that the administrator has completed include: improvement reports, assurances, an executive summary, and a self assessment. On the other hand, the administrator has yet to complete an assurance task and the stakeholder survey. Each of the items pending for the administrator to complete has a link that takes the administrator to a graphical user interface screen to complete the associated task. Each associated task has computer instructions that request information from the administrator to input via one or more GUI screens. Once the administrator inputs the requested information into the GUI, the system stores the information in database 570 in association with the school.

### Profile & Diagnostics

When each school enrolls with the managing entity, the managing entity obtains predetermined profile information from the school and manually inputs this information into managing entity's database 570. The managing entity assigns a customer number to the school that is unique to the school among the other schools in the database, and the database includes one or more records with the profile information, each record associated with the customer number so that when the school or school administrator requests information, the school's data is then retrieved from the database. The managing entity also assigns permissions for each administrator that govern the administrator's access to data, e.g. allowing or not allowing access to certain data and/or allowing or not allowing the administrator to modify or delete certain data. The database stores an administrator's permissions with the administrator's username. In particular, the database associates each username with the respective customer number(s) for the education organization(s) whose data the administrator is allowed to access. When the administrator requests data (via a query) from database 570 via server 510, the database 570 will only return data in accordance with the permissions associated with the username associated with the query and for the customer number the administrator selects, as discussed above. Thus, a given administrator may access only that data associated with the customer number (i.e. school) associated with the administrator's username and selected by the administrator, and only to the extent allowed by the permissions associated with the administrator's username.

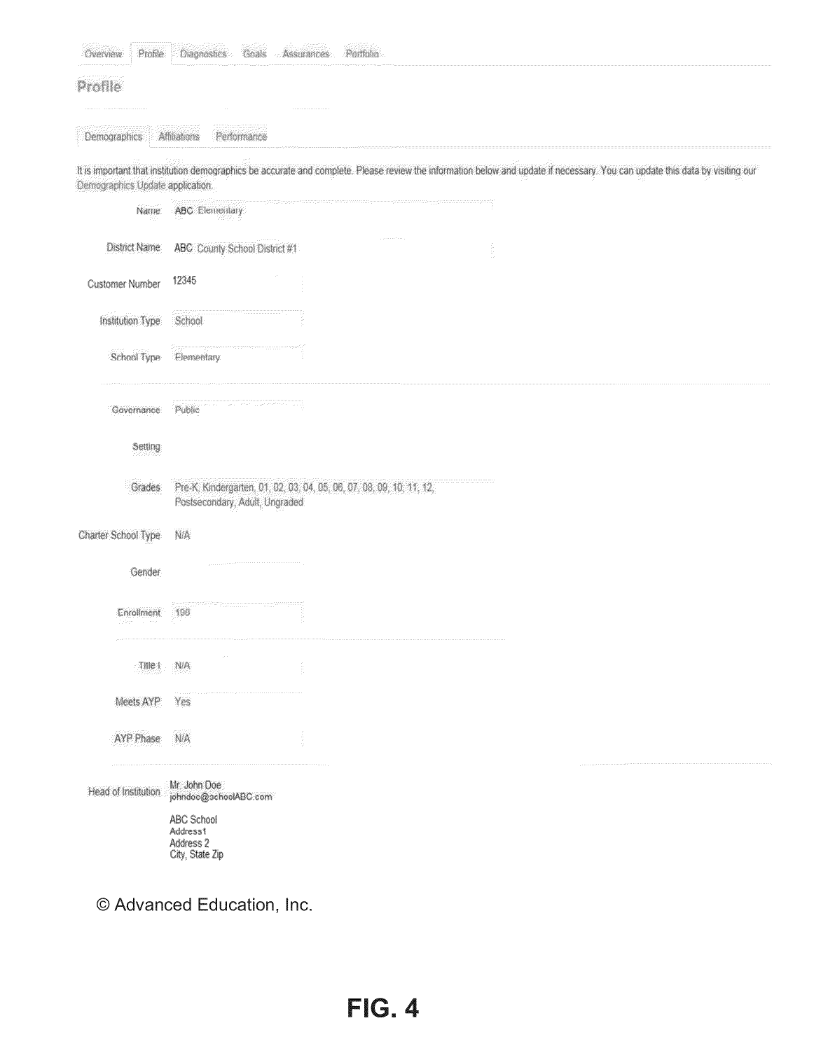

Referring back to FIG. 2, assume that, as indicated at block 202, the administrator clicks on, or activates, the “Profile” tab from the screen shown in FIG. 3. Server module 508 queries database 570 for profile information for the school associated with the administrator's username in the database via the school's customer number, and system 502 presents a profile GUI screen (FIG. 4) to the administrator, displaying the retrieved profile information and allowing the administrator to update the school's profile data.

The school's profile data can be subdivided into three categories in the presently-described embodiments—demographic, affiliations, and performance—as indicated by respective selectable tabs across the top of the screen shown in FIG. 4. The “demographics” tab is the default and is, thus, the screen presented upon initial selection of the “profile” tab from FIG. 3. As described above, the profile data may vary among education organizations, depending on the protocol applicable to the given organization, but in this example the demographic information includes: school name, school district, customer number, organization type (e.g. school, school system, or jurisdiction), general type (e.g. elementary, middle school, high school, and college), funding/governance type (i.e. public or private), student grades taught at the school, student enrollment, contact information for the head of the school, etc. At the profile GUI screen, the administrator may update the profile data if desired. The administrator may activate a hyperlink, such as the “Demographics Update” hyperlink shown in FIG. 4, to modify or initially input profile data. In response to the administrator activating such hyperlink, system 502 presents a profile-input GUI screen (not shown) to the administrator whereby the administrator can change or add information to the school's profile. As noted above, the demographic data may be entered manually by the managing entity when the education organization enrolls with the managing entity, or may be automatically downloaded to database 570 from a jurisdictional database via a translator.

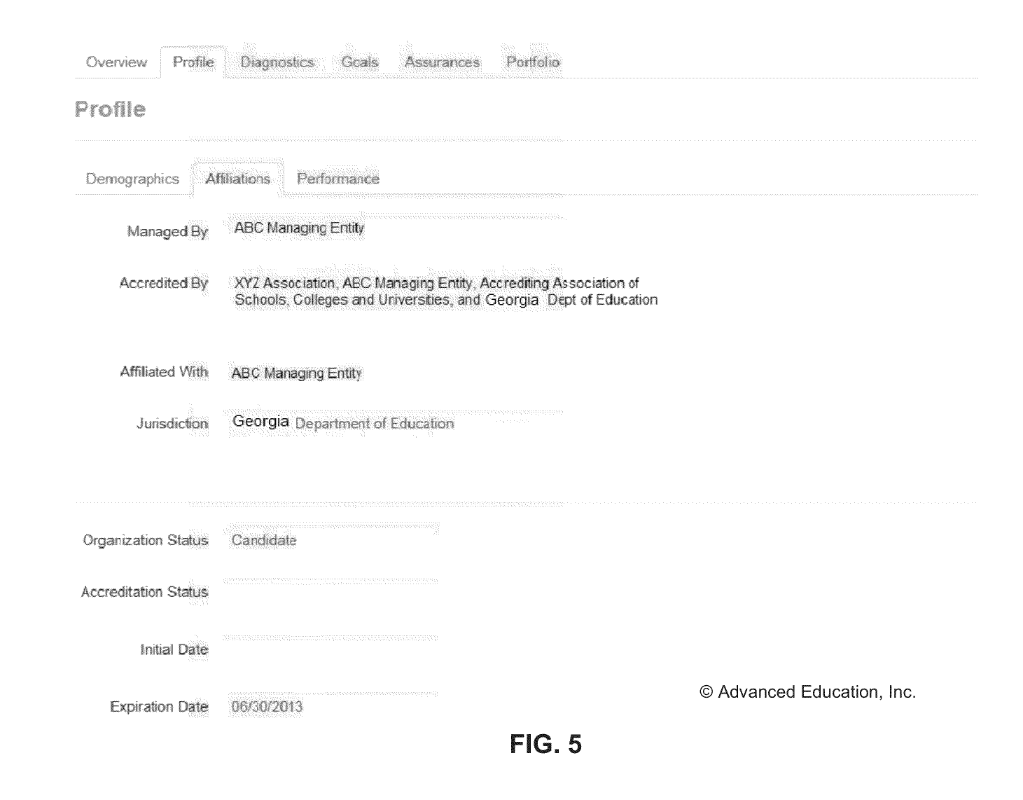

Selection of the “Affiliations” tab from the screen shown in FIG. 4 causes module 528 to present the screen shown in FIG. 5. The screen displays information maintained in system database 570 that describes the school's affiliations, including the identities of the managing entity and entities that accredit the school, and the school's jurisdiction (e.g., the state department of education and/or the county school district to which the school belongs). The managing entity typically inputs this information when initially setting up the school in the database. Again, the protocol applicable to this education organization defines the data fields for the affiliations record, such that the affiliations structure can vary from protocol to protocol. In another embodiment, certain information from the “Affiliations” tab (at the bottom of FIG. 5) is moved to an “Accountability” tab, which is accessible from the bar at the top of the screen of FIG. 4 and includes other information about the organization, e.g. whether it is subject to Title I.

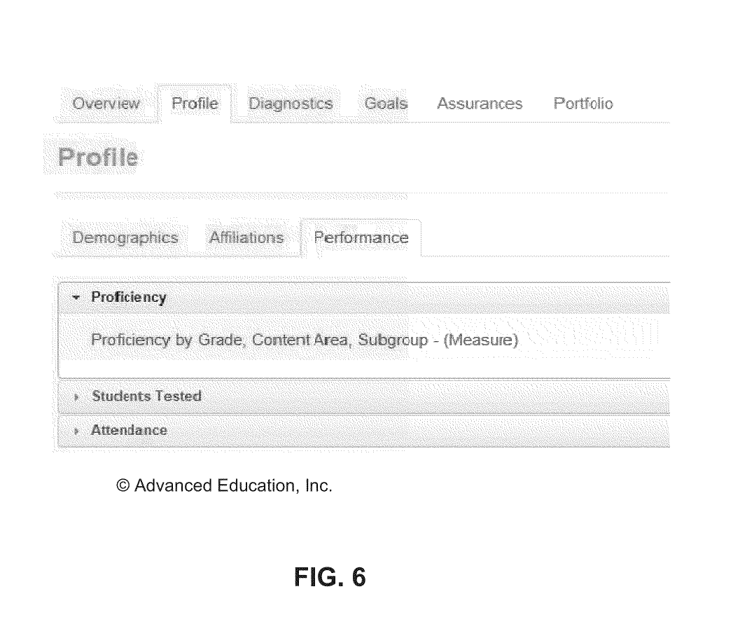

FIG. 6 illustrates a screen selectable by the administrator by activating a “Performance” tab from one of the other profile GUI screens, to access information describing the school's proficiency in terms of student performance. The performance screen allows the administrator to set search parameters that govern how data is presented under the “performance” tab. The screen presents a “proficiency” menu that provides access to student performance information, a “students tested” menu that provides information regarding the number of the school's students who have been tested under certain jurisdictional requirements, and an “attendance” menu that provides school attendance data. Each of these menus presents a section with a hyperlink that allows the administrator to view data from the managing entity's database 570 that correspond to the pull-down category. As noted above, student performance data is organized, at a highest level, by content area, student group (grade), and subgroup, and so the hyperlink provides a GUI screen to allow the administrator the ability to search the data for presentation based on those qualifiers. It should be understood, however, that different protocols, possibly with more specific categorizations, may provide screens that allow data searching and presentation based on more specific categories.

For example, activation of the hyperlink under the “Proficiency” pull-down causes the profile GUI's “performance” section to present screens allowing the administrator to perform queries against the selected school's performance data stored in database 570 to obtain targeted reports of student performance at the school. Server module 508 on server 510 performs the queries and generates the reports. The administrator is able to set parameters that define the reports by content area, student grade, and student subgroups (including race, sex, economic status, etc.). The data indicates the school's performance based on standardized assessments required by state departments of education and that may vary from state to state. It should be understood that the source of the student performance data is not critical to the present invention, although in certain embodiments there will be a translator to properly translate the source data into a school's applicable protocol, as noted above.

As described above, the managing entity system receives student performance, student demographic, and student attendance data from a governing jurisdictional database 575 or directly from the education organization itself. This data may include not only objective data, such as the number of students, student gender, student race, student age, student grade, subjects taught, student scores in those subjects, student attendance, etc. but also subjective data, such as cutoff levels (“cut scores”) that categorize students (anonymously) in database 575 based on performance data, in particular test scores—for example pass/fail, or perhaps more subjective levels such as below basic, basic, proficient, and advanced. The data may report the number of students in each grade and each subject within each category, or may provide the metrics by which this is determined As indicated above, the data format can change from jurisdiction to jurisdiction, and/or from school to school, as can the grade categories.

When the administrator selects the hyperlink under the “Proficiency” pull-down shown in FIG. 6, the GUI driven by module 508 causes system 504 to display a series of windows that allow the administrator to select the query parameters by which module 508 will select or query database 570. Server 510 then queries the database with the query parameters the administrator defines along with the administrator identification (which is retrieved from memory upon the administrator's login to server module 508) and the education organization the administrator selected at start up. The query returns only those results for the selected organization (i.e. by customer number) for which the administrator (via the permissions associated with the administrator identification) has permissions to receive.

The system returns to the administrator system 504 only student data that the administrator has permissions to receive. The system does not send data for other schools to the administrator unless the administrator specifically has permissions to receive such data.

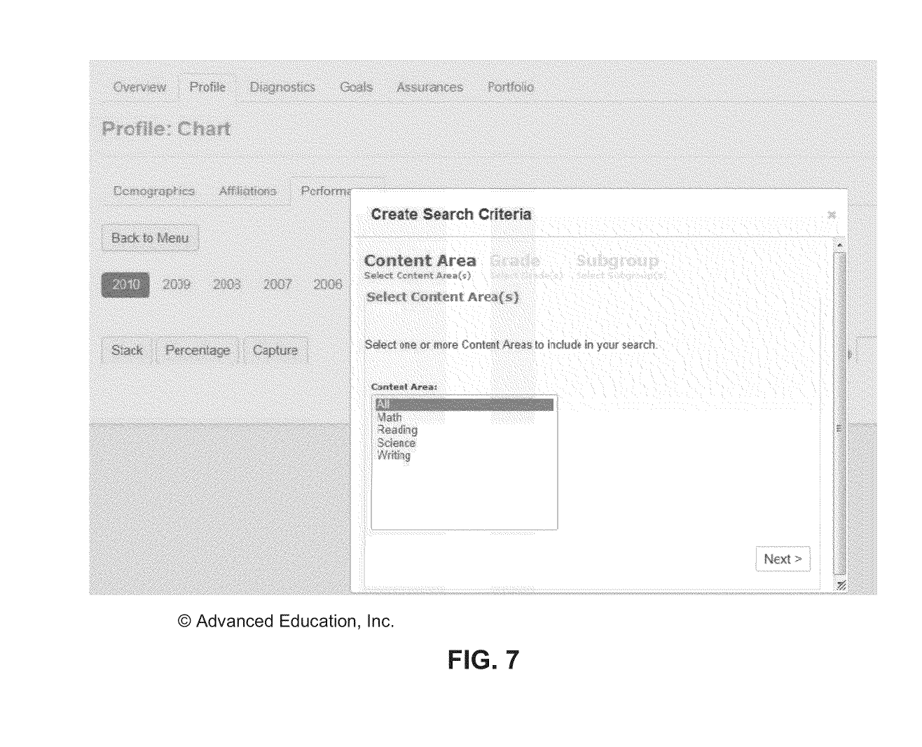

FIG. 7 illustrates the first of the series of windows, whereby the administrator determines the desired content to be presented under the “performance” tab. The “content” or “content area” refers to general educational subjects that the students are taught and into which the school's curriculum and class structure are organized, and thus into which the student grading data may be grouped in database 570. As noted above, the particular content areas appearing in the screen window in FIG. 7 depend on the content areas in the protocol applicable to this organization. In this particular example, the administrator can select from content areas of math, reading, science, writing, or all of these subjects, because these are the content areas defined in the protocol applicable to this organization and, therefore, the content areas by which data for this organization is arranged in database 570. By selecting a given content area, the administrator qualifies the data the administrator wishes to view. In FIG. 7, the administrator has selected to view data associated with all of the areas of math, reading, science, and writing. As such, module 508 retrieves data from database 570 and causes system 504 to present data for each of these content areas to the administrator.

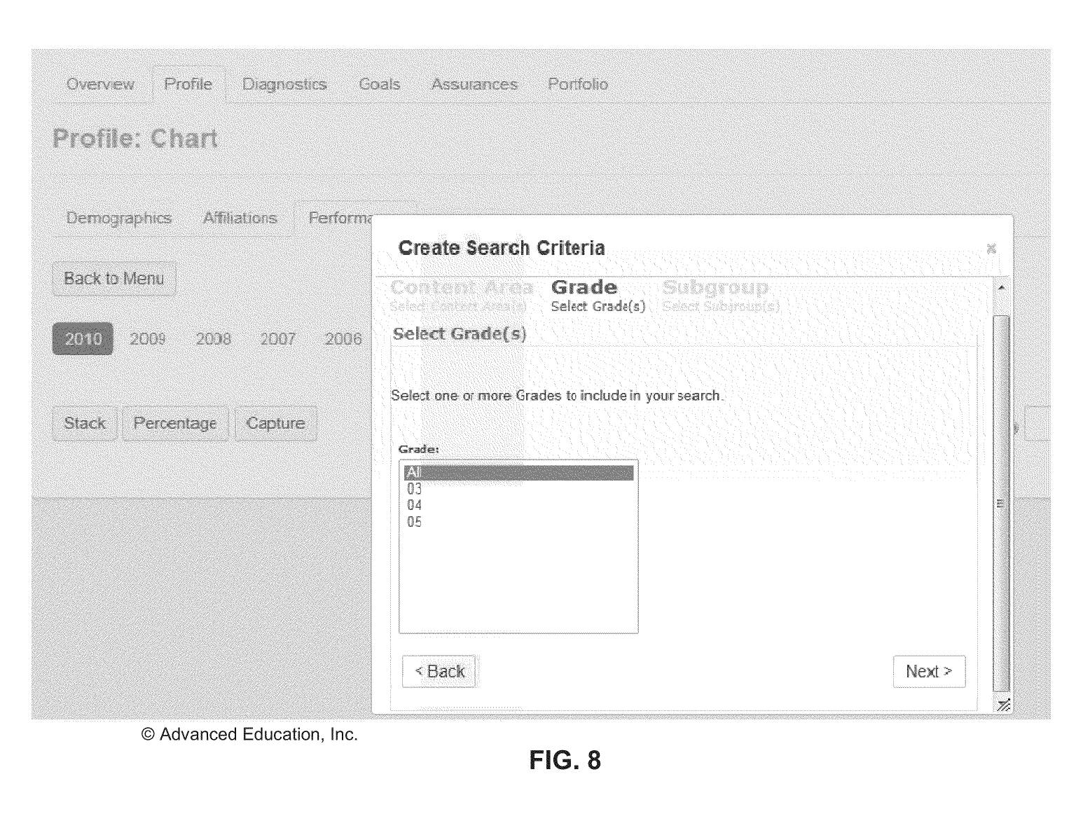

After the administrator selects the content area by which to qualify the information the administrator wishes to view, the system presents a window allowing the administrator to further qualify the data by student grade level. Again, these grade levels are defined by this organization's protocol. FIG. 8 illustrates an example of this window, in this instance providing the administrator the ability to select third grade, fourth grade, fifth grade, or all grades, for the content retrieved. In FIG. 8, the administrator has selected to view data for students in all grades (i.e., third, fourth, and fifth grades).

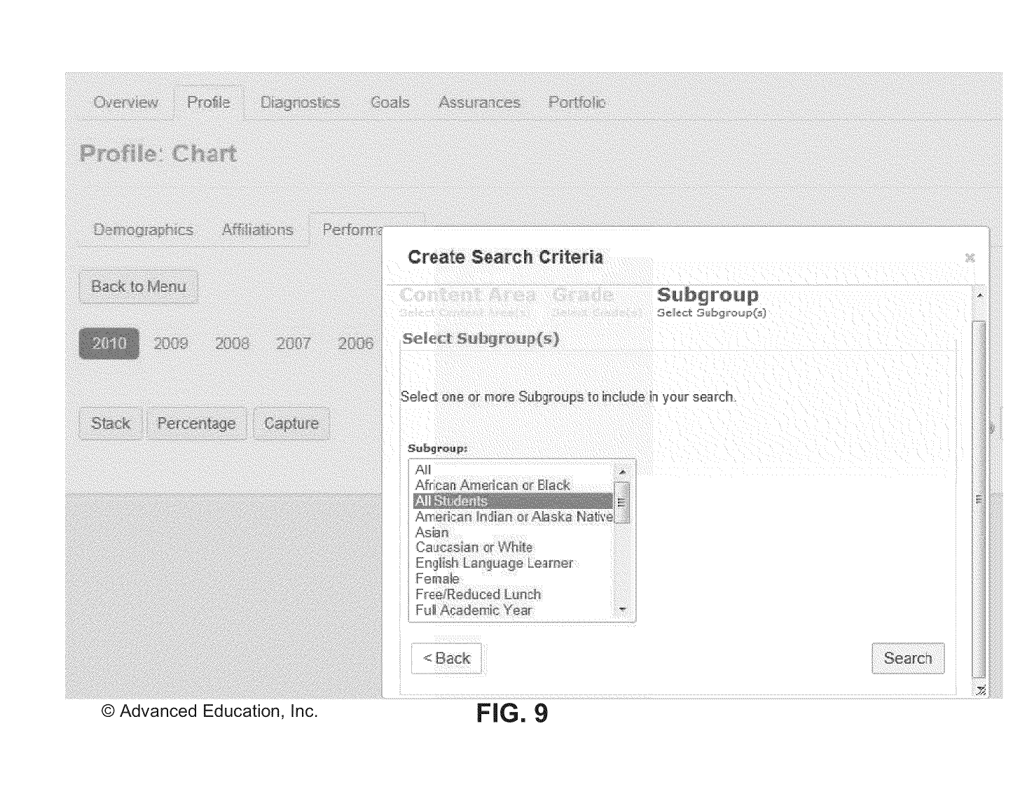

After the administrator selects the grades, the system presents another window to allow the administrator to select a subgroup by which data retrieved from database 570 is further qualified, as illustrated in FIG. 9. Again, the subgrouping is defined by the organization's protocol, and in this example corresponds to student demographic categories, including the student's race, ethnicity, economic status, gender, language capability, learning level (e.g. academically gifted, advanced, lower level, etc) or any other student characteristics supported by database 570. The characteristic is, thus, a search criteria or query parameter, allowing the administrator to select data corresponding to a specific subgroup of students having the selected characteristics in common. In FIG. 9, the administrator has selected to view data for all subgroups of students.

As such, the administrator has indicated that the administrator wishes to view data for each grade, content area and subgroup in all the possible permutations. For example, the administrator will not only see math data for third grade students who are Asian, but also reading data for these third grade students who are Asian. Module 508 presents all other possible combinations to the administrator.

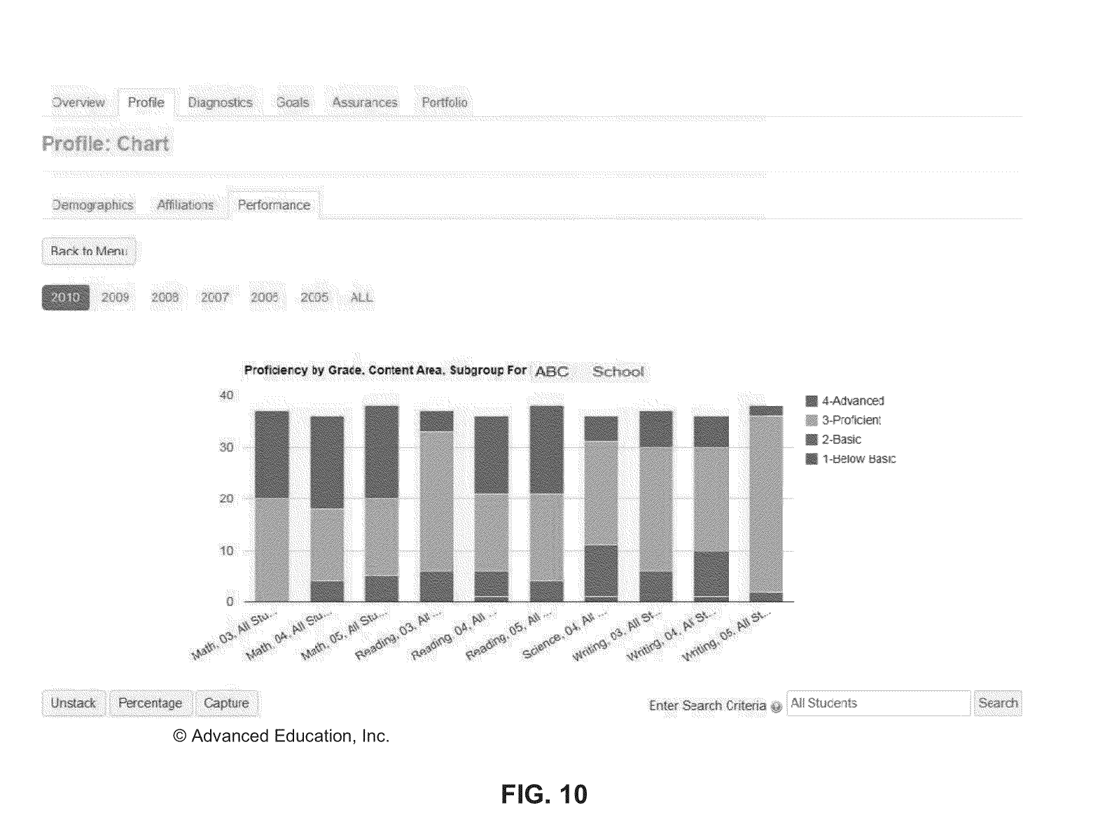

After the administrator clicks the “Select” button in the window of FIG. 9, server system 502 and module 508 submit a query against database 570, qualified by the specifically-requested query parameters. When the managing entity database 570 receives the query from the module to query databases 523, the managing entity's system presents the query output to the administrator via an output GUI screen (FIG. 10). As shown in FIG. 10, the output GUI can present the data in a stacked bar chart form, whereby the data for each category is stacked on top of each other, or unstacked bar form, a percentage form, or the like. A “capture” button allows the user to obtain an image, e.g. in .jpg format, for other use.

As illustrated the example shown in FIG. 10, the system GUI presents the output of the query results from the managing entity database to the administrator according to the parameters the administrator specifies in the query. For example, the far left-hand bar in the illustration of FIG. 10 presents the performance of third grade students in math, for all student subgroups. As the protocol for this organization supports a cut score format, which is present in the data, the screen illustrates how the data fits the cut scores. Approximately 20% of third grade students in the administrator's school are “proficient” in math, and approximately 18% of students in the 3^{rd} grade are “advanced” in math. The other bars illustrate data for the other categories included in the administrator's query. Since the administrator selected all subjects (i.e., math, reading and writing) and all grades (i.e., third, fourth and fifth), the system presents the data for each permutation of the subjects and the student grade levels. The particular data set shown in FIG. 10 illustrates that most students in all grades are either proficient or advanced in all subjects. However, if one set of students or subgroup of students were underperforming, that data would be readily visible to the administrator. The administrator may then take note of the anomaly as a problem statement and follow a process of root cause analysis in order to generate improvement goals, as described in more detail below.

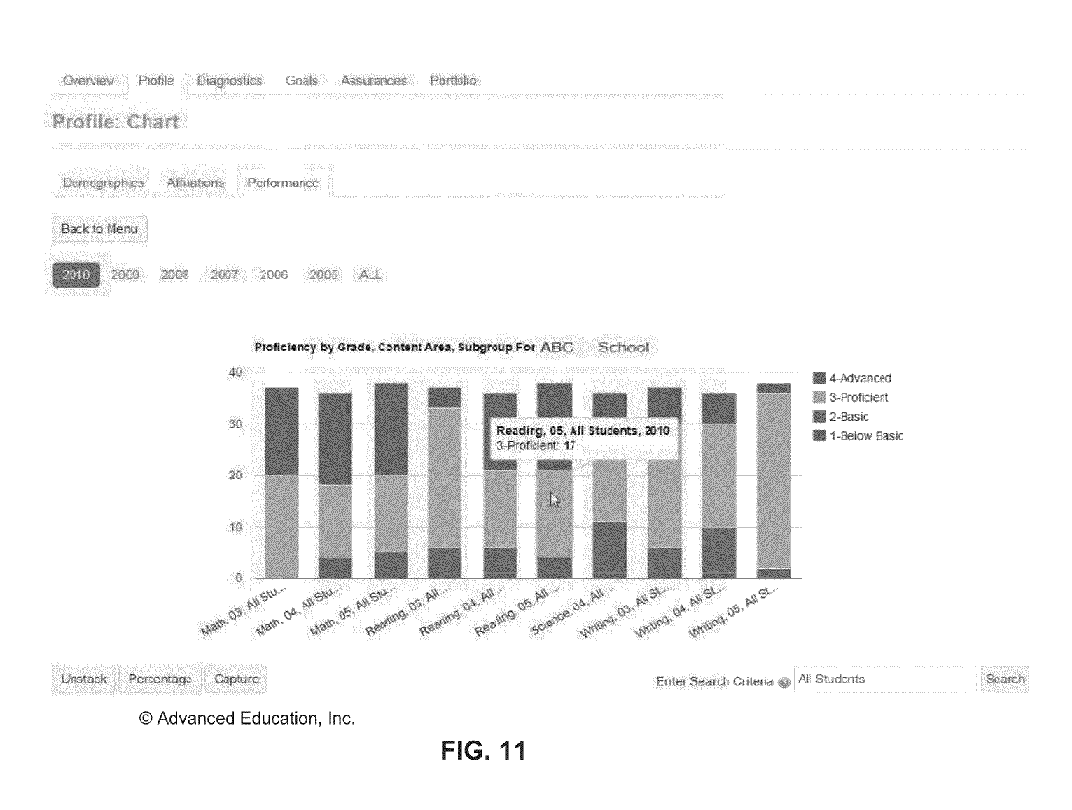

FIG. 11 illustrates that the administrator can hover his or her mouse cursor icon over a particular data subset, causing the system GUI screen to display a text box providing the underlying data in text form that is graphically represented by the data subset. In this instance, the administrator has selected the “proficient” section of the column bar corresponding to fifth grade math. Since the subgroups were selected, the column bar applies to “all” students. As indicated, seventeen students meet this criteria.

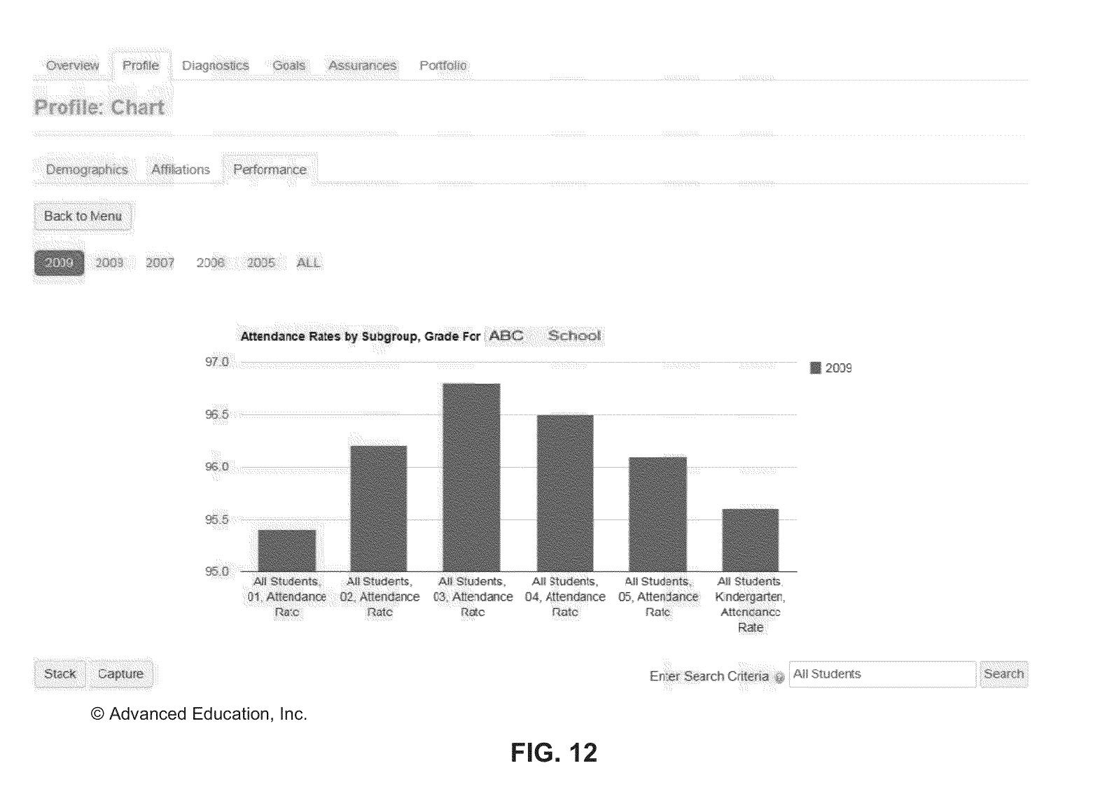

Referring briefly back to FIG. 6, the administrator can display, through the GUI, data relating to student attendance at the school by selecting appropriate data sets in a manner similar to the process illustrated by FIGS. 7-9. For example, in FIG. 12, the administrator has requested attendance rate information for all students in grades kindergarten through fifth. The administrator then selects a search button, and the system queries the managing entity database over the network, requesting specific attendance information for students at the administrator's school for the particular grades (i.e., kindergarten through fifth grade). The managing entity database then retrieves the attendance rate data requested for the particular students of the administrator's school. A GUI 526, presented to the administrator by server module 508 and server interface module 522 via display 529, displays the returned results, as illustrated in FIG. 12. As shown, the attendance rate for third grade is the highest, although all grades show a relatively high attendance rate. However, should an attendance be lower than desired or required, the administrator can make note of this and try to determine the cause of the attendance problems.

Again referring back to FIG. 6, the administrator can also display data relating to student testing by selecting a link under the “Students Tested” option. Certain jurisdictions may have requirements that students in one or more grades take jurisdiction or nation-wide tests, and the protocols for schools in those jurisdictions may have a data hierarchy that identifies the number of students who have completed the testing, by grade, content area, and/or subgroup, and by year, as applicable. The data may be displayed graphically, in a manner similar to that shown herein.

After the administrator's school profile has been established and updated, the administrator continues to the “Diagnostic” portion of the module 508. Referring back to FIG. 2, in block 204, the system obtains from various sources various types of diagnostic data, such as a self-assessment diagnostic indicated at 206, stakeholder perception surveys indicated at 208, objective student performance data 210, and the like. Whereas profile information generally comprises demographic data about a school, which the school and/or a governing body can generate or collect from the school's operation, diagnostic data generally comprises subjective assessments of the school made by those who have an interest in the school's performance, e.g. teachers, administrators, students, and/or parents of students, generally referred to herein as “stakeholders.” In this regard, in response to the administrator activating the “Diagnostic” tab from the screen shown in FIG. 3 or subsequent screens, the system generates a diagnostic GUI screen that allows the administrator to input information, perform diagnostic analyses, and create and distribute stakeholder perception surveys. In this regard, the “Diagnostics” tab is changed in another embodiment to “Diagnostics and Surveys” in order to provide further notice that surveys are part of the diagnostics.

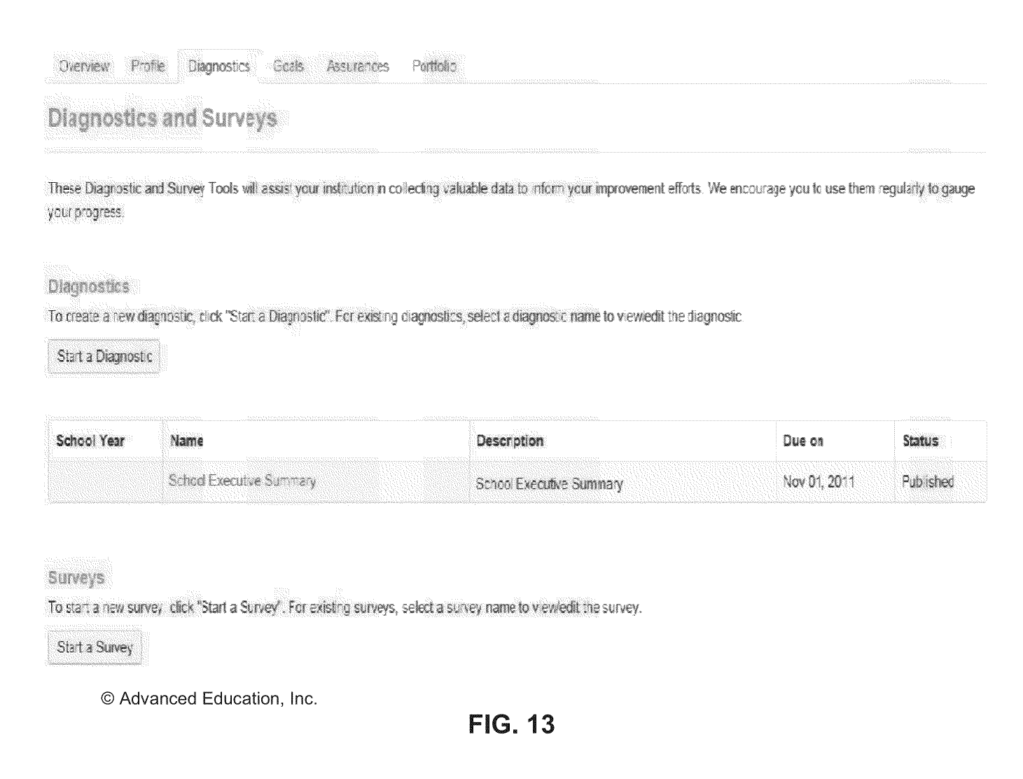

As illustrated in FIG. 13, the system GUI presents a default overview screen to the administrator in response to the administrator selecting the “Diagnostics” tab that presents two main sections: a “diagnostics” section and a “surveys” section (although surveys themselves may be considered a form of diagnostic). As indicated above, the diagnostic refers to the instrument (and process) that effects an assessment of the education organization. Surveys can be a part of the diagnostic process, providing information perception data supporting the diagnostic's assessments. Very generally, the internal diagnostics in the presently-described embodiments comprise executive summary, stakeholder perception surveys, and self-assessments, although it should be understood this is for purposes of explanation only and that other analytical formats and information may be utilized. An external review team conducts an external diagnostic, as described in more detail below.

The overview screen's “diagnostics” portion presents a table that lists each diagnostic saved in database 570 in association with the school's customer number. The database includes a record for each diagnostic a user creates and saves, the record's format being determined for each given diagnostic type (i.e. executive summary, self-assessment, or survey, in the presently-described embodiments) by the protocol. Each record includes the customer number that is active when the diagnostic is created, thereby associating the diagnostic with the appropriate school. When the user selects the “Diagnostics” tab, module 508 can therefore execute a query against database 570 and present in the “diagnostics” table in the screen of FIG. 13 all diagnostics saved in the database for the user's school. Module 508 populates the table entry with data from the diagnostic's record in database 570. The “Description” is the diagnostic type, i.e. executive summary, in this example. “Name” refers to the name given the specific diagnostic record by its creator, and the “due on” date is the date the user provides, in creating the diagnostic, by which the diagnostic is to be completed. Note that if a diagnostic is not completed, this “due on” date will appear in association with the diagnostic in the “Upcoming” table in the overview page shown in FIG. 3. In some embodiments, the year (identified in terms of a school year) in which the diagnostic is created is displayed in the “School Year” column, but this is optionally omitted from the display, particularly where users tend to put the school year for which the diagnostic is applicable in the description column. A “Status” column defaults to “pending” when initially opened, but the system can change the status of a given diagnostic to “published” or “completed,” as described below.

Activation of a “Start Diagnostics” button from FIG. 13 causes the GUI to present a screen (not shown) in which the administrator can create a record for a new diagnostic. The screen presents a pull-down box from which the user can select one of the predetermined diagnostic types (i.e. one of the predetermined diagnostics defined by the protocol that governs the school's data hierarchy and content). The GUI screen also presents a text entry box through which the administrator enters a description of the diagnostic. When the user completes the data entry and activates a “save” button, module 508 creates a record in database 570 for the new diagnostic according to the format (and in association with certain data as described below) defined by the protocol. The new diagnostic then appears in the “Diagnostics” table shown in FIG. 13.

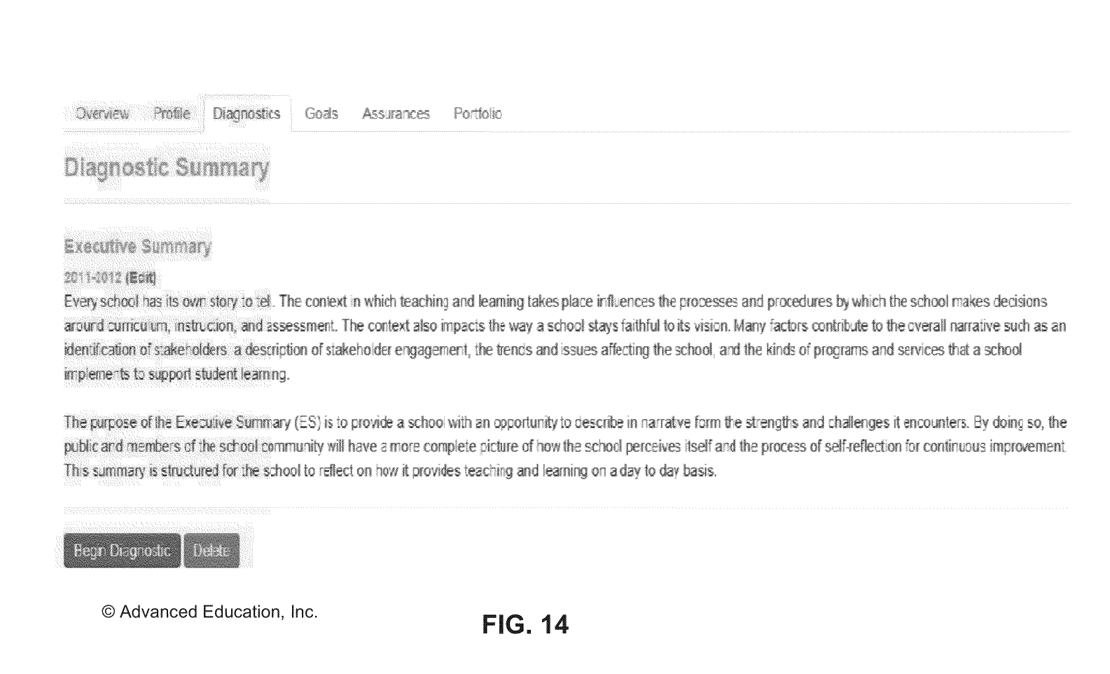

The “Name” field in each row of the “Diagnostics” table in FIG. 13 has a name that is pre-set by the protocol in association with the diagnostic type chosen by the administrator. The name field is a hyperlink that the administrator may activate from the GUI screen to cause module 508 to present a subsequent screen, shown in FIG. 14, that presents an overview of the diagnostic and from which the administrator can interact with the diagnostic, either to view or update its contents. As indicated above, the present example is of an executive summary diagnostic. The executive summary provides the school with an opportunity to describe the school's strengths and challenges in narrative form. In one embodiment, the public and members of the school community have access to this data, and, thus, the executive summary provides to the public and members of the school community a view of how the school perceives itself. The text shown at FIG. 14 is an overview narrative entered for this diagnostic by the administrator by activation of an “edit” button (and via a subsequent text entry screen, not shown). If the administrator has previously entered the overview narrative, activation of the “edit” button causes the GUI to present the text entry box screen (not shown) populated by the previously-entered text, which can then be edited. A save feature allows the administrator to instruct module 502 to send the newly-entered text to module 508, which in turn saves the summary in database 570, in association with the school. Activation of the “delete” button in this and other screens causes the system to delete the diagnostic record from the database.

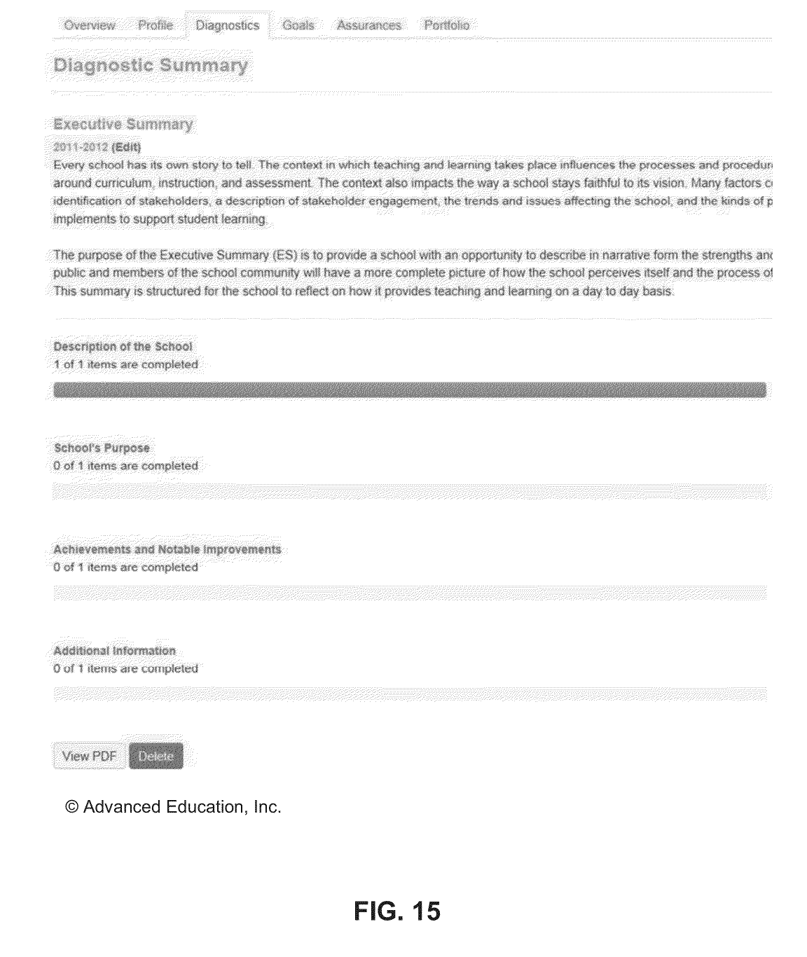

As indicated above, each diagnostic in the presently-described embodiments is one of a plurality of predetermined diagnostic types, and for each type, module 508 defines (as determined by the protocol applicable to the given education organization) a plurality of actions (in this example, responses to queries, or requests for information or opinions) to be taken to complete the diagnostic. To complete each action, module 508 provides a screen, or a sequence of screens, through which the administrator can enter data needed to complete the action or otherwise indicate that the action is complete. When the administrator activates the “Begin Diagnostic” button from the overview page of FIG. 14, system 504 requests information from module 508, which queries database 570 and causes system 504 to present to the administrator the screen illustrated in FIG. 15, which presents the diagnostic's (executive summary) overview narrative and lists the four actions comprising the executive summary diagnostic—i.e. description of the school, the school's purpose, the school's achievements and notable improvements, and additional information the administrator feels would be relevant. Again, the protocol governing the framework for this organization defines these actions for the executive summary diagnostic, and it should be understood that the actions under the executive summary may differ for other protocols. For each action under a diagnostic, module 508 defines one or more items to be completed, as defined by the protocol. When an administrator saves a new diagnostic record in the database, the record indicates each item and its status, i.e. whether or not completed. As described below, the administrator completes the items interactively through module 508 and its GUI's, and as the administrator does so, and changes and saves the diagnostic's data received in database 570 to so indicate, the data record changes to reflect completion of the items. Under each diagnostic action in the executive summary diagnostic screen shown in FIG. 15, a single-row bar graph indicates the percentage of items under each action that have been completed, according to the present state of the diagnostic's database record. A text line above the graph indicates how many items are included under each action and how many of these are completed. When all items under all actions are complete, module 508 automatically changes the diagnostic status to “complete” in the diagnostic's database record, as will be reflected in the “completed” box in FIG. 3.

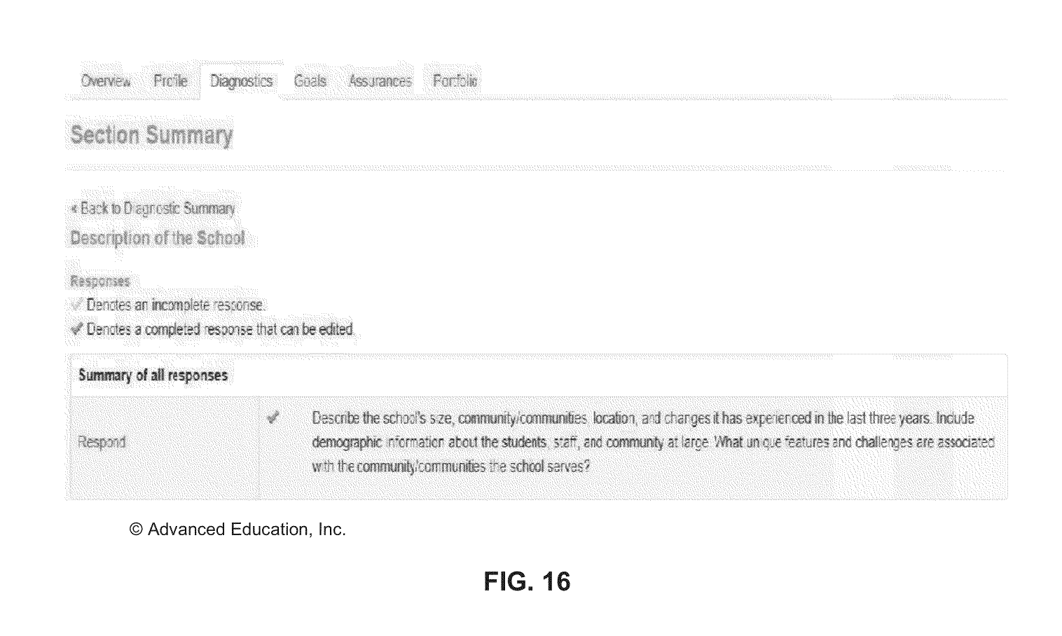

The name of each action (which the protocol defines) in the screen of FIG. 15 is a hyperlink that, upon activation, causes module 508 to cause system 504 to present a new GUI screen through which the administrator completes the items of the respective action. For example, as illustrated in FIG. 15, the GUI screen includes a hyperlink for “Description of the School” that, when activated by the administrator, causes system 504 to present the screen shown in FIG. 16 that allows the administrator to respond to a question that relates to the description of the school. This question is the item (in this diagnostic action, the only item) under this action. The question and the action are applicable to all “executive summary” diagnostics created using module 508 under the applicable protocol, and the module associates the action and the item, and all other actions and items configured for this diagnostic, with each executive summary diagnostic record upon its creation.

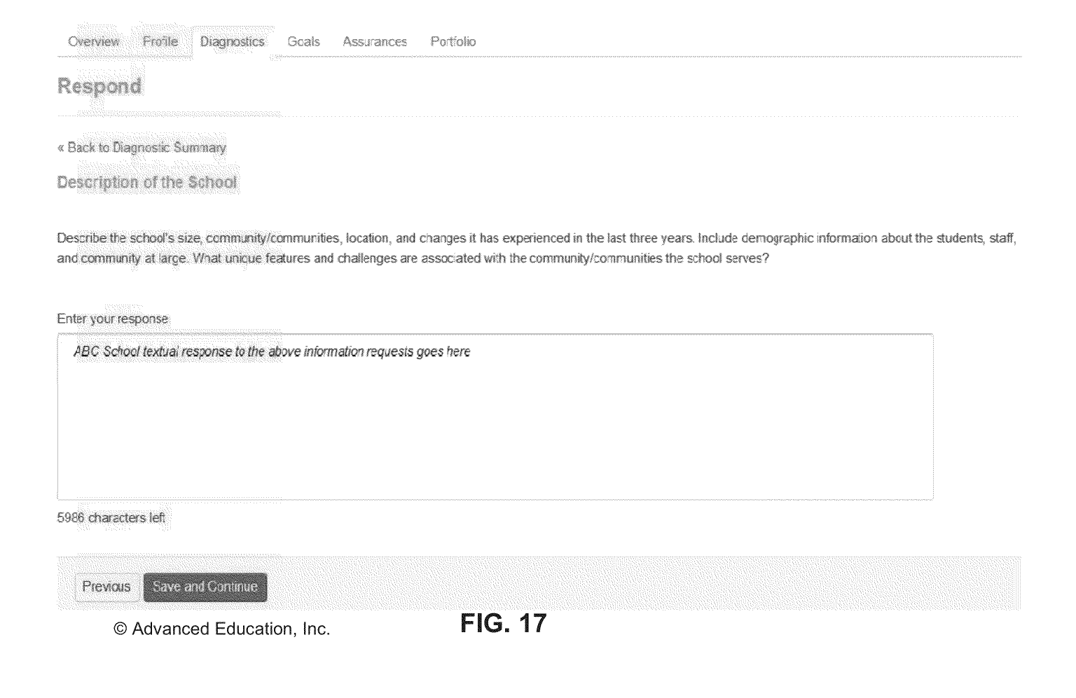

The question illustrated in FIG. 16 requests that the administrator input information about the school, in this example the school's size, community, location, changes that may have occurred, and demographic information about the school's students, the school's staff, and the community at large. The GUI screen also asks the administrator about the school's unique features and challenges that are associated with the community that the school serves. To respond to this inquiry, the administrator activates a “Respond” hyperlink illustrated in FIG. 16, thereby instructing module 508, via module 502, to present another GUI screen (shown in FIG. 17) that presents a text box through which the administrator types a narrative response to the request. When the administrator activates the screen's “Save and Continue” button, server 510 stores the textual data in the managing entity's database and changes the item's status to “complete.” Module 508 then directs the administrator back to the GUI's diagnostic summary screen (FIG. 15), which, given there is only one item under the action, now shows that the “Description of the School” has been completed but that the other items have not. At this point, the administrator can complete each of the other individual sections of the executive summary diagnostic (in this example, the school's purpose, its achievements and notable improvements, and additional information) via respective similar data entry screens corresponding to the items under those actions. The executive summary may be published by the administrator for public access once it is completed. In this example, publication can occur outside the system, e.g. through placement of the content on a website maintained by the managing entity.

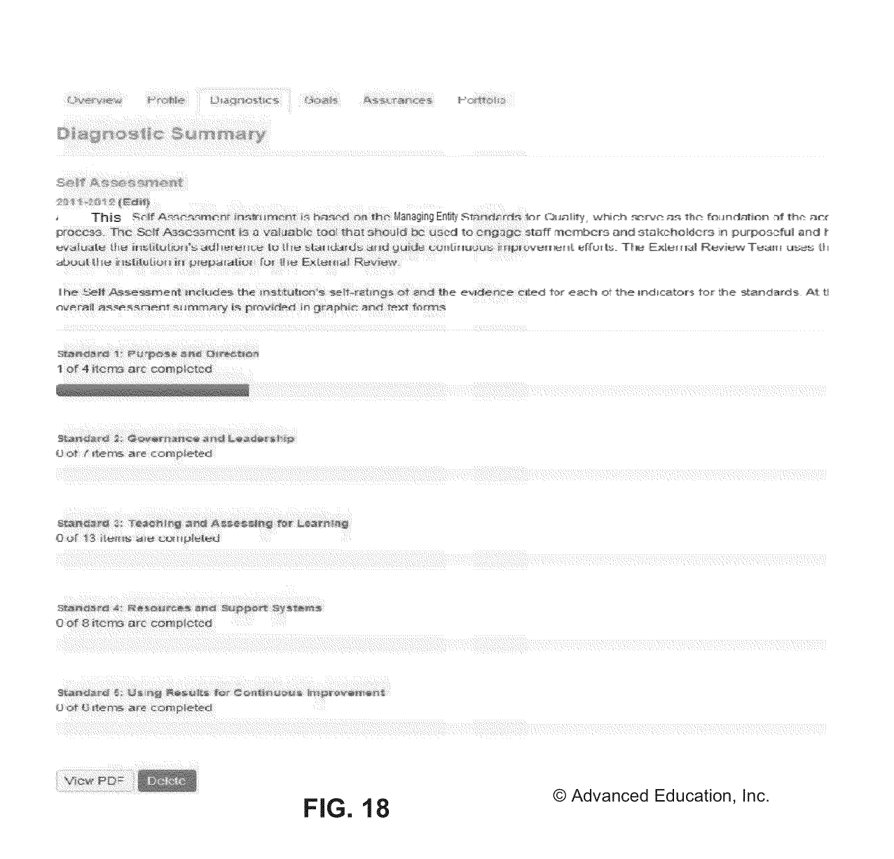

The administrator's activation of the “Save and Continue” button from the school description page causes module 508 to return the administrator to the screen shown at FIG. 13. Assume, again, that the administrator activates the “Start Diagnostics” button, but that from the resulting pull-down box the administrator selects a “self-assessment” diagnostic and enters a description for the diagnostic in the resulting text entry screen (not shown). When the user completes the data entry and activates a “save” button, module 508 creates a record in database 570 for the new diagnostic according to the format defines by the protocol. The new diagnostic then appears (with a “name” defined by the protocol) in the table shown in FIG. 13. Activation of the name in the FIG. 13 table, which is a hyperlink, causes module 508 to retrieve from database 570, and present via a GUI screen, the self-assessment diagnostic as shown in FIG. 18. At the top, similar to the executive summary diagnostic screen of FIG. 15, the screen provides an (editable) overview narrative, in this instance an explanation of the self-assessment's purpose and organization. Below the explanation, the screen lists the actions that comprise the diagnostic and indicates the number of items under each action. As described in more detail below, each item for a given action represents a response needed in the self-assessment, and the screen indicates the number of items for each action for which the administrator has already provided responses. In the example shown in FIG. 18, a response has been provided for one of the four items under the first action, but no responses have been provided for the other three. The screen indicates the number of responses in text and in a respective bar graph below each action.

The self-assessment is based on a hierarchy, defined by the managing entity through a protocol, within which module 508, via the GUI and computer device 504, queries the school administrator (in the administrator's capacity as a school representative) about the administrator's views of the school's performance. At the top of the hierarchy are standards, which in this embodiment are broad statements of the functions the school performs and/or qualities the school should demonstrate if it is to be an acceptably performing school, in this instance: “purpose and direction,” governance and leadership,” “teaching and assessing for learning,” “resources and support systems,” and “using results for continuous improvement.” That is, in order for a school to be considered an effectively functioning school, in this embodiment, the school should demonstrate that it has defined a purpose for its operation and a direction for effecting that purpose. It should have effective governance and leadership. It should have effective teaching and learning assessment. It should have adequate resources and support systems, and it should have mechanisms and procedures in place through which the school can utilize results of its operations for continuous improvement. As will be apparent to one skilled in the art, the selection, scope, and categorization of standards may vary (e.g. from protocol to protocol), and it should be understood that the standards described herein are provided for purposes of example only.

Under each standard are one or more indicators, which in this embodiment are characteristics that, when present, indicate the school is effectively performing to the given standard. For example, under the “purpose and direction” standard, the hierarchy has three indicators: (a) “The school engages in a systematic, inclusive, and comprehensive process to review, revise, and communicate a school purpose for student success,” (b) “The school leadership and staff commit to a culture that is based on shared values and beliefs about teaching and learning and supports challenging, equitable educational programs and learning experiences for all students that include achievement of learning, thinking, and life skills,” and (c) “The school's leadership implements a continuous improvement process that provides clear direction for improving conditions that support student learning.” Where these three indicators are present for a given school, and/or to the extent they are present, there is a degree of likelihood the school meets the standard (i.e., the school has defined and pursues a purpose and direction). As with the standards, the definition and scope of the indicators may vary, for example over time and from community to community, and may for example be defined for a given jurisdiction with input from administrators and/or governing bodies within or over the jurisdiction. Further, while a single level of indicators for each standard is described herein, it should also be understood that the hierarchy may define sub-indicators that define characteristics that, when present, indicate the upper-level indicator is also present, and that any number of levels may be defined as desired. Thus, the presently-described embodiments are but one example of a hierarchy that may be used, and it should be understood that such example is provided by way of example.

In the context of the diagnostic, the standards are the actions, and the indicators are the items. For each indicator/item, the module/GUI provides a plurality of response options as defined by the protocol, covering a range of possibilities regarding whether and/or to what extent the indicator is present in the school's operation. The administrator selects the most appropriate option for the administrator's school. While multiple choice answers are desirable in the presently-described embodiments because such questions lead to objective answer data amenable to comparison analysis, the answers may also be provided in narrative or other formats. In one embodiment, all indicators trigger multiple choice responses, except for a final item under each standard that asks for a narrative response. The narrative allows the administrator to provide any explanations the administrator feels is necessary, e.g. if the administrator feels the multiple choice options do not completely convey all relevant information.

The GUI also allows the administrator to identify the evidence that supports the administrator's response regarding the indicator. In the embodiments described below, the evidence often relates to information, including surveys, derived from school stakeholders, but as should be understood, the evidence can vary by indicator and standard. Accordingly, the hierarchy provides a framework for the self-assessment, in that the predetermined indicators, and the predetermined selectable options by which the administrator can describe a given indicator as it relates to the administrator's school, guide the administrator's assessment so that it reflects whether, and/or the extent to which, the school meets the predetermined standards. In the presently-described embodiments, at least one evidence checkbox must be activated in each standard in order for the diagnostics to be “complete.”

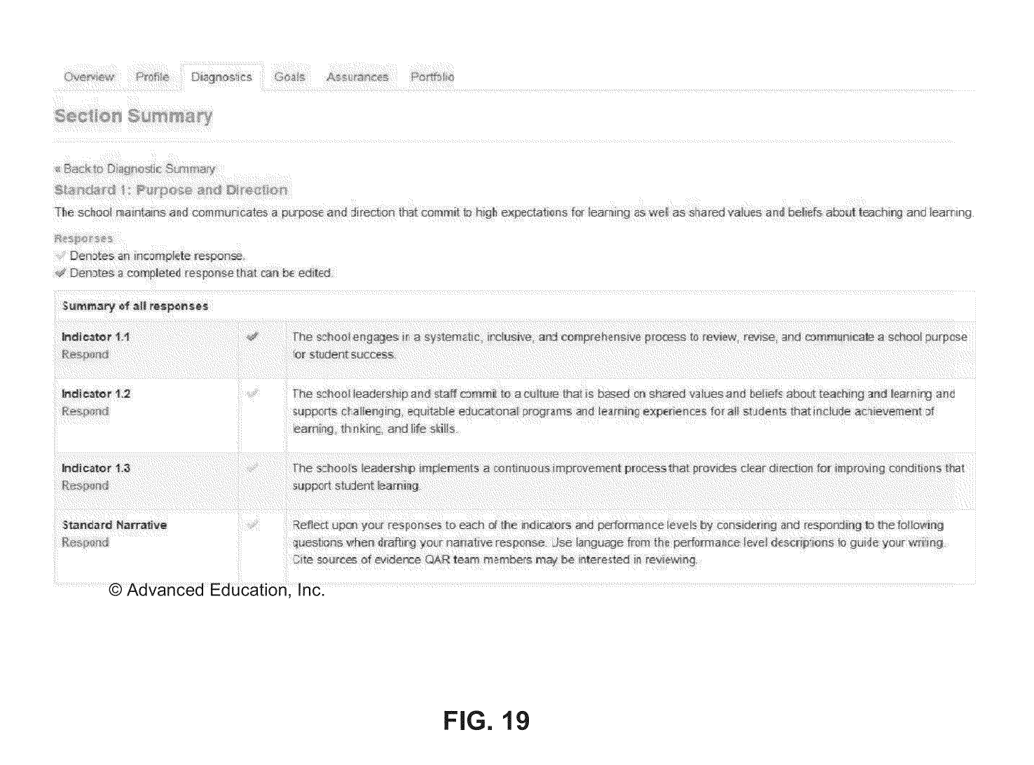

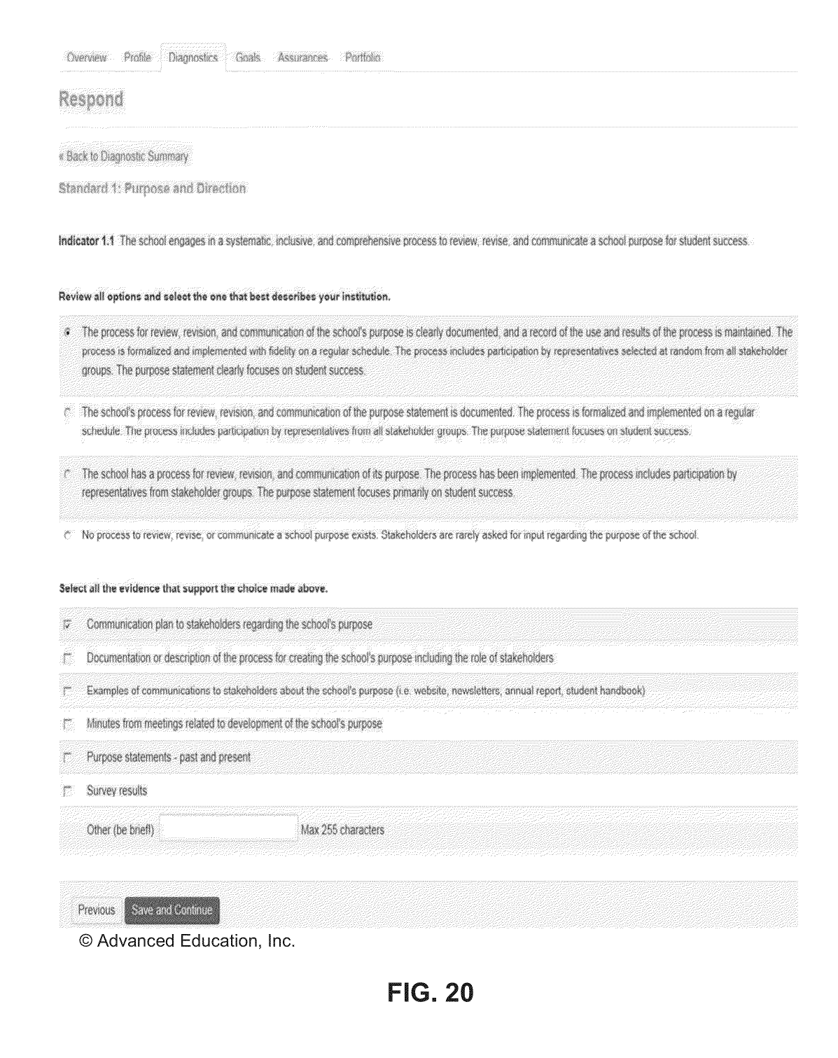

Returning to FIG. 18, each standard/action is presented as a hyperlink in the GUI screen. To add responses for the items/indicators for a given standard, the school administrator activates the corresponding hyperlink. Assuming, for example, that the administrator activates the “purpose and direction” standard's hyperlink, module 508, via module 502 and display 529, presents the GUI screen of FIG. 19, which illustrates as items the four indicators associated in the assessment hierarchy with the “purpose and direction” standard. The screen presents an overview description of the standard and a table having a text box description of each indicator (defined by the protocol), an icon indicating whether the school administrator already has stored a response for a given indicator, and a response hyperlink for each indicator. When the administrator activates a response hyperlink (“Respond”), module 508, via module 502, presents an indicator-specific GUI screen (FIG. 20) that allows the administrator to enter a response. Referring to FIG. 20, the screen presents the predetermined Likert response options associated with this indicator, with a check box next to each option, allowing the administrator to select only one option for a given indicator. As discussed above, the options represent a rubric through which the administrator indicates the level at which the school meets the expectations reflected by the indicator. Below the response options, the screen presents a list of options by which the administrator can indicate the bases for the administrator's response option above. As indicated in FIG. 20, the administrator can indicate that the response is based at least in part on survey results. The GUI presents a check box next to each evidentiary option and allows the administrator to check all that may apply and to enter a free form description in the event the listed options are incomplete. In one or more embodiments, the system allows the administrator to store images of evidentiary documents in database 570 in association with the education organization and to link the documents to the present diagnostic.

After the administrator provides a response in the FIG. 20 screen, the administrator activates a “Save and Continue” button, causing module 508 (via instructions from modules 502 and 522) to store the administrator's responses in database 570. Module 502 then returns the administrator to the GUI screen shown in FIG. 19, allowing the administrator to complete responses for other indicators, if desired. Each time the administrator enters a response in the screen as shown in FIG. 20, the administrator saves the response to the database through that screen, and it is therefore unnecessary for the GUI to provide a save function in the screen shown in FIG. 19. Further, it is not necessary that the administrator complete all responses in a single session. Thus, at any time, the administrator can return from the screen shown in FIG. 19 to the self-assessment diagnostic summary screen of FIG. 18, by activating a “Back to Diagnostic Summary” hyperlink in the screen of FIG. 19.

The same process occurs for the other actions/standards (in this example, governance and leadership, teaching and assessing for learning, resources and support systems, and using results for continuous improvement).

The managing entity stores in database 570 various surveys that the administrator may choose to enable and conduct. The surveys are predetermined forms defined by the protocols and therefore available for use by education organizations through the organizations' respective protocols. The administrator may choose to conduct one or more surveys to obtain feedback from school stakeholders, e.g. the school's staff, parents, and students, typically via communications over network 512. The managing entity creates the surveys as part of the protocol definitions and stores them on database 570, from which they can be retrieved by the administrator at computer 504 via modules 502, 522, 508, 526, and 523.

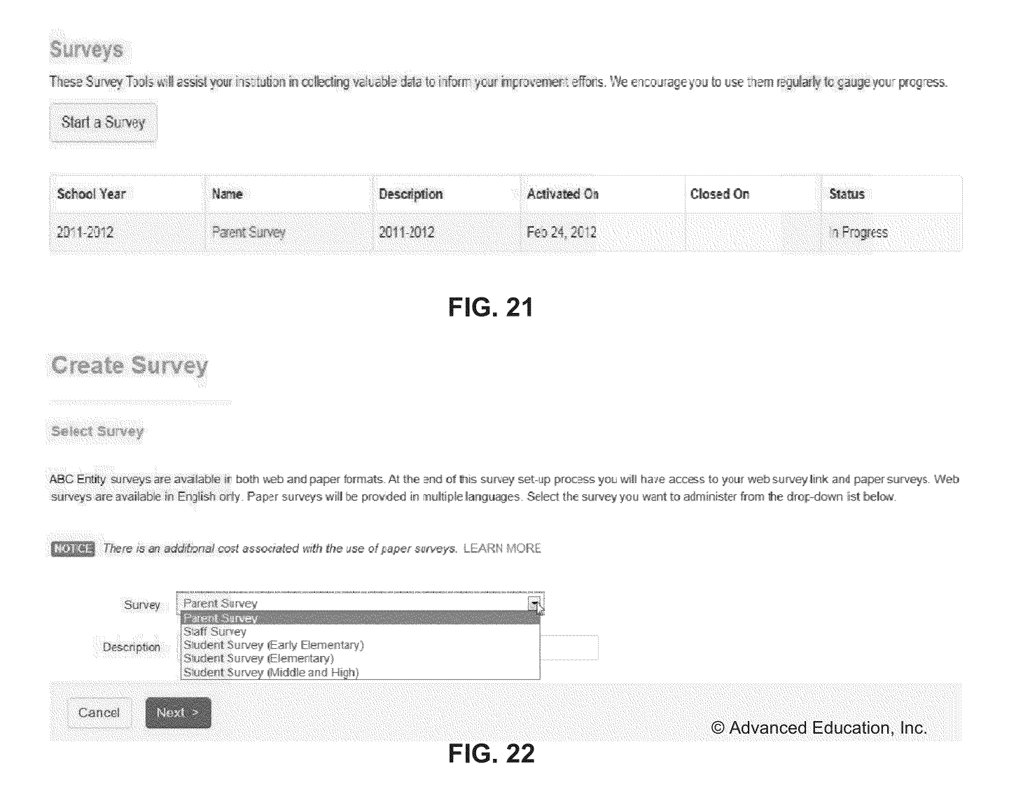

In the presently-described embodiments, the managing entity creates surveys on a stakeholder group basis, for example providing distinct surveys at database 570 for parents, school staff, early elementary students, elementary students, and middle and high school students. In general, the distinction among surveys depends on the differences in perspectives and information the groups may have with respect to the standards. System 510 includes survey forms comprised of predetermined questions corresponding at least in part to the same standards upon which the self-assessment is organized, but while the surveys in these embodiments all include queries directed to obtaining the survey-taker's information and opinions as to whether or how the education organization is performing to the standards, the information and perspective of the various stakeholders can vary. For example, school parents have different interactions with a school's administration than do school staff or students, or as do students at the respective grade levels. Thus, the questions designed to elicit each group's perspective of the school's “governance and leadership” vary according to these differences. In one embodiment, a group, for survey purposes, may be identified by a group demographic, and preferably a largest common demographic categorization (e.g. the subgroupings discussed above), for which it is possible to define a set of questions such that the group's answers convey meaningful information. Thus, for instance, the surveys of students may be subdivided into specific surveys for students of one gender or the other, or students of specific ethnic backgrounds or national origins. Moreover, the relationship between the standards and the surveys means that the selection of stakeholder groupings for survey purposes may depend on the selection of the standards.

Whereas the managing entity defines the survey forms (a form being a distinct set of survey questions, organized by standard and possibly indicator) for each stakeholder group, the school administrator selects which, if any, surveys to conduct as part of the school's diagnostic process. From the GUI screen shown in FIG. 13, the administrator activates a “Start a Survey” button. This causes module 502, via modules 522, 508 and 523, to query database 570 for any actual surveys previously created and stored by the school and to present a GUI screen as shown in FIG. 21, presenting a table that lists all such previously stored surveys. Surveys are stored on database 570 on a per-school basis, and common surveys are used for all schools in the database that share common protocols, according to one embodiment. The administrator, having authorization to view data only for the administrator's school(s), can view only that school's (or schools') surveys. As indicated in the Figure, the administrator's school in this example has one existing survey (a parent survey) that is currently in process.

A hierarchy applies to the surveys that is similar to the self-assessment hierarchy. As noted, the presently-described embodiments utilize stakeholder surveys to collect information in support of and/or as part of the school's diagnostic process. Because the survey questions correspond at least in part to the same standards upon which the self-assessment is organized and possibly also to one or more of the individual indicators under each standard, answers to survey questions under a particular standard and indicator can be correlated to determine not only if there are discrepancies among answers to the same questions provided by different stakeholder groups in respective surveys, but also if there are discrepancies between a school's self-assessment and one or more supporting surveys, with respect to a given standard and/or indicator. For example, if a “purpose and direction” standard has an indicator relating to whether the school engages in a systematic, inclusive, and comprehensive process to revise, review and communicate a school purpose, and a question under this standard and indicator in the self-assessment (see FIG. 20) indicates the school perceives that the school ranks high in this area, but a survey question response under the same standard, or the same indicator, by a given stakeholder group (e.g., African-American students) ranks the school lower than does the self-assessment, the school and/or the managing entity may be able to identify an issue for potential follow up investigation. For instance, the school or the managing entity may wish to determine if either the school (via the administrator who performed the self-assessment) or the stakeholder group misperceives the school's performance in this area, e.g. relying on interviews with the school, the stakeholder group, or other stakeholder groups, review of other survey responses relating to this standard and/or indicator, or other evidence indicated in the self-assessment as supporting the school's response, and/or review of student performance data related in database 570 to this standard and/or indicator.

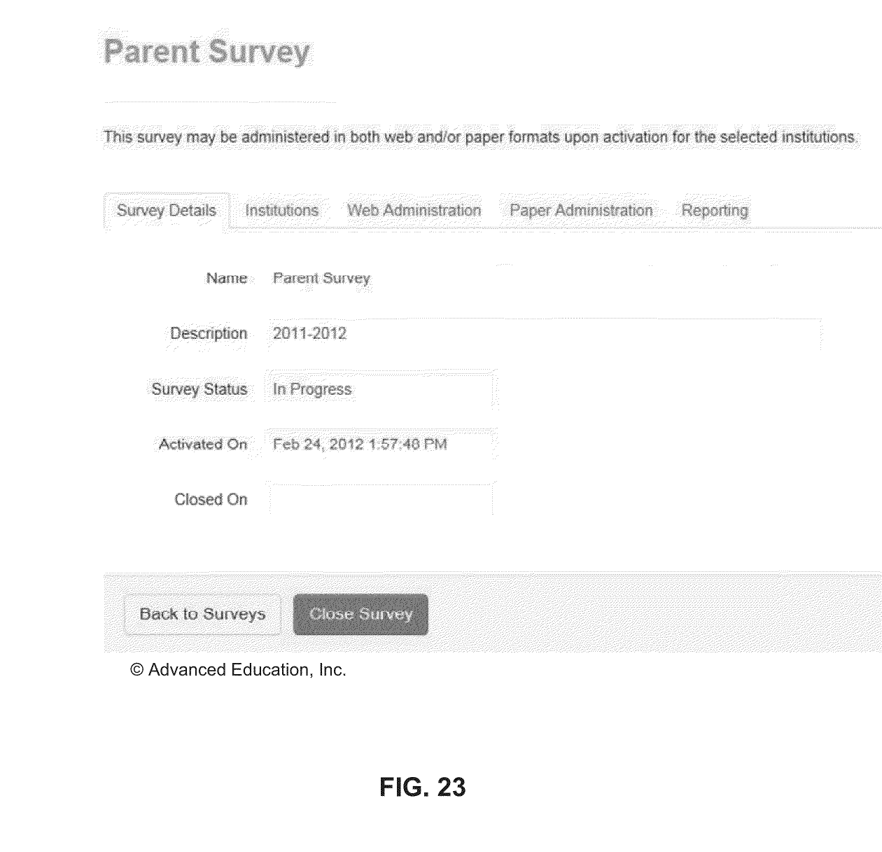

From the screen in FIG. 21, the administrator activates a “Start a Survey” button to create a new survey, causing module 508, via module 502, to create a database record for the survey and to present the GUI screen shown in FIG. 22. A pull-down “Survey” box allows the administrator to select a survey form from among the plurality of survey forms the managing entity previously stored (via a protocol) at database 570 (in this example: forms respectively for parents, staff, early elementary students, elementary students, or middle and high school students). Upon selection, module 508, via modules 522, 502, and 523, saves the selected survey type as the “name” in the database record (see FIG. 21) and links the record to the corresponding form. A “Description” field is a text entry box into which the administrator may enter a descriptive text that is stored in the database record and displayed in the FIG. 21 screen under “Description.” Activation of a “Next” button in the GUI screen causes modules 502, 508, and 523 to save the database record in database 570, with the status of “In Progress” (see FIG. 21), and module 502 to present the administrator with a GUI screen as shown in FIG. 23, presenting the survey details. In addition to the information entered by the administrator, the screen illustrates the value of a timestamp created when the system saves the record. The timestamp is saved as part of the survey's database record.

As indicated in FIG. 23, the survey's default status is “In Progress,” and the survey will remain open until closed by the administrator. As described in more detail below, the administrator may publish the now-opened survey to relevant school stakeholders, who may consequently enter survey responses and save the responses to database 570 in association with the survey. As long as the survey remains open, stakeholders may access the survey through database 570 and save their responses. After a predetermined period of time, and/or after receiving a desired number of survey responses, however, the administrator may “close” the survey by activating a “Close Survey” button on the screen as shown in FIG. 23 or later Figures. Once the survey is closed, modules 502 and 508 will not allow stakeholders to enter and save responses.

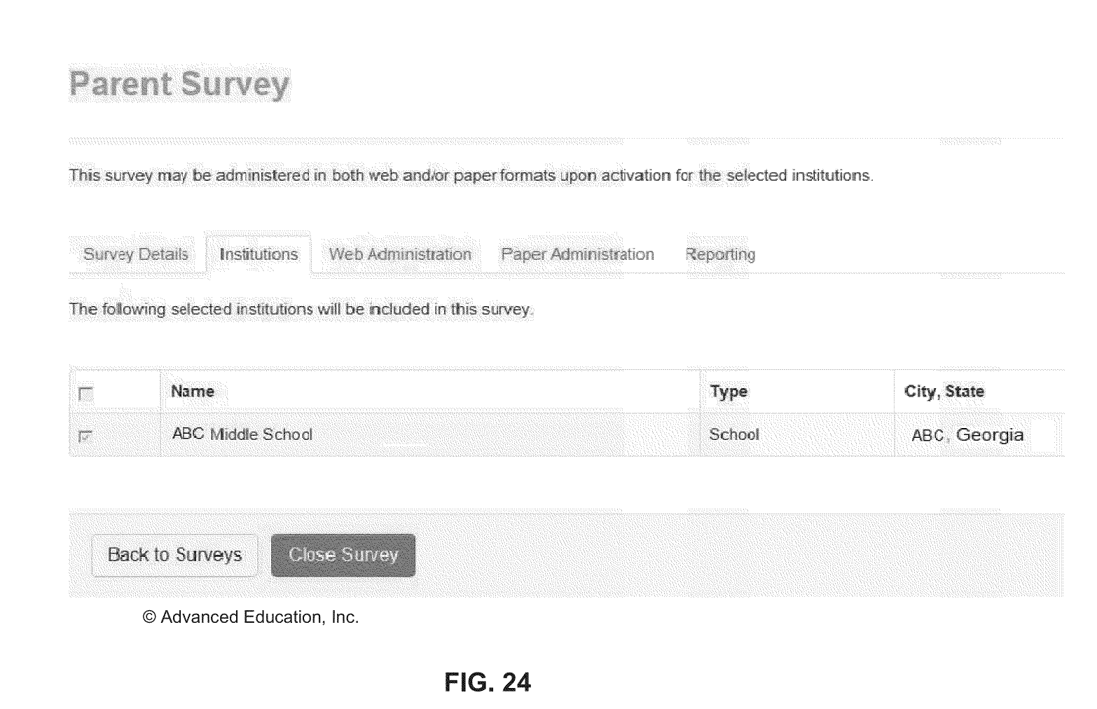

From FIG. 23, the administrator may activate one or more tabs presented in a row at the top of the screen in order to associate the new survey with a school, select either web or paper/mail administration, and/or obtain survey reports. Upon selecting the “Institutions” tab, module 508, via module 502, presents a GUI screen as shown in FIG. 24, which presents the administrator with a table listing each education organization for which the administrator has database rights, with a check box next to each. The screen allows the administrator to select a school, which in turn causes modules 502, 508, and 523 to associate the survey record in database 570 with the selected school.

In the presently-described embodiments, the administrator publishes the surveys to relevant stakeholders, i.e. the administrator distributes the surveys to those individuals within the stakeholder group for the relevant school. Under one option, the administrator may print hard copies of the selected survey and mail the surveys to those individuals in the group. Under a “Paper Administration” tab, the system provides a zip file containing the paper survey questionnaires and answer sheets in multiple languages (e.g. English, Spanish, Portuguese, Mandarin, Arabic and Haitian-Creole). The survey questionnaires and answer sheets are uniquely coded for a given organization and survey administration instance. The returned surveys, being answered in a predetermined format, are scannable so that the resulting information can be stored in the database.

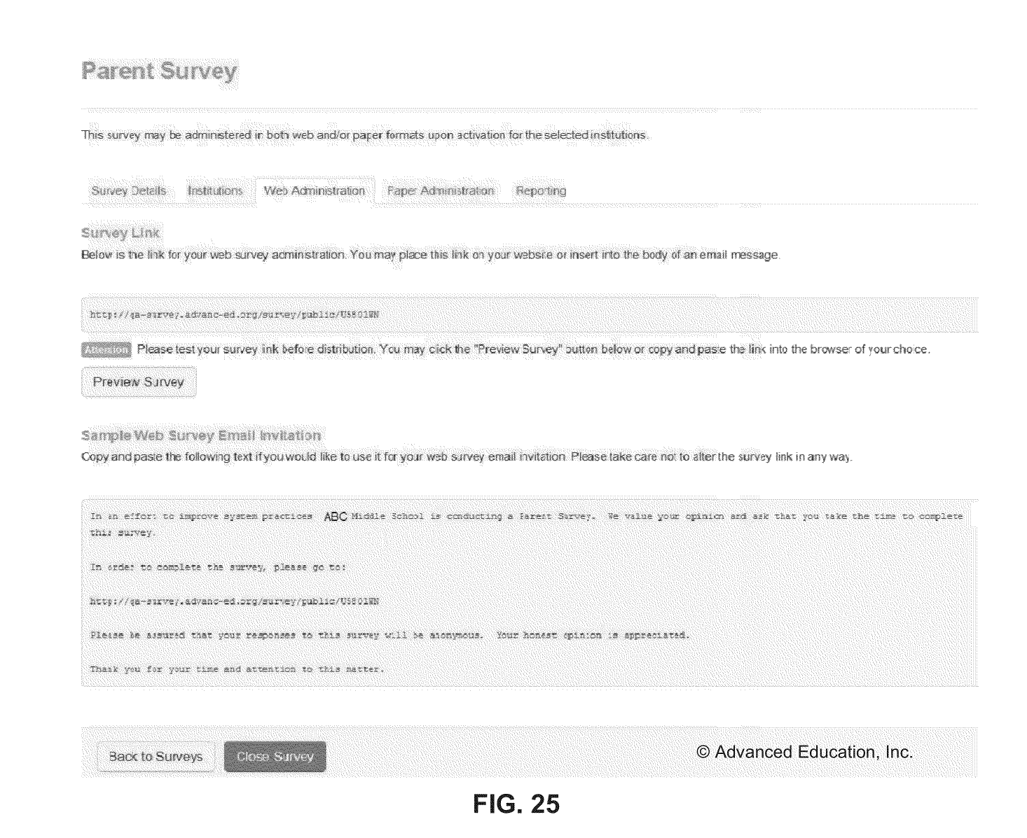

Alternatively, the system allows the administrator to publish the survey over the Web. In this regard, server 510 hosts the survey on a website over network 512, whereby the administrator can email to stakeholders (for the school selected at the screen shown in FIG. 24), in this example school parents, a link through which the parents can navigate from their computers (including mobile devices) to server 510 over the Internet to access and complete the survey via module 523 through a GUI presented by modules 508 and 526. The link is directed to a website that acts as a query to retrieve the specific survey. Under a “Web Administration” tab, the administration GUI presents a screen, as shown in FIG. 25, from which the administrator may copy and paste explanatory text and the link into an email to the school parents from the administrator's computer. The link is specific to the survey saved by the administrator. When the parents receive the email, they may select the link within the open email, causing the parent's computer browser to redirect to a website hosted by the managing entity's server 510. The managing entity's server (modules 508 and 523) then retrieves the survey, based on the link provided, and presents the survey to the parents over the Internet. When each parent completes the survey, the parent saves and submits the results from their computer via the GUI over network 512 to server 510. Server 510, via module 508 and 523, creates a record in database 570 for each survey response, and saves each set of responses in association with the survey record created by the administrator (responses can be associated with a survey record because the surveys are uniquely coded when a survey is created). When each survey is completed, server 510 receives and stores the results of all of the survey data and saves this data in the managing entity's database 570.

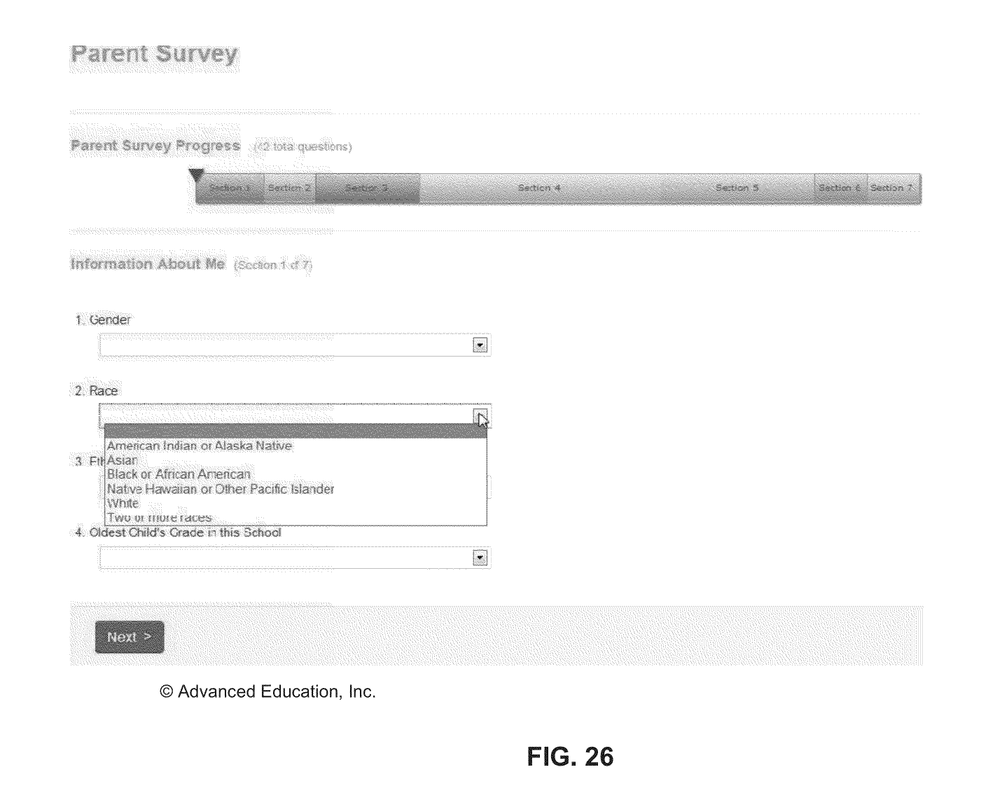

FIGS. 26-28 illustrate an example of the parent survey as accessed by a parent over the Internet (see FIG. 1B, 512) using a remote computer. Starting with the screen shown in FIG. 26, the survey GUI requests basic information about the parent completing the survey, including gender, race, ethnicity and the grade level of the parent's oldest child. When the parent activates a “Next” button, the GUI presents a series of pages, each presenting one or more questions organized respectively under the five standards (previously mentioned). A bar graph at the top of the page shows the parent's progress through the questions. In this example, the first page (i.e. the parent demographic information page) is the first section, and the graph therefore shows the parent as having completed the first section and being in progress on the second section. Each of the five standards corresponds to a respective section of questions, while a seventh section comprises open-ended questions not specifically associated with a particular standard. In the illustrated embodiment, each question is a statement with which the parent is asked to indicate the degree to which the parent agrees or disagrees with the statement. The GUI allows the parent to select one, but only one, response for each statement. Each statement relates to the standard under which it is presented, and the predetermined list of response options therefore allows correlation of responses across a stakeholder group to the standards, and a common basis of comparison of survey results from one group to another. Upon completing a given page, the parent activates a “next” button, causing module 508 to save the page's responses to database 570 in the record for this survey response and to present the next page of questions. This process repeats until the parent answers all questions in the survey, when the GUI presents the parent with a sequence of open-ended questions, to which the parent enters answers in interactive text boxes.

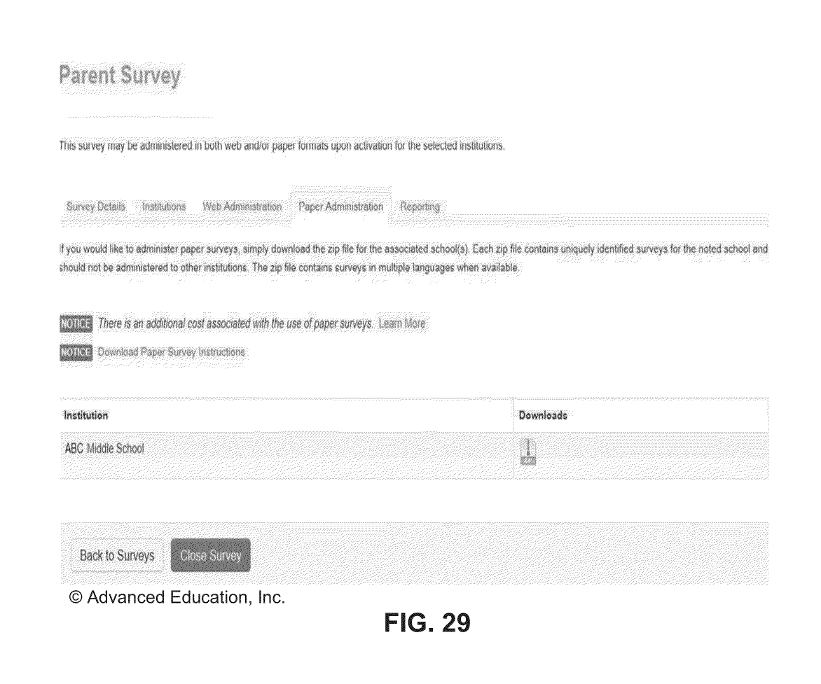

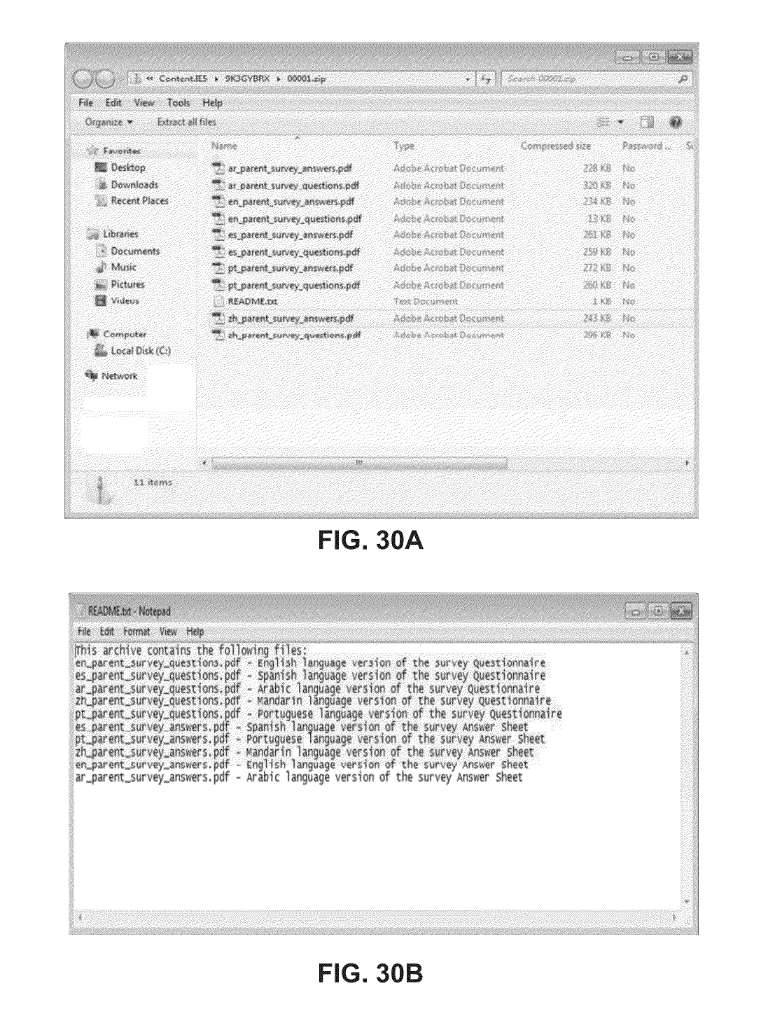

As illustrated in FIGS. 29-30B, the parent survey GUI includes a paper administration tab from which the administrator can download printable versions of the surveys to print and mail to stakeholders. From the paper administration tab (FIG. 29), the GUI allows the administrator to download a ZIP file that contains respective printable electronic files for the survey itself and a scannable answer sheet corresponding to the survey questions. It will be noted that the ZIP file contains survey/answer sheet pairs in several languages, in this instance Arabic, English, Spanish, Portuguese, and Mandarin, as explained by a README file and illustrated in FIGS. 30A and 30B. After the parents fill out the paper survey using the scannable answer sheet, the parents scan the scannable answer sheet using a computer and transmit the results over network 512 to server 510 which stores them in database 570.

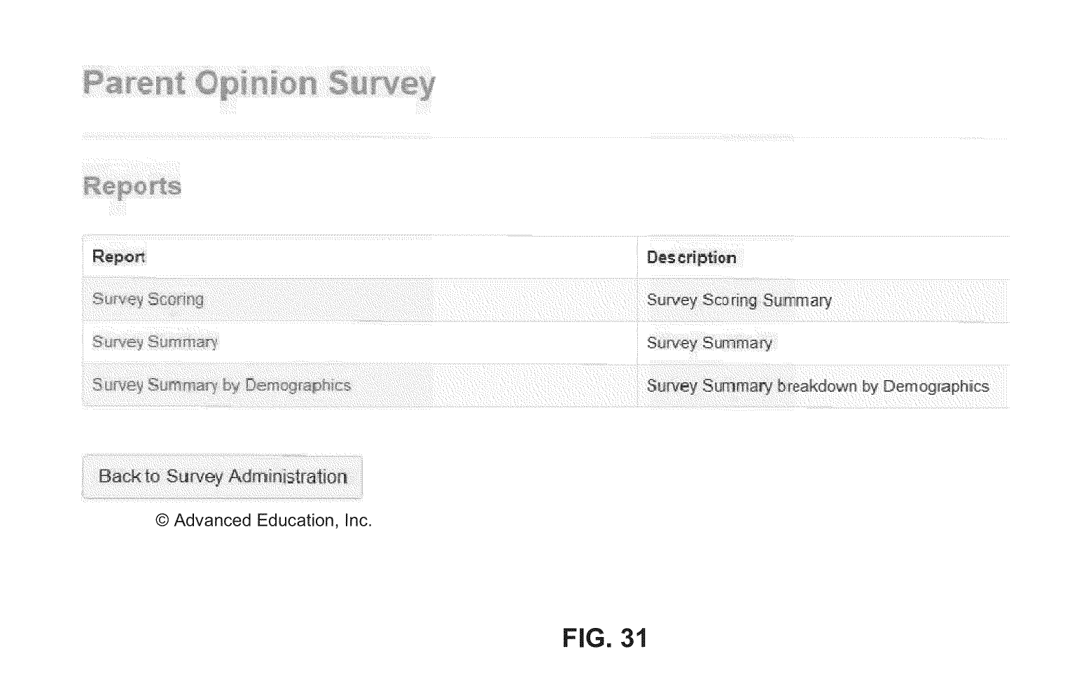

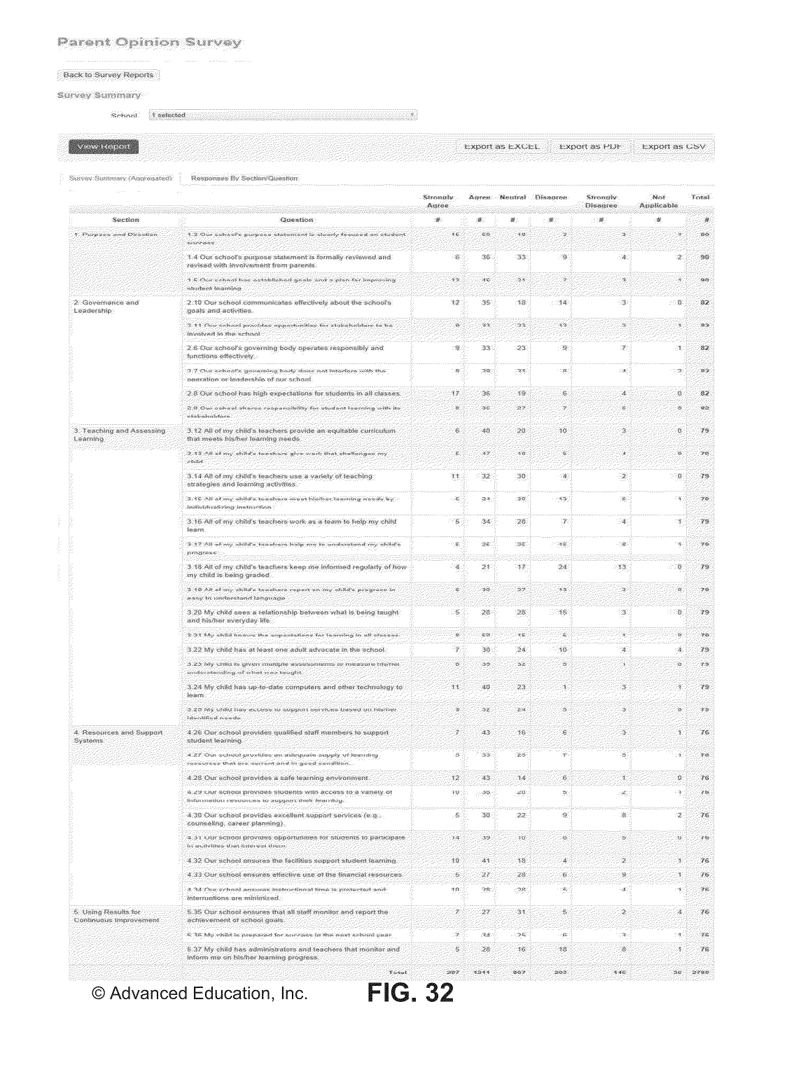

As shown in FIG. 31, the system presents a reporting section of the parent survey GUI when the administrator selects the reporting tab of FIG. 23, through which the administrator may view reports that present the survey results in various presentations. In the table shown in FIG. 31, the name of each report on the left side (i.e. “Survey Scoring,” “Survey Summary,” and “Survey Summary by Demographics”) is a hyperlink that, upon activation by the administrator from the screen shown in FIG. 31, causes modules 502, 508, and 523 to retrieve all survey response data associated in the survey response records of database 570 with the selected administrator survey (i.e. the survey within which the administrator is operating, from FIGS. 21 and 22) and present that data according to a predetermined (by the managing entity via a protocol) format for the selected report, as controlled by module 508. FIG. 32 illustrates a page of the “Survey Summary” report, which presents each question from the survey, organized by standard, and the number of the respective responses to each question contained in the stored data.

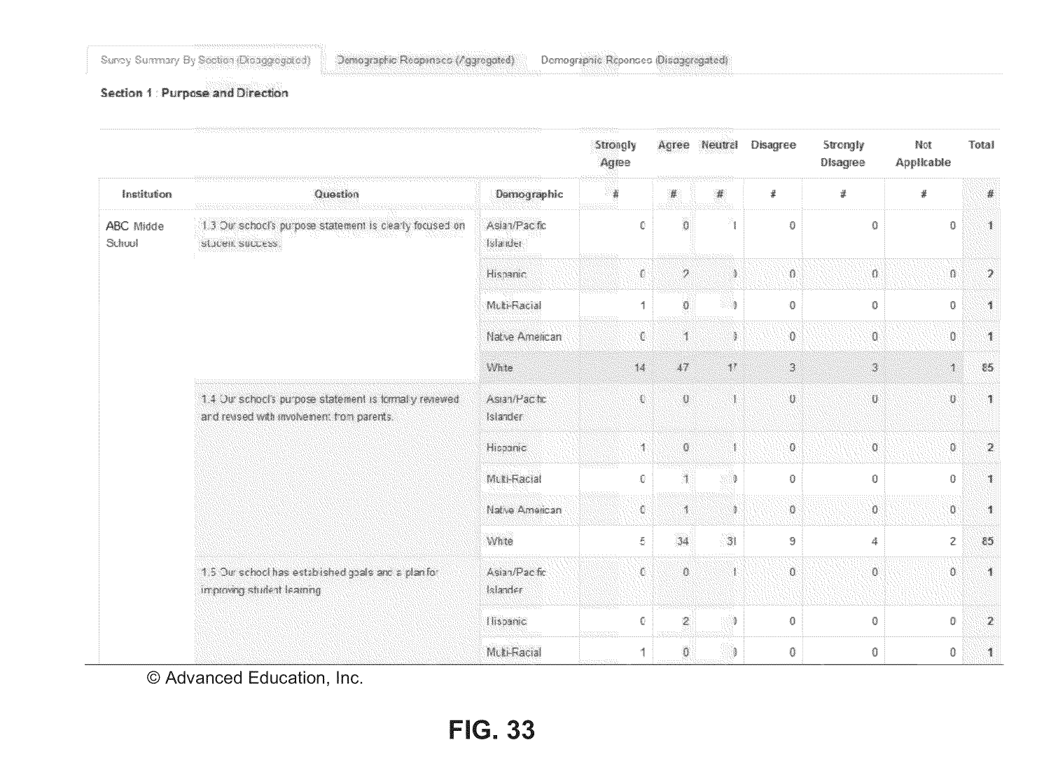

The data in FIG. 32 is aggregated, in that each single row provides all the response data for the corresponding question. If the administrator selects the “Survey Summary by Demographics” report, however, the system provides various views of the data, sorted and presented by the responder data categories entered by the responders in the first survey page (FIG. 26) of each response. As shown in FIG. 32, for example, the administrator may select a “Summary by Section (Disaggregated)” tab, which presents the same data, organized by standard and question, as in FIG. 32, but further segmented according to race. Alternatively, the administrator can select to run the report using different dimensions, such as gender or ethnicity. Selection of a “response By Selection/Question” tab provides survey data be section, as shown in FIG. 33.

Accordingly, the administrator has the ability to present the survey response data according to various parameters, including the race/ethnicity of the parents, demographics of the parents, or the particular standards surveyed. The survey results describe how the parents scored the schools in various aspects and on a scale. It may be evident to the administrator when viewing this data where the points of emphasis for the school should be focused, as the survey questions relate back to the standards and, optionally, to the indicators. The answers that indicate areas of concern can then be tracked back to the standards and indicators to help the school or school system create plans to address the concern. For example, if the parents scored all questions as “strongly agree” or “agree” except for one question most parents answered “disagree,” the administrator immediately knows that the excepted question would be an area for the school administrator to analyze.

### Analysis

The information described above (i.e., the objective student performance data, the school's itself—assessment, and stakeholder surveys) comprises data that describes the school's operation and resources, the performance of its students and the subjective assessment of its stakeholders regarding the school's performance, derived in accordance with a set of standards the school is expected to meet and indicators that support the standards. Since the standards define a set of expectations for the school's performance, an assessment of the school's performance, including the identification of problems, is a reflection of the degree to which the school meets the standards. The data can, therefore, provide a basis upon which to diagnose causes of problems identified in the school's performance or operation, and the data is therefore referred to herein as diagnostic data.

In embodiments described herein, the administrator performs a root cause analysis against the diagnostic data to identify underlying causes of problems. As should be understood, root cause analysis is a type of problem-solving methodology that assumes that all, or almost all, perceived problems have underlying causes. Root cause analysis assumes that the real problem is the underlying cause and that the perceived problem is, in fact, a symptom of the real problem. Thus, the goal of root cause analysis is to allow an organization to identify and address root causes, rather than focusing solely on the perceived problem or symptom.

Various types of root cause analysis are known and should be well understood. The specifics of these methodologies are not, in and of themselves, part of the present invention, may vary as desired and are, therefore, not discussed in detail herein. In general, however, the process begins by the identification of perceived problems. By its nature, the identification of problems depends upon perception, and in this example, the administrator identifies problems based on the administrator's perception of the school's performance. As described above, the diagnostic data is organized around a set of standards the school is expected to meet and indicators that reflect whether or not the school is, in fact, meeting those standards. Accordingly, in one preferred embodiment, the administrator reviews the diagnostic data and the objective student performance data and determines whether the administrator perceives one or more problems with the school's performance. The diagnostic data may include the external review results, described below, and thus problems may be identified by the administrator from problems identified by the external review team.

For example, the administrator may perceive that third grade students in the school are not performing sufficiently well in mathematics. Still referring to FIG. 2, at block 214, the administrator creates a problem statement based on this perceived problem.

At step 216, the administrator identifies potential causes of the perceived problem, through a guided root cause analysis. The administrator may identify the events that occur in sequence that led to the problem. For example, assuming the problem is that third grade math scores are low, a sequence of events may include—students taking tests, students attending math classes, students attending school (and the rates at which they do), teachers being assigned to teach math, institution and/or cancellation of programs and activities related to math, changes in administrative staffing, changes in school funding, particularly as they might relate to the teaching of math, changes in school facilities, and changes in school schedules and procedures. The administrator then reviews the diagnostic data and associates the diagnostic data with the identified events. For example, the administrator may identify, as an event, the reduction of the number of math teachers employed by the school and may, in turn, associate with that event data relating to school funding. Of course, the line between events and supporting data is not always precise, but the exercise nonetheless causes the administrator to focus on cause and effect. For each event identified as contributing to the problem, the administrator asks why the event occurred and what data relates to the event and, upon identifying the causes of each event, asks in turn why each cause occurred and what data relates to the newly-discovered causes.

This process may lead to a crowded list of potential causes, and at step 218 (FIG. 2), the administrator applies a qualitative analysis to the identified potential causes in order to identify those that materially impact the problem. This step may be, at least in part, subjective, based upon the administrator's experience. Thus, in reviewing the potential causes, the administrator's experience may allow the administrator to understand that certain identified potential causes, if eliminated or modified, would likely cause a material change in the perceived problem. For example, if the low third grade math scores occur primarily within a certain group of third grade students, and if the administrator identifies that this group of third grade students has an absentee rate significantly greater than the absentee rate of other third grade students who have higher math scores, the administrator may understand that absenteeism is a material cause of the lower math grades. Conversely, the administrator may understand that a change in class scheduling, even though affecting the teaching of mathematics, is unlikely to be a significant cause of the problem, as that change applies equally to all groups. Accordingly, the administrator then focuses on the events and data that underlie absenteeism and does not focus on the events and data that underlie the class schedule change.

The administrator may give weight to broad trends and patterns over isolated events. For example, the administrator may review the data and notice that classroom size has been increasing over time, and particularly so for math classes, or the administrator may notice that funding has been decreasing for math teachers over time. As these events have occurred over relatively long periods of time, the administrator can assess math grades for the school over the same period of time to determine if any correlations exist. If so, the identified causes are more likely to be material causes of the problem. The administrator then focuses on the potential causes of the identified material causes, and the process repeats, until the administrator is left with a set of material potential causes that do not, in turn, have their own material potential causes. This iterative process may end when the administrator determines that there are no further material “why” question to ask.

At 220, the administrator assesses and compares the one or more causes resulting from this analysis, asking whether any one or more of these remaining causes is materially more important than the others, with regard to the perceived problem, and whether it is within the school's power to effect any change in the cause. All causes in the remaining group for which the answers to those questions are both positive may be considered root causes. In summary, the process may be described as: (1) define the problem statement (based on one more perceived symptoms), (2) identify other problem areas that may be directly or indirectly related, (3) develop a “problem-cause” tree through a series of why questions, and (4) identify a probable root cause.

As described above, the administrator performs the root cause analysis (steps 214-220) manually, with assistance of the system in providing data supporting the steps, but without automation of the steps themselves. It should be understood, however, that the system may automate these steps to a desired degree. For example, the database may define a decision tree—type data structure within which, through a GUI, the administrator may enter the sequence of causes. Through the GUI, the administrator may review the cause list and select or eliminate causes through the GUI, based on the analysis as described above.

The root cause analysis results in one or more root causes that the school believes it has the ability to influence and that, if so influenced, is expected to improve the school's performance. Accordingly, the administrator defines a set of goals for the school, where each goal corresponds to a desired elimination of or modification to one or more causes identified in the root cause analysis. As described in more detailed below, the administrator then builds a plan that identifies and outlines actions the school is to take to achieve the goals. As also described below, the school may be subject to requirements to provide assurances, for example to state or federal agencies, that the school is complying with standards or requirements imposed by the agency. Execution of its improvement plan, and compliance with the assurances, can form the basis of a continuing self-improvement process. System 510 provides a tool by which the school can report progress against the plan, and compliance with the assurances, to stakeholders or other entities, for example an accreditation agency.

The first step in progress planning is to define a plan by which the school intends to achieve the goals defined by the root cause analysis in response to the diagnostic and objective data collection. The system facilitates goal and plan definition by a software tool located at server module 508, which the education organization administrator accesses via a computer 504 and modules 502 and 522 and with which the administrator interacts through GUI's 526 that system 510 provides to computer 504 as described above.

A plan is a set of actions the school proposes to take in order to resolve a problem or objective identified by the education organization or a governing jurisdiction, for instance an objective required by a state department of education or one or more root causes determined by an administrator in a root cause analysis. The plan is a hierarchy, at its highest level comprising one or more goals, that, if achieved, the administrator believes will correct or improve the identified root causes. For each objective, the tool allows the administrator to define increasingly-specific functions to be performed by the school in order to achieve each higher-order item in the hierarchy. For example, for each objective, the tool allows the administrator to define one or more functions (described as “strategies” in the present example) through the performance of which the school intends to achieve the objective, i.e. solutions that are expected to achieve the objective. For each strategy, the tool allows the administrator to define one or more sub-functions (described as “activities” in the present example) through the performance of which the school intends to achieve the strategy. For the lowest-level functions, the administrator may define deliverables, responsible parties, and performance time periods, so that it is possible to determine when the function has been performed. When all functions under a next-higher function are performed, the next-higher function is considered performed or achieved. Thus, when all activities under a given strategy are performed, the strategy is considered is to have been implemented. When all strategies under a given goal are implemented, the goal is considered achieved. When all goals in a plan are achieved, the plan is considered to be implemented. When the administrator initiates a plan using the tool, the tool instantiates a record in database 570 for the plan. The record's format corresponds to the data reflected in the GUI screens discussed below, so that as the administrator defines the plan, goals, strategies, and activities, the tool adds data to the record.

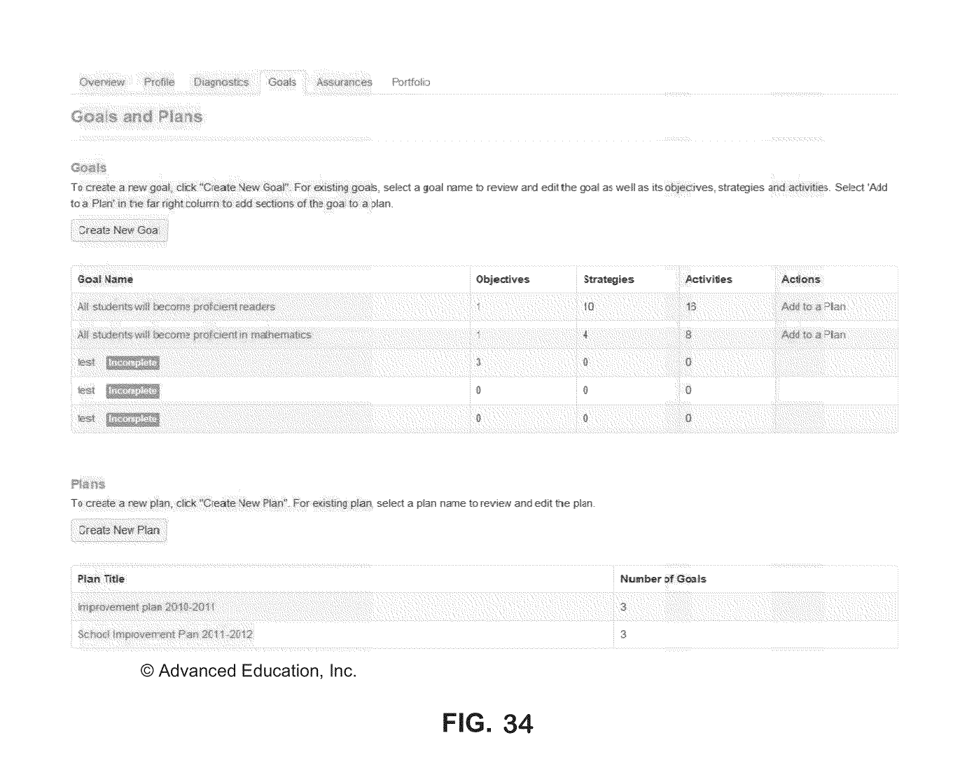

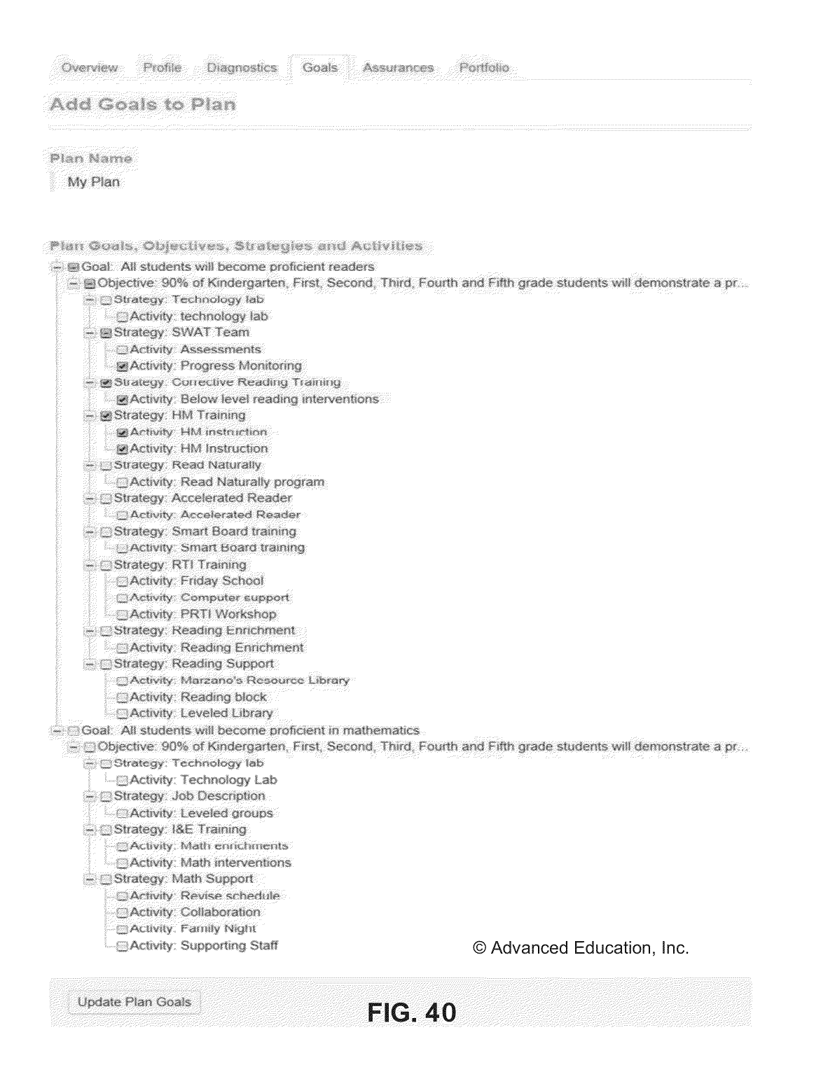

From the overview screen in FIG. 3, the administrator activates a “Goals” tab, causing the GUI to present a main screen for a goals and plans portion of the tool (In that regard, this tab is changed in another embodiment to “Goals and Plans”). Through the tool, the administrator may define multiple plans and multiple goals, assigning goals to plans. Accordingly, the screen at FIG. 34 includes respective tables listing and providing information for all the plans and all the goals stored in database 570 in association with the customer number of the school the administrator selects at login. As noted above, plans often comprise goals, and the table therefore lists each plan name and the number of goals assigned to the plan. Each plan name is a link, and upon the administrator activating the hyperlink at a plan name in the table, for example by mouse click, the tool GUI presents a screen as shown in FIG. 40, which lists the plan name and a hierarchal illustration of each goal included in the plan. From this screen, the administrator may edit the contents of a plan. As indicated above, each goal is comprised of one or more objectives, which are in turn comprised of one or more strategies, which are in turn comprised of one or more activities. The screen shown in FIG. 40 includes a check box in front of each goal, objective, strategy and activity. Each check box is activatable by the administrator so that specified activities, strategies, objectives, and goals can be included in the plan. Thus, the screen in FIG. 40 provides an interactive visual method for the administrator to construct a plan.

Returning to FIG. 34, the screen provides, above the plan table, an actuatable button by which the administrator may cause the tool to present a GUI screen (not shown) through which the administrator may define a new plan. The administrator may provide a plan name, and may define the goals, objectives, strategies, and activities to include in the plan. Database 570 includes a record for each plan. The record includes a pointer to the school associated with the administrator who created the plan, thereby associating the plan with a school.

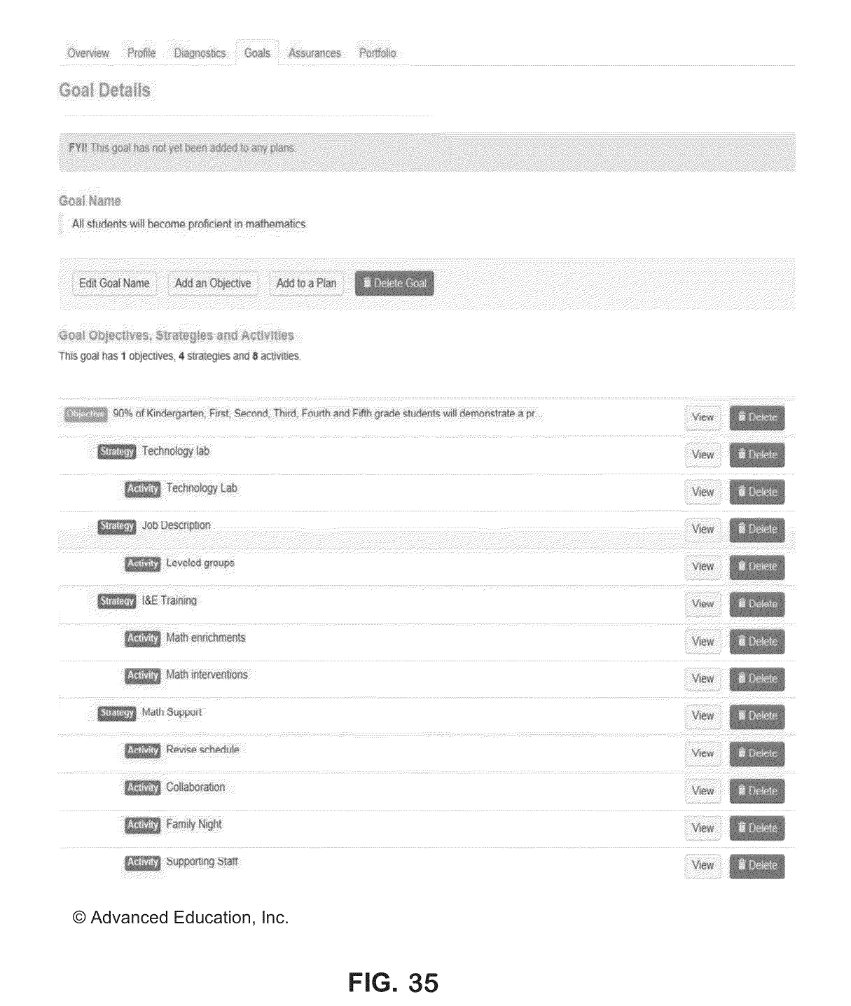

Above the plan table, the screen shown in FIG. 34 provides a table that lists all the goals associated with the administrator's selected school. The table lists the name of each goal and the number of objectives, strategies and activities assigned to that goal. Under an “actions” column, the table may indicate that a goal has not yet been assigned to a plan. This notice is a hyperlink that leads to a screen that allows the administrator to add the goal to a plan. Once added, the hyperlink may change to “edit,” which would lead to a screen allowing the user to edit or delete the plan. Alternatively, the screen may be changed so that “actions” are removed from the FIG. 35 screen and applied, at a different screen, within a goal level. The actions are “edit,” “add objective,” “add progress note,” and “delete.” A goal having unfilled data fields is identified by an “incomplete” marker.

Similarly to the plan table, the name of the goal on the goal table is a link that, when activated by the administrator, causes the tool GUI to present a screen that details the goal, as shown in FIG. 35. At the top, the screen provides a text box that presents the goal's name. The administrator may edit the goal name through a screen (not shown) selected by activation of an “edit goal name” button.

The screen lists the goal's objectives, strategies, and activities in a hierarchal format. The goal has one objective, i.e., that ninety (90%) percent of kindergarten, first, second, third, fourth and fifth grade students will demonstrate a proficiency in math. The goal includes four strategies associated with the objective, i.e., to conduct a technology lab, to revise job descriptions, I and E training, and to obtain mathematics support. Under each strategy is listed one or more activities. The use of the technology lab is, in essence, an activity, and so it is listed both as a strategy and as a lower-level activity.

Database 570 includes a record for each goal, and a respective record for each objective, strategy, and activity. Each record points to its higher-level record. This data structure allows the tool to present the higher hierarchal illustration provided in FIG. 35.

To the right of each objective, strategy, and activity are two selectable buttons—“view” and “delete.” Activation of the “delete” button allows the administrator to remove the corresponding objective, strategy, or activity from the goal thereby deleting the respective record in database 570. Deletion of an objective deletes the objective's strategies and activities.

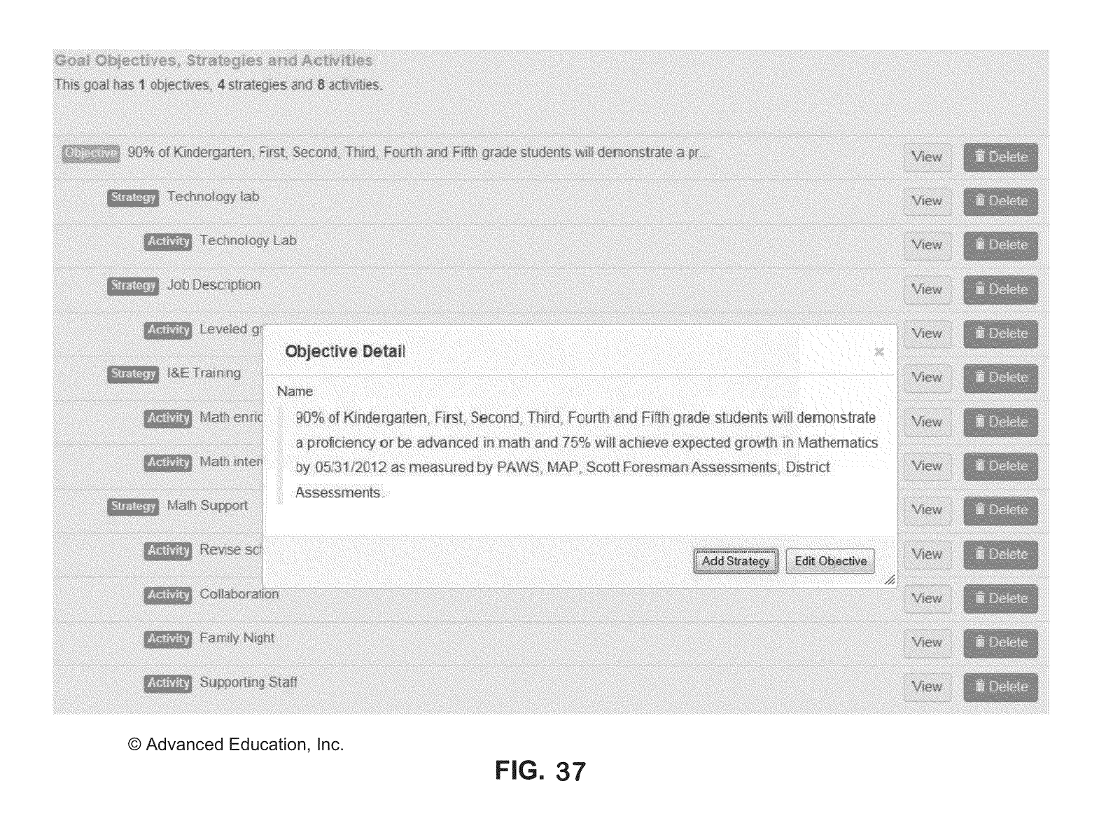

Selection of the “view” button by the administrator causes the tool to present a GUI box over the screen shown in FIG. 35 that provides details about the corresponding objective, strategy, or activity. Referring to FIG. 37, for example, the administrator has activated the “view” button for the objective shown in FIG. 35, resulting in the pop-up box shown in FIG. 37. This box provides the full name of the objective and includes a button, that, when activated by the administrator, produces a second screen (not shown) through which the administrator can edit the name. An “add strategy” button causes the tool, when the button is activated by the administrator, to present a GUI screen (not shown) through which the administrator can define a new strategy that, when saved through the pop-up box by the administrator through the GUI, creates a new strategy record associated with the objective.

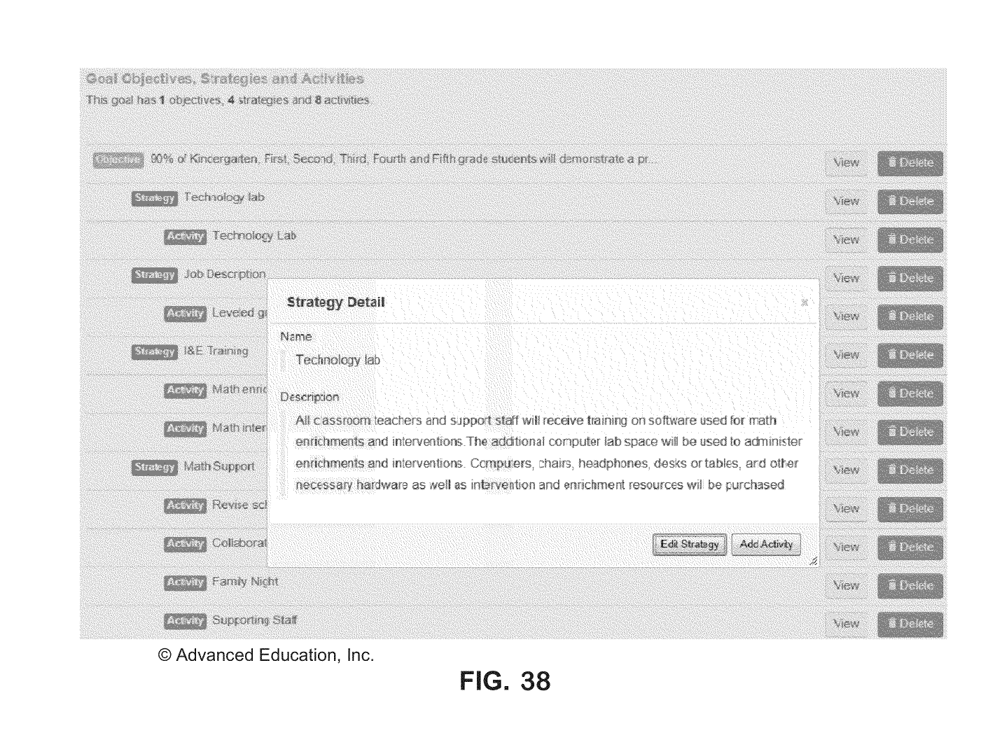

Referring to FIG. 38, activation of the “view” button associated with the strategy provides a pop-up box that provides the name and description of the corresponding strategy. Again, a button is provided that, when activated by the administrator, causes a pop-up box (not shown) to be presented, through which the administrator may edit the strategy's name and description. An “add activity” button allows the administrator to cause the tool to present a GUI pop-up screen (not shown) through which the administrator may add an activity. Through this screen, the administrator defines a name and description on the activity. A button is provided by which the administrator can save the activity, and upon receiving the administrator's activation of a saved button, the tool creates a new record for the activity in the database in association with the strategy.

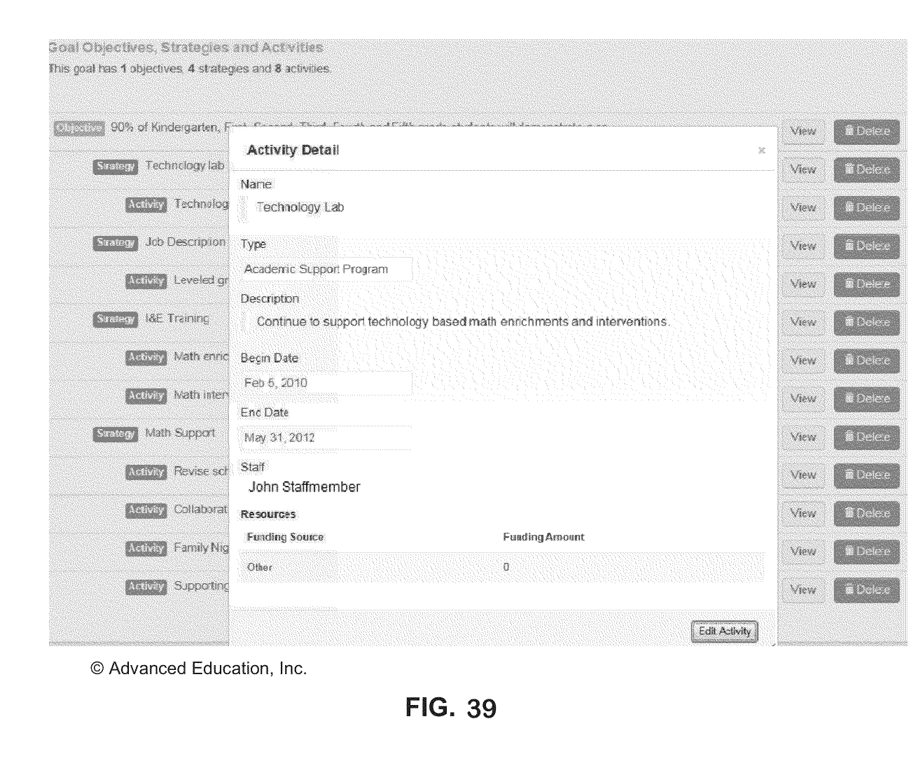

Referring to FIG. 39, activation of a “view” button associated with an activity causes the tool to present a GUI pop-up screen that provides details of the activity. The pop-up screen reflects the data saved in the activity's record in database 570. Each activity has a name, a type, a description, beginning and ending dates, the identification of a school staff member who is assigned to manage or confirm the activity's completion of the activity, and the identification of any sources of funding and the amounts of such funding. An “edit activity” button is provided through which the administrator can cause the tool to present a subsequent pop-up screen (not shown) through which the administrator may edit these details. A “saved” button on this pop-up screen allows the administrator to save changes to the database record for this activity. Similar buttons are provided on the detail pop-up screens for strategies and objectives.

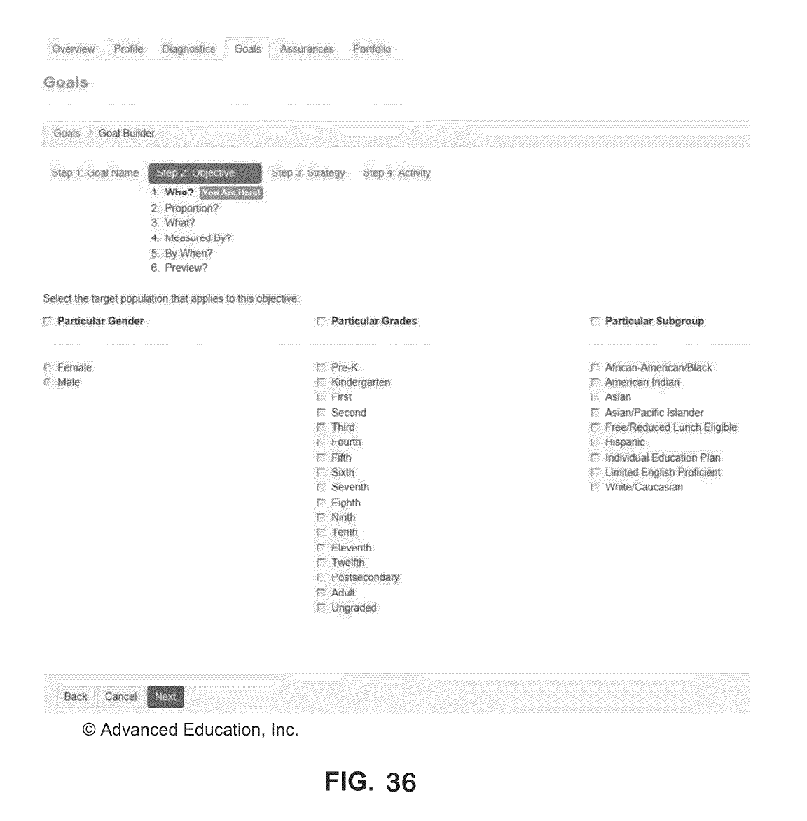

To add an objective to a goal, the administrator activates an “Add An Objective” button on the main goal detail screen shown in FIG. 35. This prompts the tool to provide a sequence of screens through which the administrator provides a name for the goal and defines objectives, strategies, and activities. The screens are provided in sequence, with the GUI providing a “next” button in each screen that, when activated, causes the tool to save the data entered on that screen and present the next screen in the sequence. The “objective” step, in turn, comprises its own sequence of screens causing the first illustration as shown in FIG. 36. The screen presents six hyperlinks under the “objective” step, one each for respective aspects of the objective, in this example “food,” “the person,” “what,” “measured by,” “by when,” and “preview.” Activation of each hyperlink causes the tool to present a respective GUI screen. The “who” screen, shown in FIG. 36, allows the administrator to define the particular target group to which the objective is directed. As shown in this example, there is an assumption that all objectives will be directed to students, and the GUI provides the ability to select categories of demographics applicable to students, in this example gender, grade, and a set of predetermined sub-groups, such as ethnic origin, language proficiency, and whether the student is subject to an individual educational plan. It should be understood that these groupings are presented for purposes of example only and can be selectable, or may not be used.

Activation of the “by when” link causes the tool to present a GUI screen through which the administrator may enter a target date by which the goal is to be achieved. A “save” button on this screen (not shown) allows the administrator to cause the tool to save the entered data into the record for the goal in database 570.

Accordingly, this set of screens allows the administrator to set up a measurable objective comprising (a) who is the target population (for example, teachers, staff, target students, etc.), (b) what does that target population need to achieve, (c) how will success be measured, (d) a date by which the objective is to be achieved.

It should be understood that the administrator and/or the managing entity can predefine the fields presented to the administrator so that the objective is targeted to the appropriate students or subgroups. That is, the demographic and subgroup information presented by the system to the user are specific to the education organization, e.g. based on protocol.

The administrator then completes the strategy and activity sections, where the system provides fields similar to the objective section for the administrator's completion. In the strategy section, the administrator enters textual information and provides a general description of how the objective is going to be carried out.

As described above, the administrator defines one or more strategies for each objective. A strategy provides a description and/or details how the school plans to achieve the corresponding objective. For example, a strategy for the objective illustrated in Figure in 37, technology lab, is that all classroom teachers and support staff will receive training on software used for math enrichments and interventions, as shown in FIG. 38. Further, additional computer space will be used to administer the math enrichment and interventions, and additional computers and other materials will be purchased to support the initiative. This provides the school with the specific direction how to achieve the associated goal. The administrator defines other strategies using the system in a similar manner. When the administrator completes the strategies, the administrator activates a button indicating that the administrator is finish, and the system stores all of the resulting strategies in the managing entity database 570.

Also as noted above, the administrator defines specific activities that will be performed to complete the strategies. The administrator inputs various detailed information into the system about the activities. As illustrated in FIG. 39, the administrator has defined the type of specific program to be implemented, a description of the program, when the program begins, what teacher or staff member is involved, the resources needed, and any funding sources. Therefore, after the strategy is determined, specific activities are then immediately organized and carried out by the administrator so that the strategies are implemented. This ensures that the strategies are not forgotten. When the specifically-required activities are successfully accomplished, this strategy is fulfilled, which, in turn, meets the metrics of the goal. When the metrics of the goals are met, the school's performance should improve.

Database 570 also stores assurances to which the school is subject. Assurances are optionally used and, when present, are defined by an education organization's protocol. An assurance is a policy, procedure, or practice the school is expected to maintain The school is or may be required to confirm, or provide assurance, that the school is maintaining the stated policy, procedure or practice. Typically, the requirement is established by an external entity, such as a state department of education or other state or federal agency, but the requirement may be imposed by various entities and could be self-imposed. In any event, database 570 stores the assurances, and the database record for the school links the record to the assurances applicable to the school. As described in more detail below, the tool provides a GUI screen through which the school administrator may confirm whether or not school has conformed or is conforming to the requirement. The database stores this information in association with the school as the administrator enters the confirmations, and the school may provide reports to a regulatory body or to an accreditation entity (for example the managing entity) as needed.

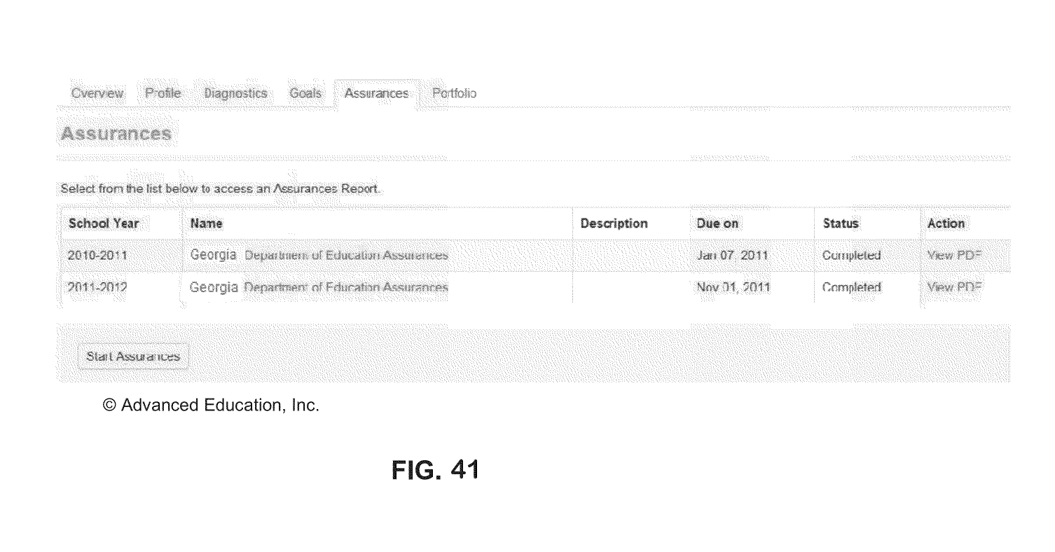

From the overview GUI screen shown in FIG. 3, or from any other screen having the group tabs at the top row, the administrator may access a sequence of assurance-related screens by activating an “Assurances” tab, causing the tool to present the GUI screen shown in FIG. 41. The screen presents a table that lists each group of assurances associated in database 570 with the school with which the administrator is associated. As indicated in the table, each group of assurances is associated with a school year and with the name of the entity imposing the assurances. That is, database 570 has a record for each group of assurances, where each record identifies the school year and the imposing entity's name. Each record identifies the date on which the assurances are to be completed, and a status indicator that identifies whether or not assurances have been completed. In order for the administrator to submit a report, which may contain assurances, the system in the presently-described embodiments requires that all content defined by the protocol for the report must be received by and stored into the system. The system checks for completion of required assurances upon submittal of a report.

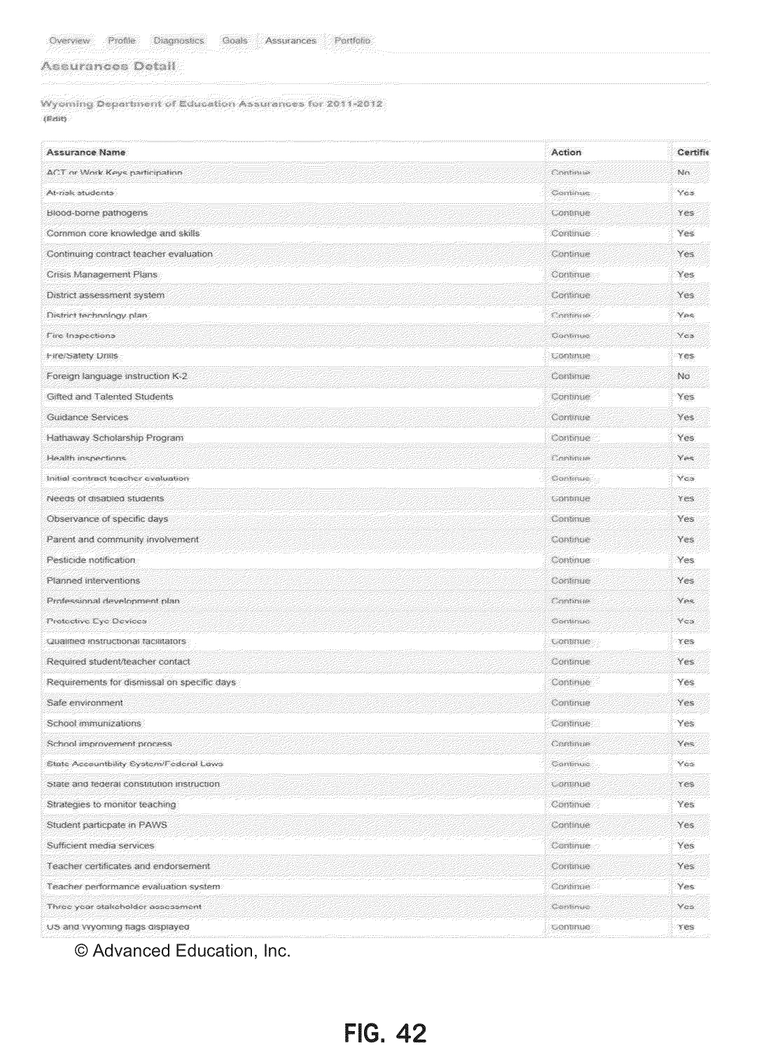

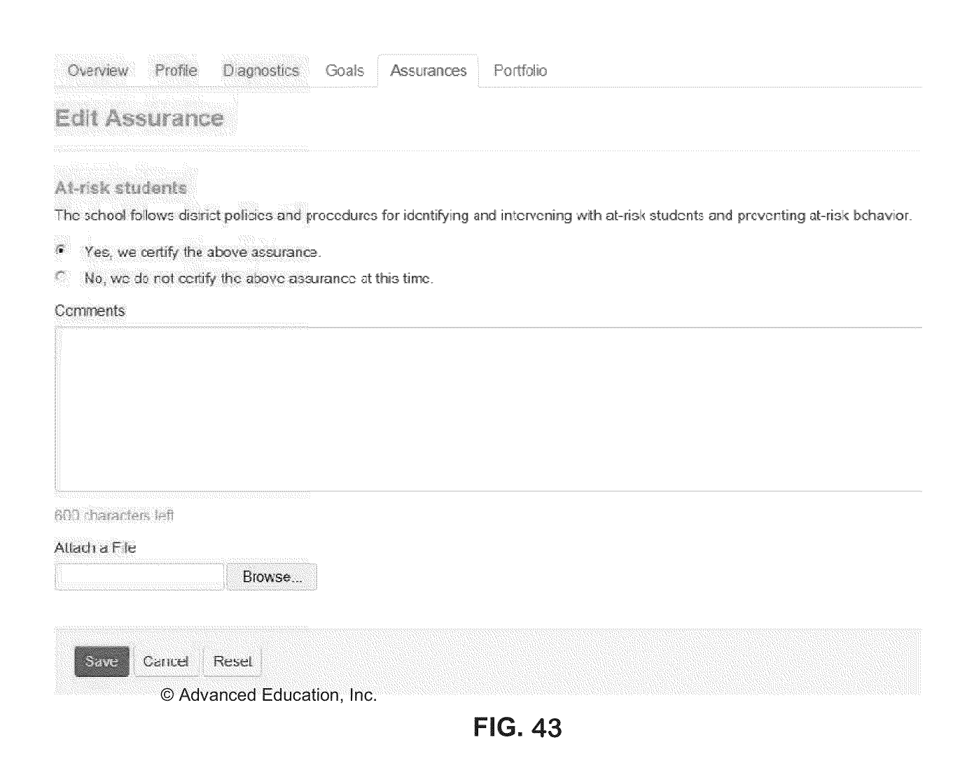

To view a set of assurances, the administrator clicks on a “continue” hyperlink embodied in the table under the “action” heading for the respective assurances, thereby causing the tool to present a GUI screen providing a detail of the selected assurances, as shown in FIG. 42. The screen provides a table listing each individual assurance stored under that assurance group. When the administrator activates a hyperlink in the table, the tool presents a new GUI screen to the administrator, such as shown in FIG. 43, that provides a textual description of the assurance and selectable, alternative response choices, indicating whether or not the administrator's school has complied with the assurance. The screen provides a text box into which the administrator may enter comments, if desired, to be stored in the database in association with the assurance. The administrator may also attach a file to the assurance, by directly entering a location address or selecting an address through a “browse” feature that searches for documents within database 570. Entering or selection of a document location establishes a pointer in the assurance data record, thereby associating the document with the assurance. Thus, with reference to the example provided in FIG. 43, the assurance is that the school should follow distinct policies and procedures for identifying and intervening with at-risk students and preventing at-risk behavior. In support of the assertion as shown in FIG. 43, that the school has complied with the assurance, the administrator may attach a document, such as a crisis management policy, that constitutes parts of the school's policies and procedures for preventing at-risk behavior. The administrator saves the changes to this screen by activating the “save” button at the bottom of the screen. In response to receiving the “save” instruction, and if the administrator as selected the “yes” option, the tool modifies the assurance record to indicate that the assurance has been certified. This is reflected in the rightmost column, as shown in FIG. 42.

After the administrator has completed the assurances, the administrator may select a “Portfolio” tab, which allows the administrator to view the school's portfolio. The portfolio includes a compilation of the diagnostic section, goals/plan section, and assurances section. The system aggregates this data into a report that may be required by jurisdictional authorities. The administrator can download a PDF of the report. Additionally, the system saves the report on the managing entity database and allows the administrator access to the report in the archives.

The administrator can then use the system to electronically submit the improvement plan along with its components to a jurisdictional entity, such as a state department of education.

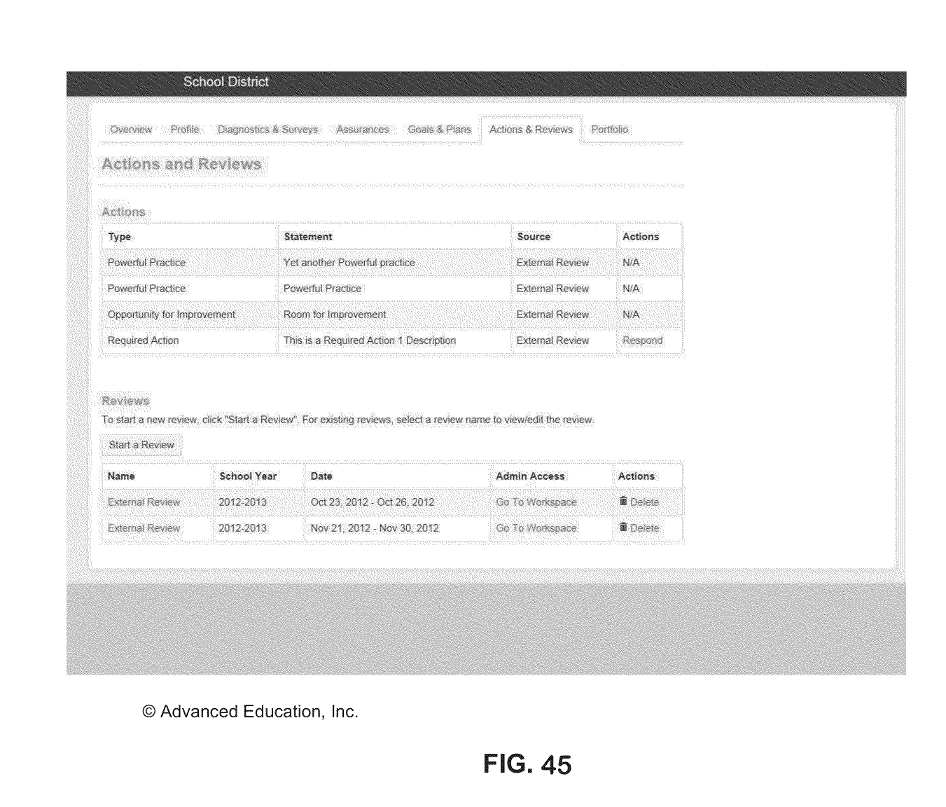

Also from the Overview screen shown in FIG. 3 or from any of the other system screens discussed herein having the tab options at the top part of the screen, the managing entity may select an “Actions & Reviews” tab, causing the tool to present a screen, shown in FIG. 45, that allows the managing entity to conduct an external review of a given school. The tool's external review feature provides a framework by which the managing entity can provide an assessment of the school, under a metric similar to that utilized by the school in its self-assessment. Having a common framework, the self-assessment and the external review provide common diagnostic information about the school, thereby providing the ability to compare internal and external assessments of the school's performance. This comparison is, itself, of value in that similarities in views taken by the internal and external reviews reinforce the likelihood those assessments are correct, whereas differences in views between the two sources may indicate a likelihood that further review is needed in that particular area. The external review is viewable by the administrator for the school being reviewed.

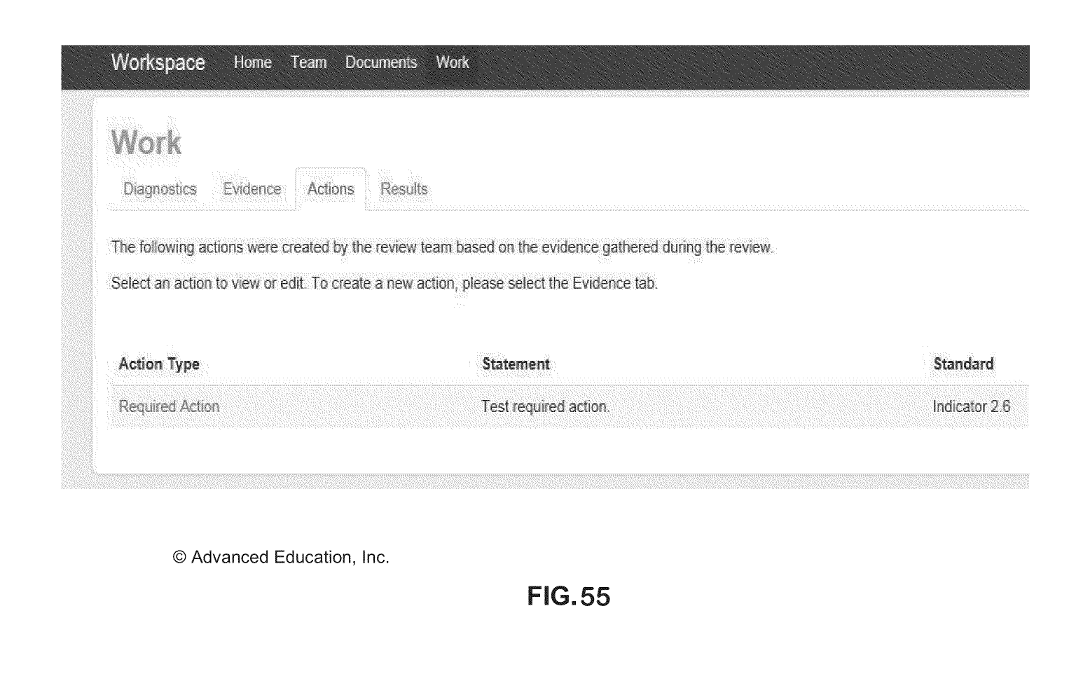

In operation, the tool's external review component provides a structured approach for conducting the external reviews, which can be managed by the managing entity. The managing entity may schedule reviews with the applicable school, assign staffing teams to conduct the review, generate review findings, and generate a review report. Members of the team assigned to conduct an external review access the tool's workspace in order to perform those responsibilities. The managing entity may make the tool's external review reports available to the corresponding education organization upon approval of the report by the managing entity. The tool's external review component is discussed in detailed below with regard to FIG. 45-56.

The screens illustrated in FIGS. 45-56 may be part of the general graphical user interfaces 526, as discussed above. The managing entity server 510 accesses the GUI, and the respective screen, via school analysis/improvement module 508 (as illustrated in FIG. 1B). Server 510 transmits each GUI screen over network 512 to a computer system 504, at which an operator authorized by the managing entity interfaces with the screen. Server interface module 522 receives the GUI screen, and software module 502 directs the screen to be presented on display 529 to the particular party, for example an operator at the managing entity or one or more designated external overview team members. Server 510 may retrieve data stored in database 570, as described with regard to the screens as discussed below, and may store in the database data entered by the operator or external review team members through such screens.

FIG. 45 illustrates the graphical user interface screen through which the managing entity may schedule a review or edit or otherwise manage an existing review. In a “Reviews” table, the screen lists any existing external reviews associated with the present school (which the managing entity, having access to all education organizations on the system, has selected through a prior screen) that are being conducted by the managing entity. The table identifies the name of the review, the school year for which it is applicable, the start and end dates (i.e. the period of time during which the staff is to conduct and complete the review; in one embodiment the system automatically sets these dates as predetermined periods of time following the present date, but the dates may also be selectable), “Admin access,” and “Actions.” The “action” column includes an actuatable function icon that allows the managing entity operator to delete the external review indicated in the corresponding table row. In that regard, database 570 includes a record for each external review, each record including the data as described herein and being associated with the managing entity conducting the external review and the school to which the external review applies.

The screen shown in FIG. 45 also includes an “Actions” table, which is populated when the External Review Report is submitted. It identifies recommendations the external review team makes as a results of the review process. “Required Actions” are actions the school must take (e.g. to achieve accreditation by the managing entity). “Powerful Practices” are recommended actions. “Opportunities for Improvement” are opportunities noted by the team for consideration but not necessarily recommended. The administrator for the education organization may access this table (although not the “Reviews” table) to see the recommendations and respond to the required actions. The “respond” hyperlink opens a screen through which the administrator can respond to the required action in narrative form as well as create and associate goals to the response. The education organization can thereby use the goals structure (discussed above) to address required actions.

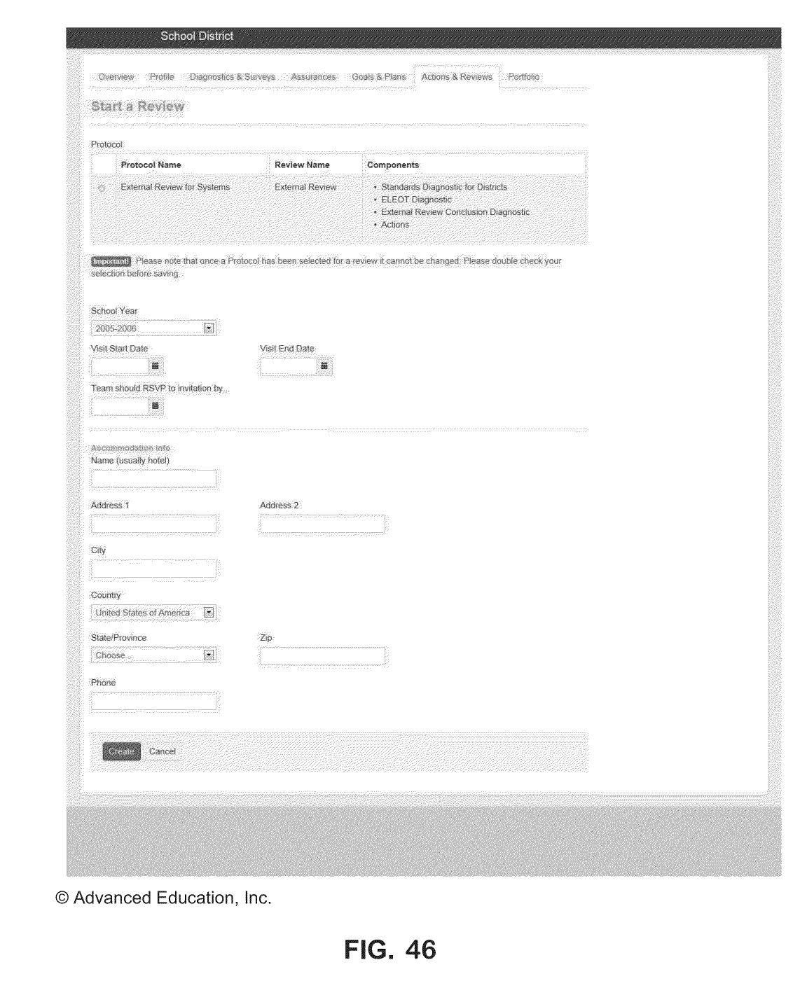

The screen shown in FIG. 45 includes a “start a review” button, the activation of which by the managing entity operator causes the tool to present a screen as shown in FIG. 46, by which the managing entity operator schedules a review and specifies certain particulars (for example, a review protocol, the school year under review, the start and end dates of a school visit, the team's RSVP date for the school visit, and accommodations/hotel information.

A table at the top of FIG. 46 includes a list of protocols available to the external review team that will govern the external review. The protocol is a pre-determined set of procedures, established by the managing entity, under which the external review will be conducted. The screen provides a selectable button by each pre-determined protocol, enabling the managing entity operator to select the particular protocol that will be applicable for the new review. Once selected, and once the managing entity operator activates the “create” button at the bottom of the screen in FIG. 46, server 510 creates a record in database 570 for the new external review that identifies the selected protocol as that protocol which should be followed. In the present example, only one protocol is available, but it should be understood that this is for purposes of example only, and the tool may provide an option to select any of multiple protocols.

Each protocol has a name, which is defined earlier by the managing entity. Under “components,” the table lists the protocol's functional components, i.e. those tasks that should be performed in completing the external review. The first, in the illustrated example, is “standards diagnostic for districts.” As will be discussed in more detail below, this is a portion of the tool by which the external review staff assesses the school according to the same standards by which the school conducts its self-assessment. ELEOT (Effective Learning Environments Observation Tool) refers to a diagnostic defined by the managing entity that is independent of the school's self-assessment, and which will be discussed in more detail below. As is also discussed below, the conclusion diagnostic is a set of functions by which the external review team draws conclusions based upon execution of the standards diagnostic and the ELEOT diagnostic. A final portion of the tool component allows the team to define actions that need to be taken to address needs identified through the conclusion diagnostic.

The screen shown in FIG. 46 allows the managing entity operator to define the school year to which the external review is applicable, through a drop down box illustrated in the figure. Because the external review typically requires one or more staff members to visit the subject school, the operator can indicate the start and end dates over which the visit will occur. Often, the school will invite the managing entity to conduct the visit and the external review. Such an invitation may, in fact, be the event that causes the managing entity to set up the external review. In such instance, where there is an existing external review invitation, the managing entity operator enters a date in a text box provided in the screen shown in FIG. 46 by which the external review team should respond to the invitation. When hotel accommodations are arranged for the visit, the managing entity operator, or one of the team members, may enter this information into the external review record, for ease of reference by the other members.

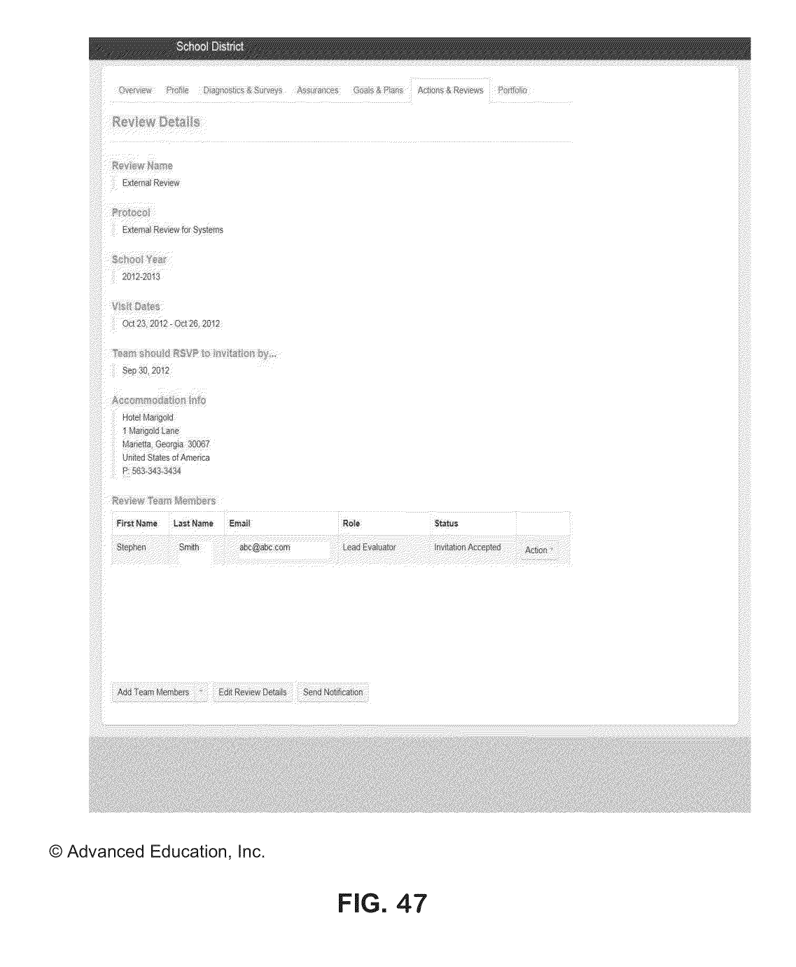

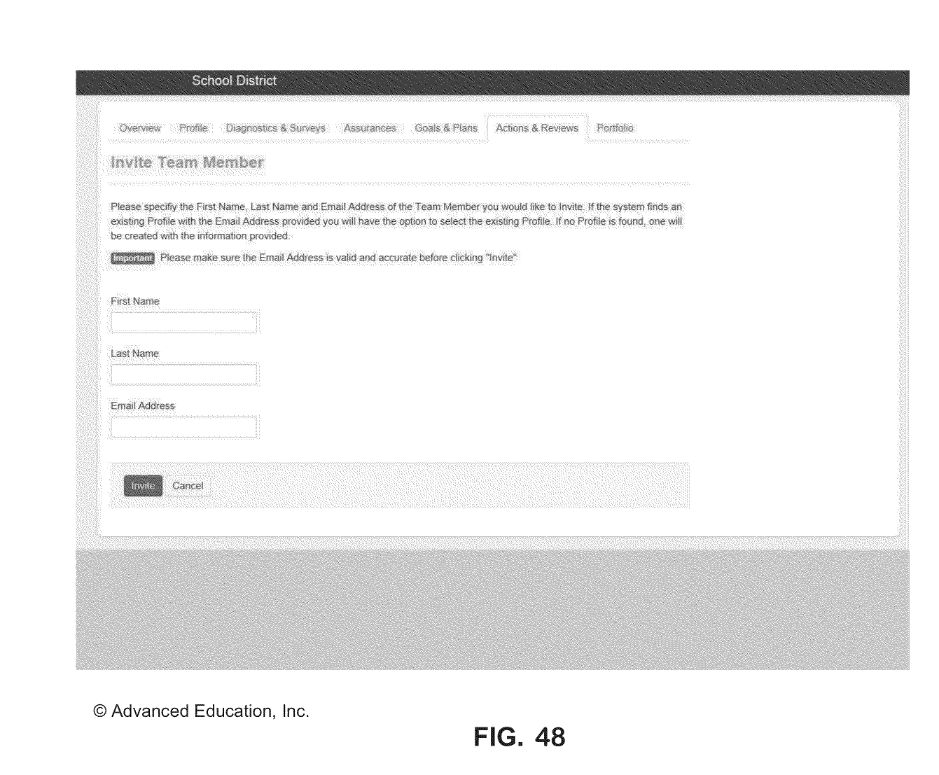

Upon activation of the “create” button the screen of FIG. 46, the tool saves a record corresponding to the external review in database 570, and presents a screen, shown in FIG. 47, that lists the details of the review selected and entered from the screen in FIG. 46. At the bottom of this screen is a table that lists the team members. The tool does not add team members to the screen shown in FIG. 46, and so upon the review's initial creation, this table will be empty. Team members may, however, be added to the screen shown in FIG. 47, through an “add team members” option. The option is a button with an embedded drop-down list, from which the managing entity can select among “lead evaluator,” “associate lead evaluator,” “team member,” and “reviewer,” thereby defining the team member's role. Selection of one of these options causes the tool to present the screen shown in FIG. 48. The managing entity operator then enters the first name, last name, and e-mail address of the person the managing entity operator would like to add to the team. Upon selecting an “invite” button at the bottom of the screen, server 510 queries database 570 to see if a record exists having the same information as entered through the screen. If so, the tool presents a sub-screen (not shown) that provides the first name, last name and e-mail address found in the database and asks if the operator would like to associate the identified profile with this external review. If the operator selects a button on the sub-screen indicating an affirmative response, the tool updates the external review record in database 570 to include a pointer to the team member's existing profile record in the database. If the operator selects a button indicating a negative response, or if the tool finds no existing record with the entered information, the tool creates a new team member record, with the information entered through the screen shown in FIG. 48, and updates the external review record to point to this new team member record. The tool will also generate an e-mail in a predetermined format, inviting the identified potential team member to participate in the external review, and automatically sends the e-mail message to the e-mail address entered into the screen of FIG. 48. The email includes a link by which the team invitee can accept or decline the invitation.

Once the managing entity operator activates the “create” button, data in the record may be edited. For instance, from the screen shown in FIG. 45, the user may activate a hyperlink comprising the external review name, causing the tool to present external review data that may be edited.

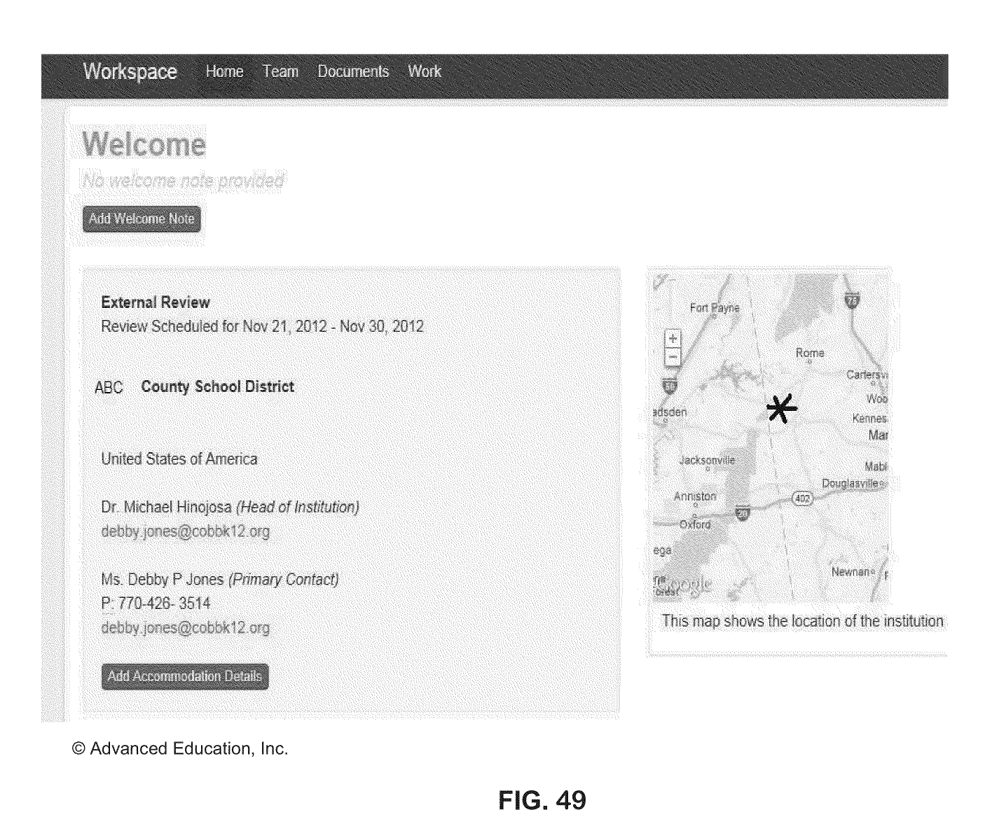

As illustrated in the example graphical user interface screen of FIG. 49, the team members have access to a dedicated workspace (each is provided a link and PIN to access the workspace, thus allowing individuals who are not registered users of the system to be external reviewers) in order to conduct the functions and responsibilities of the external review. The screen shown in FIG. 49 is the workspace home screen. The screen includes a welcome message (entered in a different screen by the lead evaluator) and presents high level information from the external review's record in database 570, for example the date of the review, the school being reviewed, and primary contacts at that school (from the school's demographic data). A tab bar at the top of the workspace screens allows the team members to access team information, documents relevant to the external review, and to access a work area for generating findings for actions, and/or to review reports. Each of these tabs, and corresponding functions, is discussed below. The tool that drives the GUI screens interacts with database 570 to store and retrieve corresponding information. In general, the information and documents discussed with regards to the workspace are stored in association with a given external review, for example by direct storage on the review record in the database or through database pointers. The school administrator does not have access to these screens but can access the External Review Report (in the Portfolio tab) once the report is submitted and approved by the jurisdiction.

To access the workspace, the team members may utilize one or more computers connected to network 512 to thereby access managing entity server 510 and module 508, which executes a software tool that presents the screens discussed herein. The computer may be a computer 504 or other computer in communication with server 510. Regardless, the team member computer receives graphical user interfaces from server 510 and communicates data therebetween, as well as receives and stores data to and from database 570.

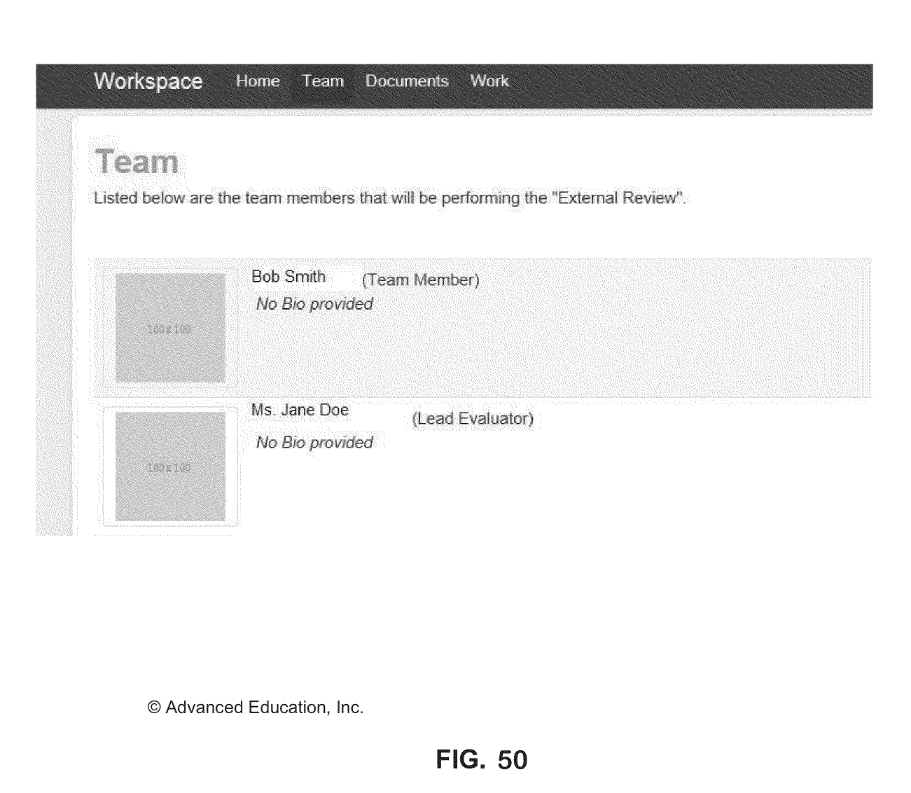

When a team member accesses the “team” tab on the workspace tab bar, the tool provides a GUI screen as shown in FIG. 50, which provides biographical information on each team member assigned to the external review.

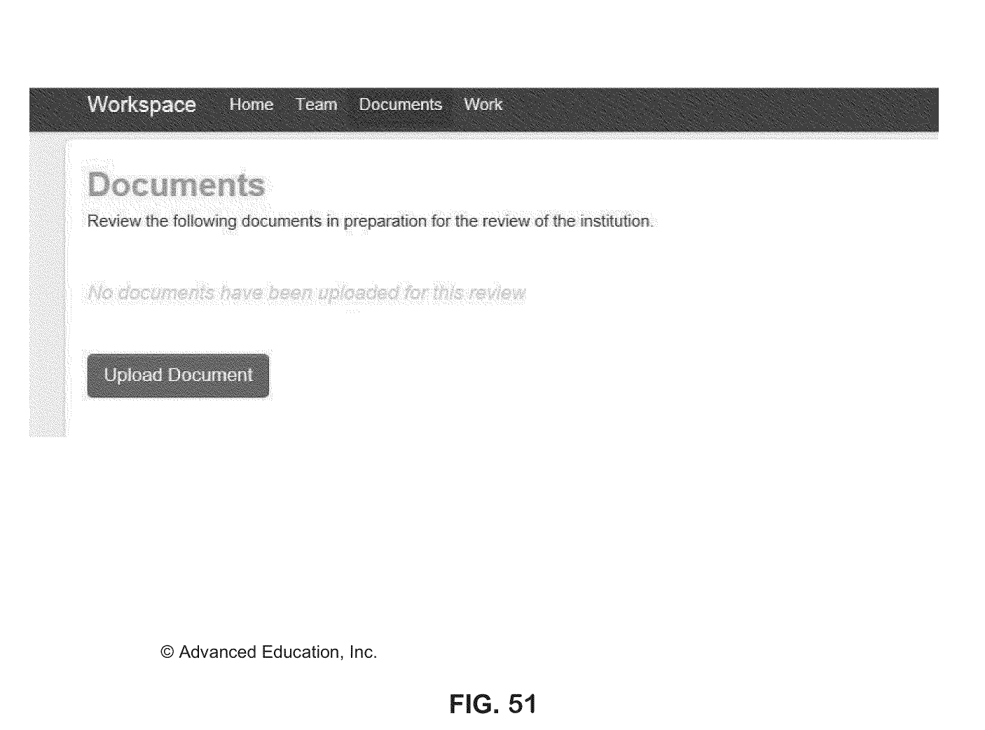

Activation of a “documents” tab on the tab bar causes the tool to present a GUI screen, as shown in FIG. 51, that lists all documents assigned to this workspace, i.e. this external review. Although no documents are illustrated in the example provided in the Figure, as the team members and/or the managing entity operator, upload documents to the workspace, the screen provides a list, each identified document being presented as a hyperlink through which the team member or operator may select a screen within which to view the document. Documents are added to the workspace through the “upload document” selectable button shown on the screen. Activation on this button causes the tool to present an operation screen (not shown) through which the user (which may be any team member) may browse documents stored on database 570 or on the user's desktop or hard drive. The screen allows the user to select such document, and by so doing, the user causes the tool to store a pointer to the document in the workspace/external review record on database 570. Thereafter, the GUI screen includes the uploaded document in the document list.

In general, the managing entity operator and/or team member uploads documents to a given workspace that may assist the team members in performing the external review. The documentation is entirely within the discretion of the managing entity operator but may include, for example, self-assessment data, peer surveys, or other diagnostic data or information stored in the system by or for the school for which the external review is being performed.

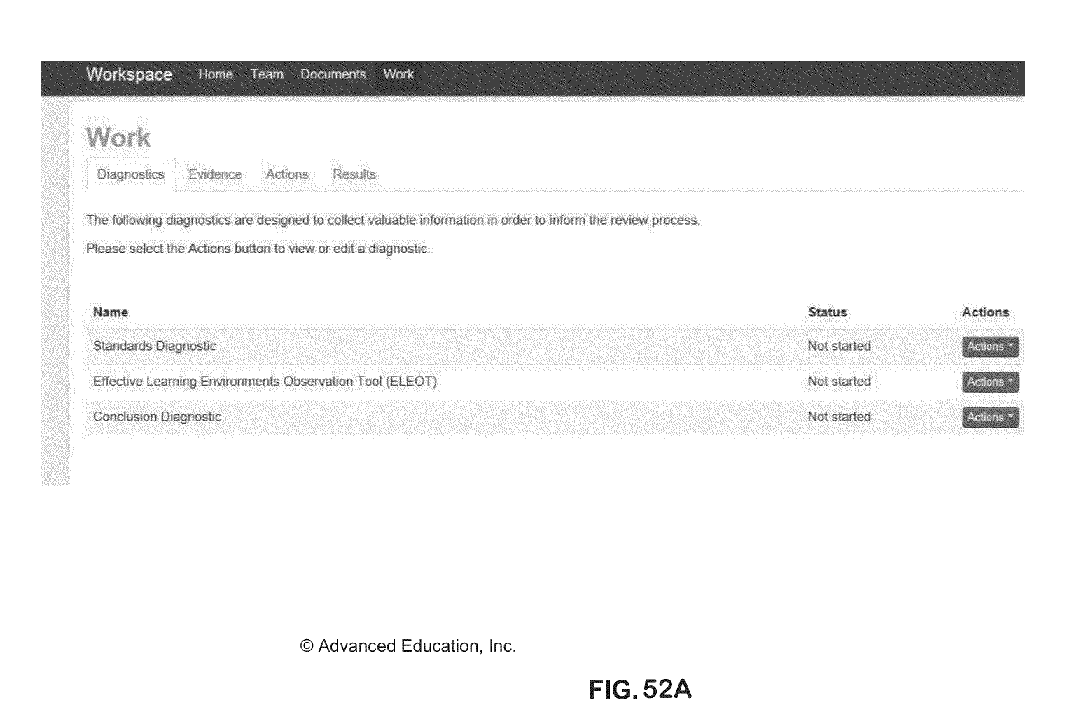

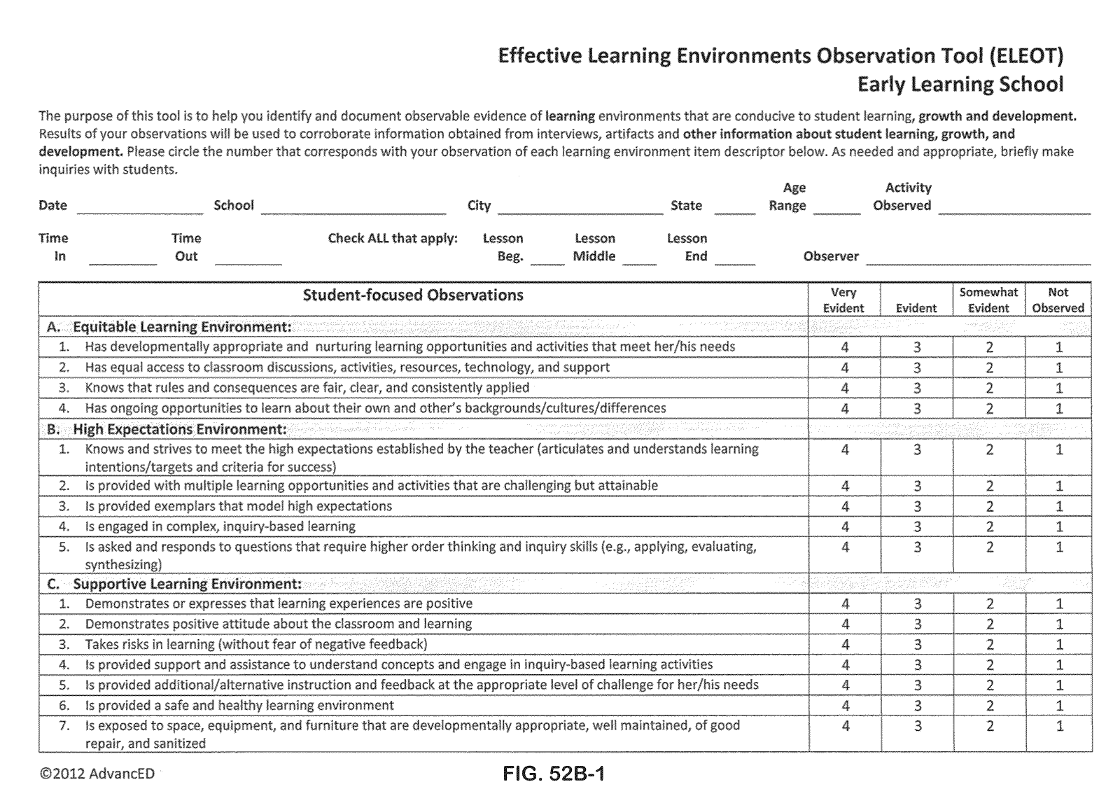

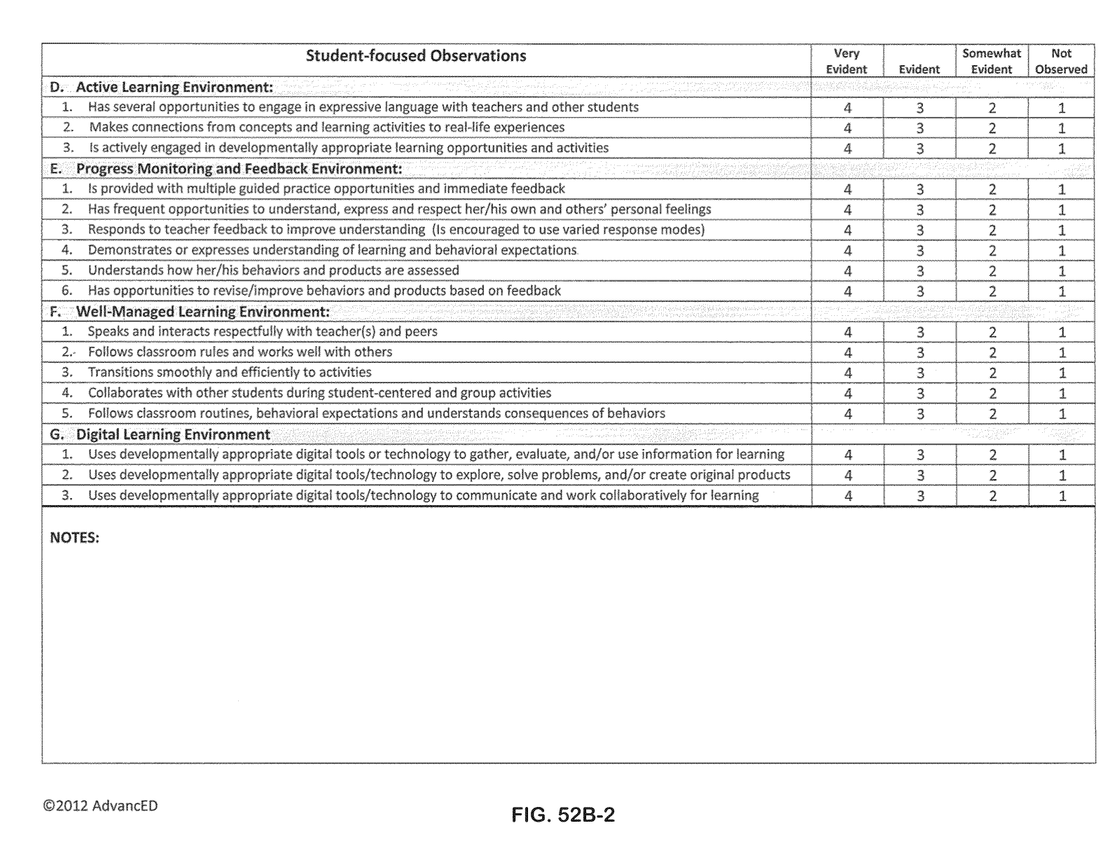

Activation of the “work” tab in the tab bar causes the tool to present the GUI screen shown in FIG. 52. This screen in turn, provides a sub-tab bar that provides access to screens supporting four high-level functions comprising the external review process. The first, “diagnostics,” provides a set of screens through which a team member assesses the school according to a pre-determine protocol, for example the same standards and indicators that form the basis for the self-assessment conducted by the school for which the external review is conducted. The second, “evidence,” provides a series of screens that applies a predetermine metric to the assessment data entered under the diagnostic protocol, to thereby score the assessment data. Based on the evidence, team members may define recommended actions to be taken by or for the school, through screens provided under the “actions” tab. The team may generate reports through screens provided under a “result” tab.

The “work” area defaults to the “diagnostic” sub-tab, as shown in FIG. 52. For each external review record in the database, the tool assigns one or more diagnostics. As indicated above, the diagnostic is a framework for collecting data and/or subjective assessments relating to a school's performance. In the example shown in FIG. 52, the tool assigns three diagnostics to this external review/workspace. The first is a “standards” diagnostic, which comprises the same standards and indicators applied to the self-assessment for the subject school. Moreover, the answer options presented for each indicator are the same as the answer options provided to the school in the self-assessment, thereby allowing the external review assessment to be directly compared with the self-assessment. The “effective learning environment observation tool” diagnostic is discussed in more detail below. The “conclusion” diagnostic allows the team to add a conclusion to the External Review Report. The “actions” allow the lead Evaluator to edit the External Review Report, view a PFD image of the report, or submit the report to the managing entity and/or a jurisdiction.

Activation of the “effective learning environments observation tool” presents a sequence of screens (not shown) that requests data similar to that shown in FIG. 52A. As indicated in the figure, a first screen prompts the team member to enter the date on which the diagnostic is completed, the school's identity, the city and state in which the school is located, the age range of the students at the school, and the activity observed. As indicated below, the protocol under this diagnostic is directed to obtaining assessment of standards and indicators relating to student learning That is, the standards reflect objectives that, if present, indicate the school is operating in a way that fosters learning among its students. The indicators, to the extent they are present, relate to the respective standards in such a way that the degree to which the indicators exists reflects upon whether the standards exist.

Because the diagnostic is based upon standards and indicators that reflect whether the school is operating at a level that fosters learning, in one preferred embodiment, the standards and indicators all relate to classroom teaching. Thus, the team member may assess the school through classroom visits, and a screen (not shown) therefore provides text entry areas by which the team member can indicate the times at which the visits began and ended and provides a selectable option by which the team member can indicate the point in a given lesson at which the team member began a visit.

The diagnostic's goal is to quantify a set of standards, and supporting indicators that reflect whether the school operates effective learning environments, based on observations of those learning environments in operation. The high-level standards are that a learning environment (a) must be equitable to the students within that environment, (b) should have high-expectations of those students, (c) should support their learning environment, (d) the classroom should operate an active learning environment, i.e., the students can actively participate, (e) the classroom should provide active monitoring of the students and provide feedback to the students, (f) the classroom should be well managed, for example, the students should follow rules and behave with decorum, and (g) the classroom should utilize digital technology. Each indicator is an articulation of a condition that, if present and/or to the extent present, indicates the likelihood that its respective standard is met. As indicated in FIG. 52B, the protocol associates a scoring metric that allows the observer, i.e. the external review team member, to score the classroom/learning environment being visited for each indicator, in this instance on a scale of 1 through 4.

Alternatively, the external review team member may manually complete a paper form carried with the team member into the classroom, or later, so that the diagnostic data may be entered into the database through a GUI associated with the external review at a later time.

As illustrated in the exemplary graphical user interface of FIG. 50, the team members have access to a dedicated workspace in order to conduct the functions and responsibilities of the external review. The workspace contains external review information, team member information, access to documentation needed for the external review, school information (e.g., a map showing the location of the school), as illustrated in FIG. 49, as well as a work area used for generating the findings or actions and to the review reports. In one embodiment, the workspace is information relating to the external review which server 510 stores in database 570 for future use by the team members and/or the school administrator.

The team members may use one or more computers connected to network 512. The computer may be computer 504 or another computer in communication with server 510. Regardless, the team member computer receives GUIs from server 510 and communicates data therebetween as well as stores data on database 570.

As noted above, computer 504 may comprise a mobile device. In one such arrangement, the managing entity provides an application that resides on an external review team member's mobile device 504, for example a smart phone or tablet device. The application enables a connection between the mobile device and server 510, specifically module 508 and its associated GUI's. Module 508 may provide a GUI that is specifically suited to the mobile device and that provides data capabilities compatible with the mobile device. Alternatively, server 510 and module 508 may provide data, but not a mobile-specific GUI, and the mobile application may house a local GUI that pulls data from server 510 to present to the user. As should be understood by those skilled in the art, mobile devices vary in their data, functional, and display capabilities, and in their operating systems, and it is generally desired to create a respective application at least for each such operating system. The particular means by which an application may communicate with a server module, such as module 508, are operating system-dependent. Such configurations should be understood, in view of the present disclosure. It should thus be understood that all steps described herein that are performed by the external review members via computer 504 may be performed on the mobile device, using such application. For example, the application may allow the external review member to review address and contact information for other team members, review school location information and maps, review accommodation information and maps, and review documents uploaded to the system by the managing entity, as described below.

To assist the external review team members, the school administrator may upload supporting data or documents to database 570 prior to the external review. As illustrated in FIG. 51, the school administrator uploads these documents or supporting documentation in the “Documents” section of the workspace. To accomplish this, server 510 presents the graphical user interface of FIG. 51 (according to an embodiment), and the administrator activates the “Upload Document” button. The administrator then selects the appropriate documents, and uploads these documents to server 510. Server 510 then stores the documents in database 570. By uploading the relevant documents, the administrator allows the team to review this information prior to or during the external review. The relevant documents can include the self-assessment data, peer surveys, or any other diagnostic data or information.

FIG. 52 illustrates a graphical user interface providing the workspace, and the diagnostics that the external review team uses for the external review, according to one embodiment. This graphical user interface provides a means for the external review team members to administer diagnostics, review evidence, create actions and generate a report. The diagnostic is a means by which the external review team can rate the school based on various criteria, such as criteria similar or the same to those discussed above for FIG. 16-20. This allows for a comparison between the self-assessment diagnostic data performed by the school (discussed above with regard to FIG. 16-20) and the evaluation diagnostic data performed by the team members.

Additionally, the self-assessment diagnostic data and the evaluation diagnostic data arise from common standards and indicators. For example, each self-assessment diagnostic item administered by the school may be ranked between 1 and 4 (1 being lowest and 4 being highest), which would also be the ranking system for each corresponding evaluation diagnostic item that is administered by the external review team members. This allows for the self-assessment diagnostic data and the evaluation diagnostic data to be aligned among a common scoring scale for ease of comparison.

The external review team members then perform a review of the school using the same or similar diagnostic review criteria that the school performed for the self-assessment diagnostic, although additional review criteria may also be reviewed by the external review team. The external review team inputs their ranking system for each diagnostic item and submits such diagnostic information via a computer to server 510, which stores the data in database 570. The external review team members perform such operations for each diagnostic item until all have been completed.

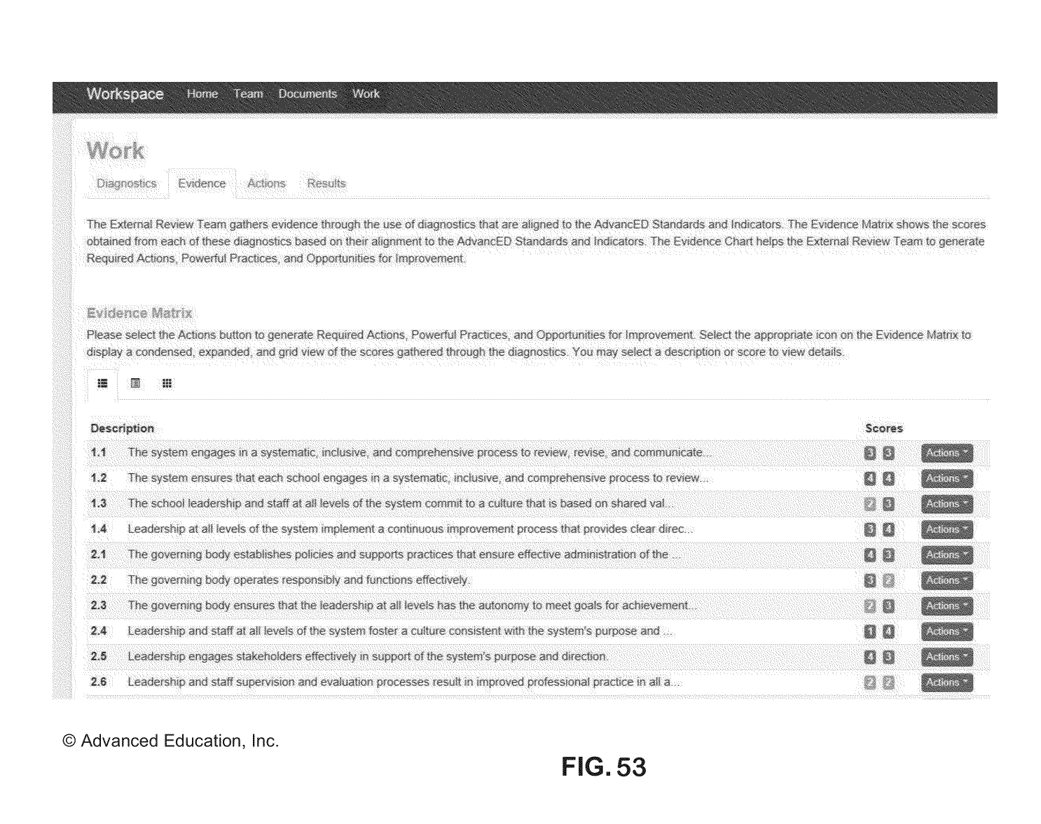

Once the external review team has completed each of the diagnostics, such that server 510 uploads the completed diagnostic data to database 570, activation of the “evidence” tab from the work screen shown in FIG. 52 causes the tool to present a screen, as shown in FIG. 53, that illustrates scoring data from the self-assessment and the external reviews and that allows the external review team to establish an action plan. The screen shown at FIG. 53 lists each of the indicators within the standard/indicator hierarchy discussed above. The table provides two scores for each indicator. The first score is the rating (from 1-4) provided by the self-assessment for that indicator while, the second score is the rating for that indicator provided in the external review. Thus, for each indicator, the table provides a visual comparison between the school's internal review of its performance with regard to the indicator, and review by the external review team. The visual indication may include color coded highlighting of high and low scores.

As indicated above, the evidence screen may indicate to a user that action is needed with regard to a given indicator, either because of the raw score value itself or because of the disparity between the self-assessment and the external review scores. Thus, for example, although the external review rated indicator 2.4 with a maximum grading of 4, the self-assessment provided a rating of 1. Even if the higher rating is, in fact, correct, the disparity between the internal and external views of the score's performance regarding that indicator may itself indicate a need for further investigation. Conversely, the internal and external assessments are in consensus regarding indicator 2.6, but that consensus is a low rating, thus indicating a need for further investigation and/or action.

The tool provides a mechanism by which the team members may not only identify potential problem areas within the framework of the standards and indicators, but may also record and store action items that may be desirable to respond to the identified problems. In that regard, and still referring to the screen illustrated in FIG. 53, the screen provides, for every indicator in the table, a selectable “actions” button.

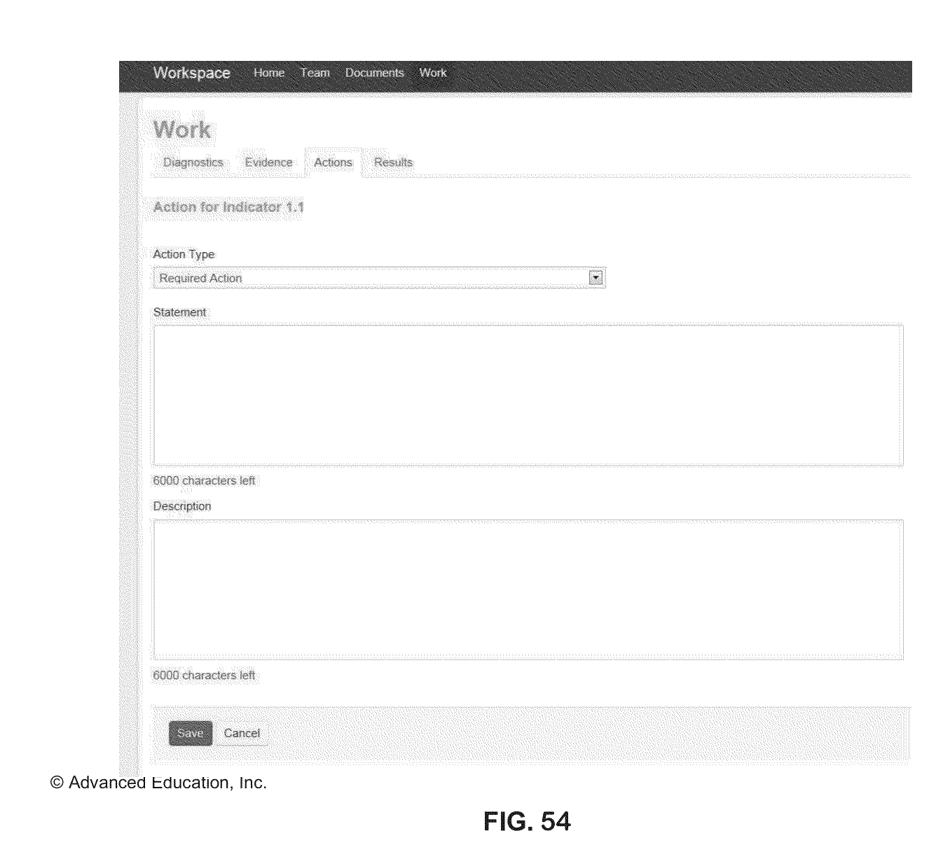

Upon activating an “actions” button for a given indicator, the GUI presents a pull-down list. If no actions have been created, the user sees a selectable “Create New Action.” If an action has been created, the user sees “Create New Action” as well as any previously-created actions. Activation of “Create New Action” causes the tool to present a screen as shown in FIG. 54, through which the external review team may enter any of three types of actions—a “required action,” i.e. an action to be completed by the school; a “powerful practice,” i.e. a recommended action; or an “opportunity for improvement,” i.e. an observation of an opportunity for school improvement. When the user completes these three data entry points, selection of the “saved” button causes the tool (i.e. server 510) to store the action in a record of database 570 associated with the school. There is a record for each action identified by the external review team. These actions will be included in the External Review Report the team generates. The relevant education organization generates specific plans to address the actions.

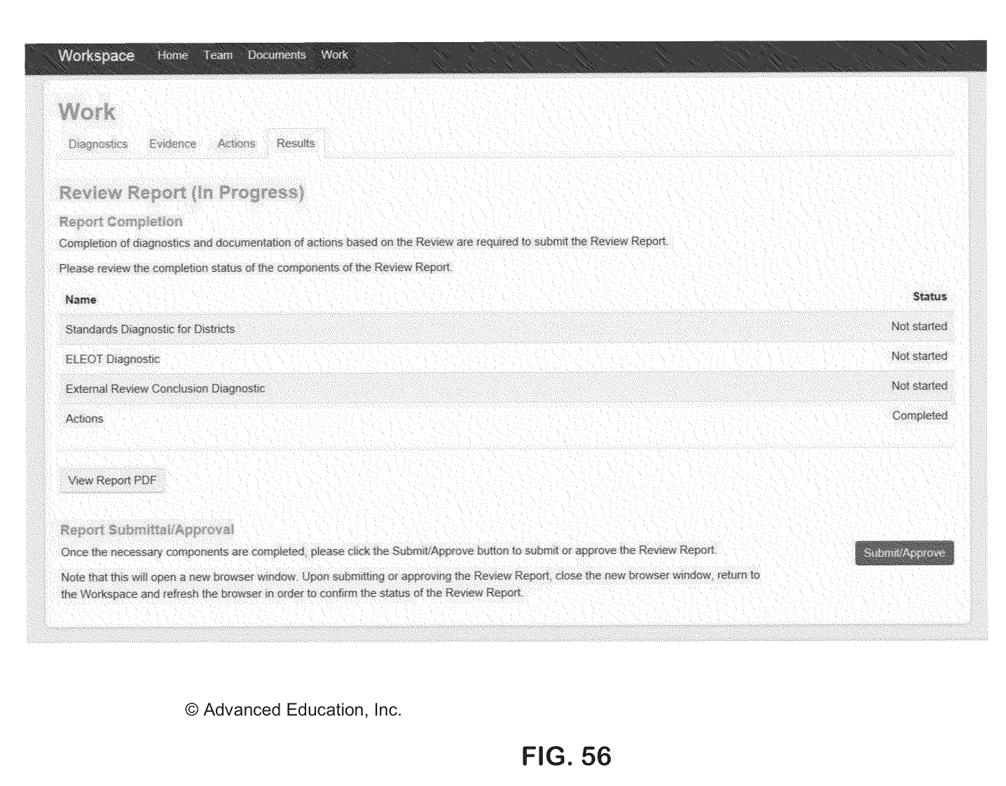

Selection of the “results” tab causes the tool to present a screen as shown in FIG. 56, through which the managing entity views the status of the diagnostics and actions, generates reports, and submits a report to a school. There is a status for the External Review Report and for each of its components. When any of the report components are started, the status will be reflected in the status column where the components are shown. When any component is started, the status of the External Review Report becomes “In Progress.” Upon activation of a “submits/approve” button, the GUI screen through which the report can be submitted to the managing entity or jurisdiction and approved.

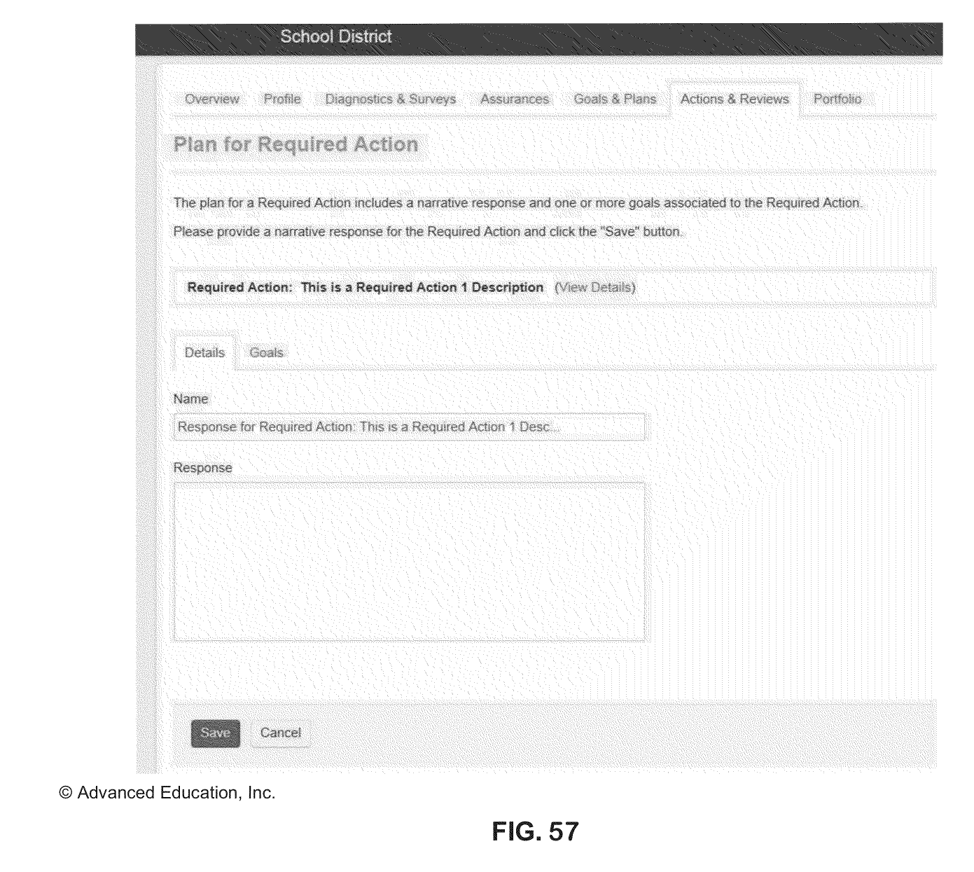

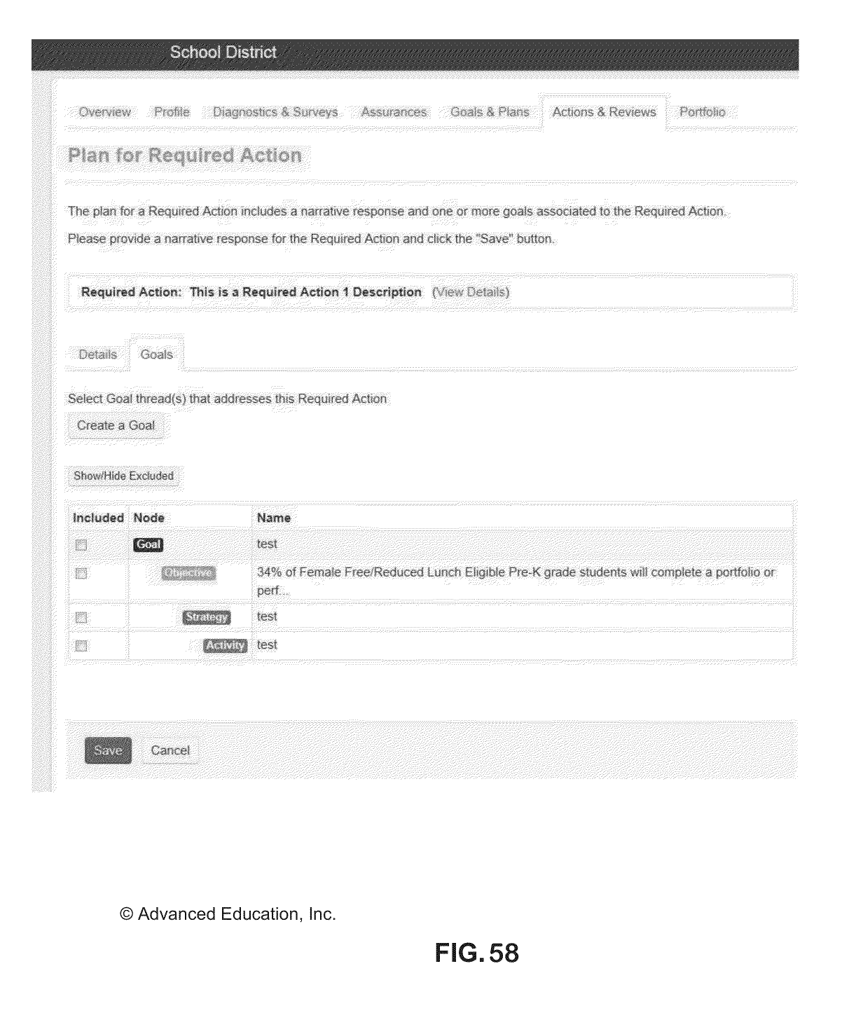

Once the external review report is submitted, the school receives an email notification from the system, and the organization's administrator may access the system and review the required actions, powerful practices, and opportunities for improvement established by the external review team. The school then provides a narrative response for each required action as a first step for addressing the required action. A graphical user interface, such as illustrated in FIG. 57, allows the school to provide such narrative response. Once the school has completed the narrative response, the school administrator submits the response to server which is then saves the response at database 570. Additionally, as illustrated in FIG. 58 the school administrator may identify one or more goals in order to address the required actions. For example, the school in FIG. 58 has identified an objective that “34% of female free/reduced lunch eligible Pre-K grade students will complete a portfolio.” The schools may also create strategies and activities. Each activity helps achieve this strategy, and each strategy helps achieve the objective.

The narrative response is used by the reviewer of the plan generated to address the required action. For example, a school that was visited by an External Review team and was put on probation would submit plans to address required actions. The managing entity would review the response for the required action as well as the plan to address the required action. The plan includes as well progress notes pertaining to the execution of the plan. The reviewer is then able to assess whether the required action was address effectively and consequently make an accreditation decision (as to whether the school can come out of probation).

Referring back to FIG. 2, after the administrator performs all analysis and develops an improvement plan, in block 224, the managing entity then monitors the improvement of the school by monitoring the completion of activities which result in completion of goals.

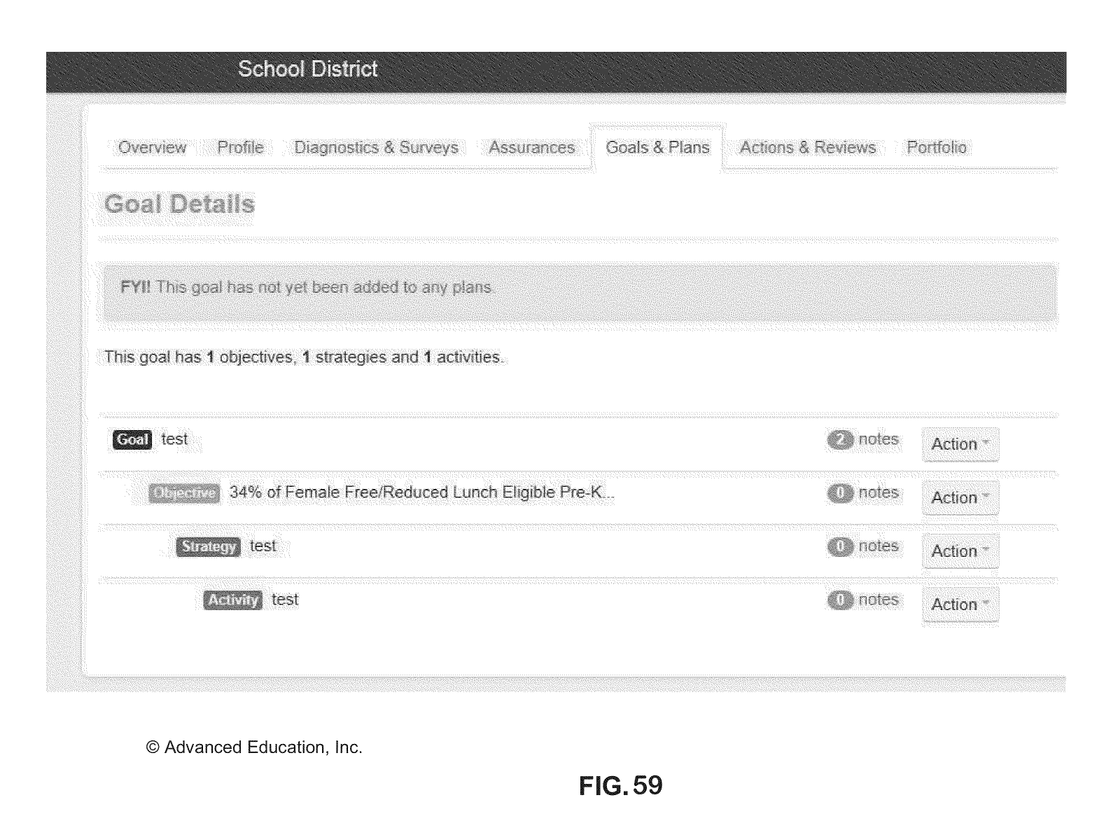

Additionally, schools provide updates of the completion of activities and goals. FIGS. 59-62 illustrate graphical user interfaces that enable the school to record its progress and execution of goals. For example, FIG. 59 illustrates a graphical interface where a school records progress notes at every level of the goal, such as the goal itself, objectives, strategies, and activities. This is shown by the “notes” section on the right-hand side of the graphical user interface of FIG. 59. For example, the goal in FIG. 59 has “2 notes” associated with the goal. Server 510 saves these notes in database 570.

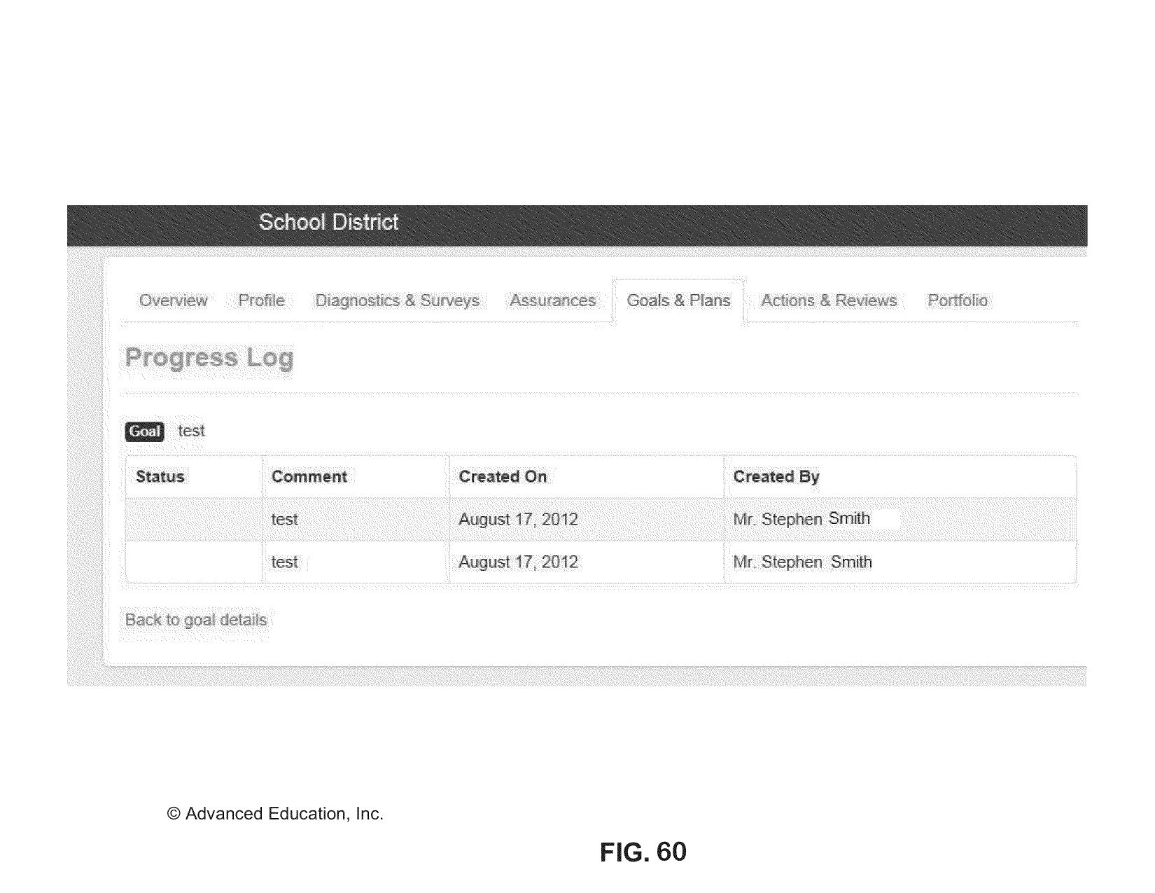

FIG. 60 illustrates the school maintaining a progress log according to one embodiment. The school enters the notes and statuses in the graphical user interface for each goal as the goal is being met. Server 510 saves each status log entry to database 570. The progress log may be viewed at any time by the school.

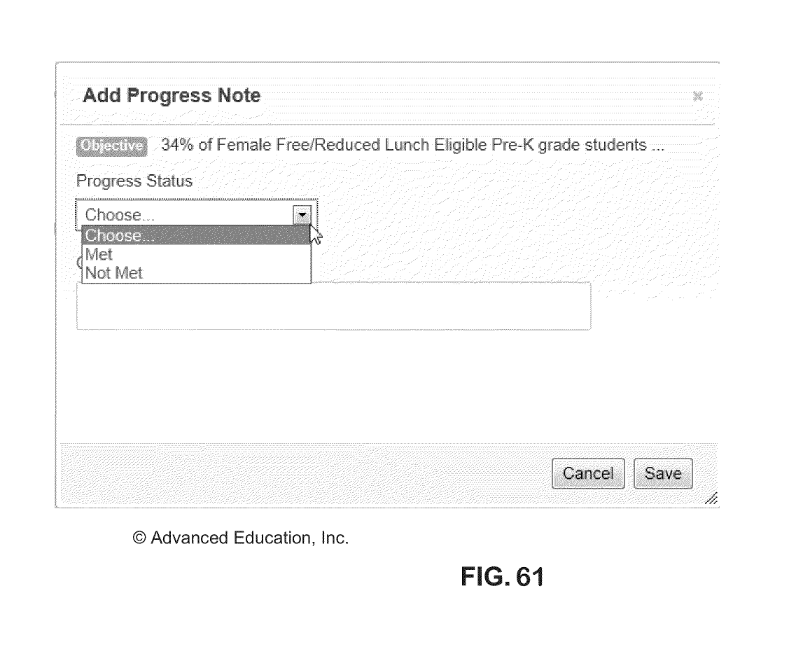

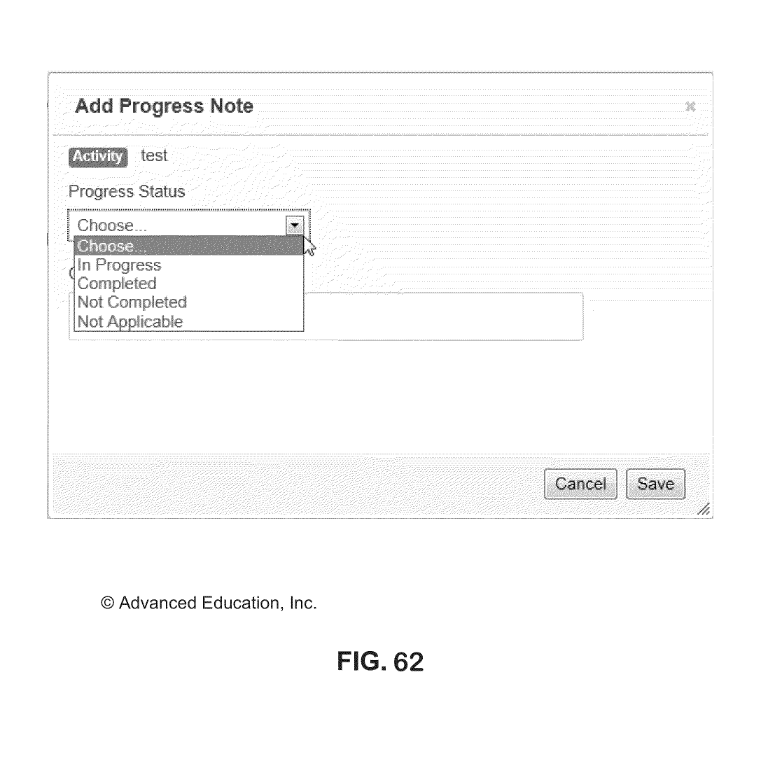

FIGS. 61 and 62 illustrate that institutions may set the status of an objective and an activity. For each item, a graphical user interface is presented with a drop-down menu. For example, in FIG. 61 a graphical user interface allows the school to choose whether an objective has been met. Server 510 saves this entered information in database 570. In FIG. 62, the school can provide whether the activity is in progress, completed, not completed, or not applicable. This allows the school to provide a progress status of each activity in achieving objectives and goals. Server 510 stores progress note in database 570.

Method 200 may continue back to block 203 where the administrator is able to obtain reports and data of student performance and analyze the school's performance. The process continues iteratively so that the school is continuously improving and analyzing the school's and students' performance.

### Learn & Collaborate

In some embodiments, server 510 connects various schools together in a collaborative environment to learn from what other schools are doing. This includes, professional learning, peer-to-peer connections, discussion forums, and best practices. Using the server, the administrators can browse what other schools have encountered problems-wise and how those schools solved the problems through the use of best practices. The administrators log onto a forum or some other social networking software to collaborate and discuss these possibilities.

As will be appreciated by one of skill in the art, the present invention may be embodied as a method (including, for example, a computer-implemented process, a business process, and/or any other process), apparatus (including, for example, a system, machine, device, computer program product, and/or the like), or a combination of the foregoing. Accordingly, embodiments of the present invention may take the form of an entirely hardware embodiment, an entirely software embodiment (including firmware, resident software, micro-code, etc.), or an embodiment combining software and hardware aspects. Furthermore, embodiments of the present invention may take the form of a computer program product on a computer-readable medium having computer-executable program code embodied in the medium.

Any suitable transitory or non-transitory computer readable medium may be utilized. The computer readable medium may be, for example but not limited to, an electronic, magnetic, optical, electromagnetic, infrared, or semiconductor system, apparatus, or device. More specific examples of the computer readable medium include, but are not limited to, the following: an electrical connection having one or more wires; a tangible storage medium such as a portable computer diskette, a hard disk, a random access memory (RAM), a read-only memory (ROM), an erasable programmable read-only memory (EPROM or Flash memory), a compact disc read-only memory (CD-ROM), or other optical or magnetic storage device.

In the context of this document, a computer readable medium may be any medium that can contain, store, communicate, or transport the program for use by or in connection with the instruction execution system, apparatus, or device. The computer usable program code may be transmitted using any appropriate medium, including but not limited to the Internet, wireline, optical fiber cable, radio frequency (RF) signals, or other mediums.

Computer-executable program code for carrying out operations of embodiments of the present invention may be written in an object oriented, scripted or unscripted programming language such as Java, Perl, Smalltalk, C++, or the like. However, the computer program code for carrying out operations of embodiments of the present invention may also be written in conventional procedural programming languages, such as the “C” programming language or similar programming languages.

Embodiments of the present invention are described above with reference to flowchart illustrations and/or block diagrams of methods, apparatus (systems), and computer program products. It will be understood that each block of the flowchart illustrations and/or block diagrams, and/or combinations of blocks in the flowchart illustrations and/or block diagrams, can be implemented by computer-executable program code portions. These computer-executable program code portions may be provided to a processor of a general purpose computer, special purpose computer, or other programmable data processing apparatus to produce a particular machine, such that the code portions, which execute via the processor of the computer or other programmable data processing apparatus, create mechanisms for implementing the functions/acts specified in the flowchart and/or block diagram block or blocks.

These computer-executable program code portions may also be stored in a computer-readable memory that can direct a computer or other programmable data processing apparatus to function in a particular manner, such that the code portions stored in the computer readable memory produce an article of manufacture including instruction mechanisms which implement the function/act specified in the flowchart and/or block diagram block(s).

The computer-executable program code may also be loaded onto a computer or other programmable data processing apparatus to cause a series of operational steps to be performed on the computer or other programmable apparatus to produce a computer-implemented process such that the code portions which execute on the computer or other programmable apparatus provide steps for implementing the functions/acts specified in the flowchart and/or block diagram block(s). Alternatively, computer program implemented steps or acts may be combined with operator or human implemented steps or acts in order to carry out an embodiment of the invention.

As the phrase is used herein, a processor may be “configured to” perform a certain function in a variety of ways, including, for example, by having one or more general-purpose circuits perform the function by executing particular computer-executable program code embodied in computer-readable medium, and/or by having one or more application-specific circuits perform the function.

Embodiments of the present invention are described above with reference to flowcharts and/or block diagrams. It will be understood that steps of the processes described herein may be performed in orders different than those illustrated in the flowcharts. In other words, the processes represented by the blocks of a flowchart may, in some embodiments, be in performed in an order other that the order illustrated, may be combined or divided, or may be performed simultaneously. It will also be understood that the blocks of the block diagrams illustrated, in some embodiments, merely conceptual delineations between systems and one or more of the systems illustrated by a block in the block diagrams may be combined or share hardware and/or software with another one or more of the systems illustrated by a block in the block diagrams. Likewise, a device, system, apparatus, and/or the like may be made up of one or more devices, systems, apparatuses, and/or the like. For example, where a processor is illustrated or described herein, the processor may be made up of a plurality of microprocessors or other processing devices which may or may not be coupled to one another. Likewise, where a memory is illustrated or described herein, the memory may be made up of a plurality of memory devices which may or may not be coupled to one another.

While certain exemplary embodiments have been described and shown in the accompanying drawings, it is to be understood that such embodiments are merely illustrative of, and not restrictive on, the broad invention, and that this invention not be limited to the specific constructions and arrangements shown and described, since various other changes, combinations, omissions, modifications and substitutions, in addition to those set forth in the above paragraphs, are possible. Those skilled in the art will appreciate that various adaptations and modifications of the just described embodiments can be configured without departing from the scope and spirit of the invention. Therefore, it is to be understood that, within the scope of the appended claims, the invention may be practiced other than as specifically described herein.

What is claimed is:

1. A method of analyzing performance of an education organization based on a set of categories of education organization activities or attributes, the method comprising:
providing a computerized system that is accessible to remote parties through a computer network and that is controlled by a managing entity;
providing, at the computerized system, a first set of queries for a first set of data items that describe education organization performance, that relate to one or more of the categories, and that are applicable to an administrator of the education organization;
providing, at the computerized system, a second set of queries for a second set of data items that describe education organization performance, that relate to one or more of the categories, and that are applicable to individuals who interact with the education organization;
providing to one or more first representatives of the education organization access, via the computer network and the computerized system, to the first set of data items and receiving first data from the one or more first representatives in response to the first set of queries;
providing to one or more individuals who interact with the education organization access, via the computer network and the computerized system, to the second set of data items and receiving second data from the one or more individuals in response to the second set of queries;
receiving third data that describes performance of students at the education organization;
defining, at the computerized system, a set of parameters corresponding to demographic attributes of the students;
receiving, at the computerized system from a second representative of the school, a selection of said parameters; and
presenting to the second representative the first data, the second data, and the third data, wherein the third data is limited by the selected parameters.

2. The method as in claim 1, wherein the second representative is also a said first representative.

3. The method as in claim 1, wherein the second data includes information describing demographic attributes of the one or more individuals.

4. The method as in claim 3, wherein the second data presented to the second representative is limited by the demographic attributes of the one or more individuals.

5. The method as in claim 1, comprising, following the presenting step:
receiving, at the computerized system from a third representative of the education organization, fourth data describing one or more desired objectives for the school; and
receiving, at the computerized system from the third representative, fifth data describing one or more activities to be performed by the education organization to achieve the objectives.

6. The method as in claim 5, wherein the third representative is also the second representative.

7. The method as in claim 5, wherein fourth data includes information correlating the desired objectives to one or more respective sub-groups of the students defined by demographic attributes of the students.

8. A method of analyzing the performance of an education organization and facilitating an improvement plan, the method comprising:
providing a computerized system that is accessible to remote parties through a computer network and that is controlled by a managing entity;
receiving, at the computerized system through the computer network, authenticating information identifying an administrator of the education organization, wherein the administrator comprises a representative of the education organization;
presenting an option to the administrator to administer surveys via the computerized system, wherein the surveys comprise
a self-assessment diagnostic comprising queries relating to the education organization's performance, and
a stakeholder survey comprising queries relating to the education organization's performance;
providing access to the self-assessment survey to one or more first representatives of the education organization and receiving first response data from the one or more first representatives;
providing access to the stakeholder perception survey to one or more individuals who interact with the education organization and receiving second response data from the one or more individuals;
receiving third data describing performance of students of the education organization;
presenting to a second representative of the education organization the first response data, the second response data, and the third data;
following the second presenting step, receiving, from a third representative of the education organization, fourth data describing one or more desired objectives for the education organization.

9. The method as in claim 8, wherein the second representative is also a said first representative.

10. The method as in claim 8, wherein the third representative is also the second representative.

11. The method as in claim 8, comprising receiving, following the presenting step and from the third representative, fifth data describing one or more activities to be performed by the education organization to achieve the objectives.

12. A method of analyzing the performance of an education organization and facilitating an improvement plan, the method comprising:
providing a computerized system that is accessible to remote parties through a computer network and that is controlled by a managing entity;
presenting an option to the administrator to administer surveys via the computerized system, wherein the surveys request data regarding performance of the education organization;
receiving and storing data responsive to the surveys into a database managed by the managing entity;
receiving data describing performance of students of the education organization;
presenting to an administrator of the education organization the responsive data and the performance data;
following the second presenting step, receiving, from the administrator, data describing one or more desired objectives for the education organization.

13. A computerized system controlled by a managing entity for analyzing performance of an education organization, comprising:
a computer-readable medium containing program instructions;
a database; and
a processor that is accessible to remote parties through a computer network and that is controlled by a managing entity, the processor being in operative communication with the computer-readable medium and adapted to execute program instructions to implement a method comprising the steps of
receiving, at the computerized system, student performance data, wherein the student performance data describes performance of students attending the education organization,
saving the received student performance data at the database according to a predefined data hierarchy,
in response to a request received from a first said remote party, presenting the student performance data to the first remote party through a graphical user interface,
presenting to a user of the computerized system, through a graphical user interface, one or more interactive screens that present to the user a plurality of requests for information evidencing or opinion regarding one or more operating conditions of the education organization,
receiving, through the one or more interactive screens, first responses to the requests,
saving the first responses in the database in association with the education organization,
presenting to a second said remote party, through the graphical user interface, one or more interactive screens that present prompts to the second remote party to enter proposed actions to be taken by the education organization,
receiving, through the one or more interactive screens, second responses to the prompts from the second remote party,
saving the second responses in the database in association with the education organization,
presenting to a third said remote party, through the graphical user interface, one or more interactive screens that present one or more predetermined statements of operating conditions of the education organization and one or more respective prompts to the third remote party to confirm the education organization meets the one or more said operating conditions,
receiving, through the one or more interactive screens, third responses to the one or more prompts from the third remote party, and
saving the third responses in the database in association with the education organization.

14. The computerized system as in claim 13, wherein the first remote party, the second remote party, and the third remote party are the same remote party.

15. A method of analyzing performance of an education organization, comprising:
providing a computerized system comprising computer-readable medium containing program instructions, a database, and a processor that is accessible to remote parties through a computer network and that is controlled by a managing entity, the processor being in operative communication with the computer-readable medium and adapted to execute program instructions;
receiving, at the computerized system, student performance data, wherein the student performance data describes performance of students attending the education organization;
saving the received student performance data at the database according to a predefined data hierarchy;
in response to a request received from a first said remote party, presenting the student performance data to the first remote party through a graphical user interface;
presenting to a user of the computerized system, through a graphical user interface, one or more interactive screens that present to the user a plurality of requests for information evidencing or opinion regarding one or more operating conditions of the education organization;
receiving, through the one or more interactive screens, first responses to the requests;
saving the first responses in the database in association with the education organization;
presenting to a second said remote party, through the graphical user interface, one or more interactive screens that present prompts to the second remote party to enter proposed actions to be taken by the education organization;
receiving, through the one or more interactive screens, second responses to the prompts from the second remote party;
saving the second responses in the database in association with the education organization;
presenting to a third said remote party, through the graphical user interface, one or more interactive screens that present one or more predetermined statements of operating conditions of the education organization and one or more respective prompts to the third remote party to confirm the education organization meets the one or more said operating conditions;
receiving, through the one or more interactive screens, third responses to the one or more prompts from the third remote party; and
saving the third responses in the database in association with the education organization.
